(19) United States
(12) Patent Application Publication
(10) Pub. No.: US 2012/0331487 A1
(43) Pub. Date: Dec. 27, 2012

(54) PATTERN MATCHING DEVICE, PATTERN MATCHING METHOD, AND PATTERN MATCHING SYSTEM

(75) Inventor: Sawako Mikami, Tokyo (JP)

(73) Assignee: NEC CORPORATION, Tokyo (JP)

(21) Appl. No.: 13/581,596

(22) PCT Filed: Feb. 24, 2011
(86) PCT No.: PCT/JP2011/054829

§ 371 Date: Aug. 28, 2012

(30) Foreign Application Priority Data
Mar. 1, 2010 (JP) 2010-043954

(51) Int. Cl. G06F 9/44

(52) U.S. Cl. 719/318

(57) ABSTRACT

Provided is a pattern matching device capable of generating an event pattern matching tree optimal for efficiently performing pattern matching assessment. The pattern matching device is provided with an event pattern table holding unit for holding an event pattern including a partial event pattern comprising a first attribute name and an attribute value; a first matching ratio measurement unit for measuring a matching ratio corresponding to the first attribute name on the basis of an event including attributes comprising a second attribute name and an attribute value and the event pattern; and an event pattern matching tree generation unit for generating an event pattern matching tree which has arranged on an upper level an attribute value matching assessment instance including the first attribute name which has the low corresponding matching ratio on the basis of the event pattern and the matching ratio.

### TECHNICAL FIELD

The present invention relates to a pattern matching device, a pattern matching method and a pattern matching system and, in particular, relates to a pattern matching device, a pattern matching method and a pattern matching system which generate a matching tree.

### BACKGROUND ART

Various related technologies are known about pattern matching.

As an example of related technologies, a method and a system which process an event are disclosed in patent document 1. The method and the system which process an event described in patent document 1 include a filter tree on the basis of one or more subscriptions received from one or more event consumers.

And the method and the system which process an event described in patent document 1 compare event notifications using the filter tree and perform processing which narrows down event consumers to which the event notification is transferred on the basis of the result.

As another example of related technologies, an event matching algorithm in a publish/subscribe system is disclosed in non-patent document 1. The event matching algorithm described in non-patent document 1 is an algorithm to assess, when an event is generated, to which subscription it matches.

The algorithm is realized by a system 900 of a tree structure as shown in FIG. 50. The system 900 includes a node 901 and an edge 904 and represents a condition for judging whether an event matches with a subscription.

A leaf node 903 among the nodes 901 is related to subscriptions (sub1-sub3) 907.

Each of the nodes 901 other than the leaf node 903 is given an attribute name 905 which is a component of the event.

The edge 904 which connects a parent node 901 and a child node 901 is given an attribute value 906 corresponding to attribute names (attr1-attr3) 905 given to the parent node 901.

When a certain event is inputted to the system 900, first, the system 900 refers the inputted event. And the system 900 acquires the attribute value 906 corresponding to the attribute name 905 given to a root node 902.

In case the acquired attribute value 906 matches with either of the attribute values 906 given to the edge 904 which connects the root node 902 and its child node 901, the system 900 makes the child node 901 and a grandchild node 901 as a parent node 901 and a child node 901 respectively and performs the processing mentioned above similarly.

In case the leaf node 903 is reached finally by repeatedly executing the processing mentioned above in this way, the system 900 assesses that the subscription 907 related to the leaf node 903 as the subscription 907 with which the event concerned matches.

Further, in case * is given to the edge 904, regardless of the attribute value 906 of the inputted event, the system 900 advances processing to the child node 901.

As a specific example, a case when an event which is “ATTR1=V1′, ATTR2=V2, ATTR3=V3′” is inputted to the system 900 shown in FIG. 50 will be described below.

First, the system 900 acquires the attribute value 906 “V1′” of the event corresponding to the attribute name 905 “ATTR1” of the root node 902. Next, the system 900 detects the child node 901 (its attribute name 905 is “ATTR2”) of which the attribute value 906 “V1′” matches with the attribute value 906 given to the edge 904.

Next, the system 900 acquires the attribute value 906 “V2” of the event corresponding to the attribute name 905 “ATTR2” of the node 901. Next, the system 900 detects the child node 901 (its attribute name 905 is “ATTR3”) of which the attribute value 906 ‘V2’ matches with the attribute value 906 given to the edge 904.

Next, the system 900 acquires the attribute value 906 “V3′” of the event corresponding to the attribute name 905 “ATTR3” of the node 901. Next, the system 900 detects that the attribute value 906 “V3′” does not match with either of the attribute values 906 given to the edge 904. And the system 900 ends the processing.

That is, in case of this example, there exits no subscription 907 which matches.

### Patent Document

[Patent document 1] Japanese Patent Application Laid-Open No. 2003-316610

### Non-Patent Document

[Non-patent document 1] M. K. AGUILERA, R. E. STROM, D.

C. STURMAN, M. ASTLEY, AND T. D. CHANDRA: “MATCHING EVENTS IN A CONTENT-BASED SUBSCRIPTION SYSTEM,” IN PROC. 18TH ANNUAL ACM SYMPOSIUM ON PRINCIPLES OF DISTRIBUTED COMPUTING, PP. 53-61 (1999).

### SUMMARY OF THE INVENTION

### Problem to be Solved by the Invention

However, in the technology disclosed in the documents mentioned above, there is a problem that the structure of the matching tree used for matching assessment of such as an event may not be optimal.

The reason is because the filter tree or the system of a tree structure is structured without considering probability that an attribute name and an attribute value of an event, and a node and an edge, match.

That is, in case the filter tree or the system of a tree structure is structured so that there exists around the root node an edge with which an attribute value matches, and there does not exist around the leaf node an edge with which the attribute value matches; the matching assessment processing of the attribute value executed around the root node becomes useless as a result. Also, time necessary to perform assessment that the event does not match with the subscription becomes long.

The object of the present invention is to solve the problem mentioned above and to provide a pattern matching device, a pattern matching method and a pattern matching system which generate an event pattern matching tree optimal for efficiently performing pattern matching assessment.

### Means for Solving a Problem

A pattern matching device of the present invention includes: an event pattern table holding unit which holds at least one event pattern including a partial event pattern comprising a first attribute name and an attribute value; a first matching ratio measurement unit which measures a first matching ratio corresponding to the first attribute name on the basis of an event including attributes comprising a second attribute name and an attribute value and the event pattern held in the event pattern table holding unit; and an event pattern matching tree generation unit which generates an event pattern matching tree which has arranged on a relatively upper level an attribute value matching assessment instance including the first attribute name which has the relatively low corresponding matching ratio on the basis of the event pattern held in the event pattern table holding unit and the first matching ratio.

A pattern matching method of the present invention includes: a first matching ratio measurement step which measures, on the basis of an event including attributes comprising a second attribute name and an attribute value and an event pattern including a partial event pattern comprising a first attribute name and an attribute value held in an event pattern table holding unit, a first matching ratio corresponding to the first attribute name; and a step which generates an event pattern matching tree which has arranged on a relatively upper level an attribute value matching assessment instance including the first attribute name which has the relatively low corresponding matching ratio on the basis of the event pattern held in the event pattern table holding unit and the first matching ratio.

A program recorded in a non-transitory computer-readable medium of the present invention makes a computer execute processing: to measure, on the basis of an event including attributes comprising a second attribute name and an attribute value and an event pattern including a partial event pattern comprising a first attribute name and an attribute value held in an event pattern table holding unit, a first matching ratio corresponding to the first attribute name; and to generate an event pattern matching tree which has arranged on a relatively upper level an attribute value matching assessment instance including the first attribute name which has the relatively low corresponding matching ratio on the basis of the event pattern held in the event pattern table holding unit and the first matching ratio.

A pattern matching system of the present invention includes: an event pattern table holding unit which holds at least one event pattern including a partial event pattern comprising a first attribute name and an attribute value; a first matching ratio measurement unit which measures a first matching ratio corresponding to the first attribute name on the basis of an event including attributes comprising a second attribute name and an attribute value and the event pattern held in the event pattern table holding unit; and an event pattern matching tree generation unit which generates an event pattern matching tree which has arranged on a relatively upper level an attribute value matching assessment instance including the first attribute name which has the relatively low corresponding matching ratio on the basis of the event pattern held in the event pattern table holding unit and the first matching ratio.

### Effect of the Invention

The present invention has the effect that it can generate an event pattern matching tree optimal for efficiently performing pattern matching assessment.

### BRIEF DESCRIPTION OF THE DRAWINGS

FIG. 1 is a block diagram showing a structure of the first exemplary embodiment of the present invention.

FIG. 2 is a figure showing an example of a structure and contents of an event in the first to the fifth exemplary embodiment of the present invention.

FIG. 3 is a figure showing an example of a structure and contents of an event pattern in the first to the fifth exemplary embodiment of the present invention.

FIG. 4 is a figure showing an example of a structure and contents of an event pattern registration request in the first to the fourth exemplary embodiment of the present invention.

FIG. 5 is a figure showing an example of a structure and contents of an event pattern registration request in the first to the fourth exemplary embodiment of the present invention.

FIG. 6 is a figure showing an example of a structure and contents of an event pattern deletion request in the first to the fourth exemplary embodiment of the present invention.

FIG. 7 is a figure showing an example of a structure and contents of an event pattern deletion request in the first to the fourth exemplary embodiment of the present invention.

FIG. 8 is a figure showing a structure of an event pattern matching tree in the first to the fifth exemplary embodiment of the present invention.

FIG. 9 is a figure showing a structure of an attribute value matching assessment instance in the first to the fifth exemplary embodiment of the present invention.

FIG. 10 is a figure showing a structure of a hash table in the first to the fifth exemplary embodiment of the present invention.

FIG. 11 is a figure showing a structure of an event notification instance in the first to the fifth exemplary embodiment of the present invention.

FIG. 12 is a figure showing a structure of a matching ratio measurement table in the first, the third and the fifth exemplary embodiment of the present invention.

FIG. 13 is a figure showing an example of a structure and contents of an event pattern table in the first to the fifth exemplary embodiment of the present invention.

FIG. 14 is a flow chart showing operation of matching of an event in the first exemplary embodiment of the present invention.

FIG. 15 is a flow chart showing operation of matching of an event in the first exemplary embodiment of the present invention.

FIG. 16 is a flow chart showing operation of matching of an event in the first exemplary embodiment of the present invention.

FIG. 17 is a flow chart showing operation of matching of an event in the first exemplary embodiment of the present invention.

FIG. 18 is a flow chart showing operation of matching of an event in the first exemplary embodiment of the present invention.

FIG. 19 is a flow chart showing operation of organization and reorganization of an event pattern matching tree in the first exemplary embodiment of the present invention.

FIG. 20 is a flow chart showing operation of organization and reorganization of an event pattern matching tree in the first exemplary embodiment of the present invention.

FIG. 21 is a flow chart showing operation of organization and reorganization of an event pattern matching tree in the first exemplary embodiment of the present invention.

FIG. 22 is a figure showing an example of an event pattern matching tree in the first to the fifth exemplary embodiment of the present invention.

FIG. 23 is a figure showing an example of a matching ratio measurement table in the first exemplary embodiment of the present invention.

FIG. 24 is a figure showing an example of a matching ratio measurement table in the first exemplary embodiment of the present invention.

FIG. 25 is a figure showing an example of an event pattern matching tree in the first exemplary embodiment of the present invention.

FIG. 26 is a figure showing an example of an event pattern matching tree in the first exemplary embodiment of the present invention.

FIG. 27 is a figure showing an example of an event pattern matching tree in the first exemplary embodiment of the present invention.

FIG. 28 is a figure showing an example of an event pattern matching tree in the first exemplary embodiment of the present invention.

FIG. 29 is a block diagram showing a structure of the second exemplary embodiment of the present invention.

FIG. 30 is a figure showing an example of a structure and contents of a matching ratio measurement table in the second and the third exemplary embodiment of the present invention.

FIG. 31 is a figure showing an example of a matching ratio measurement table in the second and the third exemplary embodiment of the present invention.

FIG. 32 is a flow chart showing operation of event pattern registration in the second exemplary embodiment of the present invention.

FIG. 33 is a flow chart showing operation of event pattern deletion in the second exemplary embodiment of the present invention.

FIG. 34 is a flow chart showing operation of attribute matching assessment in case an instance referred is an attribute value matching assessment instance in the second exemplary embodiment of the present invention.

FIG. 35 is a flow chart showing operation which updates a matching ratio corresponding to each attribute name in the second exemplary embodiment of the present invention.

FIG. 36 is a figure showing an example of an event pattern matching tree and a matching ratio corresponding to each attribute name in the first exemplary embodiment for describing the effect of the second exemplary embodiment of the present invention.

FIG. 37 is a figure showing an example of an event pattern matching tree and a matching ratio corresponding to each attribute name in the first exemplary embodiment for describing the effect of the second exemplary embodiment of the present invention.

FIG. 38 is a block diagram showing a structure of the third exemplary embodiment of the present invention.

FIG. 39 is a flow chart showing operation which requests reorganization of an event pattern matching tree in the third exemplary embodiment of the present invention.

FIG. 40 is a flow chart showing operation in case a matching ratio measurement unit receives a matching ratio measurement starting request from a tree reorganization management unit in the third exemplary embodiment of the present invention.

FIG. 41 is a flow chart showing operation in case a matching ratio measurement unit receives a matching ratio measurement end request from a tree reorganization management unit in the third exemplary embodiment of the present invention.

FIG. 42 is a flow chart showing operation in case an event receiving unit receives an event transmission starting request from a matching ratio measurement unit in the third exemplary embodiment of the present invention.

FIG. 43 is a flow chart showing operation in case an event receiving unit receives an event transmission end request from a matching ratio measurement unit in the third exemplary embodiment of the present invention.

FIG. 44 is a flow chart showing operation at a time of event reception in the third exemplary embodiment of the present invention.

FIG. 45 is a figure showing an example of a matching ratio measurement table in the third exemplary embodiment of the present invention.

FIG. 46 is a block diagram showing a structure of the fourth exemplary embodiment of the present invention.

FIG. 47 is a flow chart showing operation by which a tree reorganization management unit requests reorganization of an event pattern matching tree in the fourth exemplary embodiment of the present invention.

FIG. 48 is a flow chart showing operation by which a tree root attribute matching ratio measurement unit updates a matching ratio measurement table 131 in the fourth exemplary embodiment of the present invention.

FIG. 49 is a block diagram showing a structure of the fifth exemplary embodiment of the present invention.

FIG. 50 is a figure showing a concept of a system of non-patent document 1 of a background art.

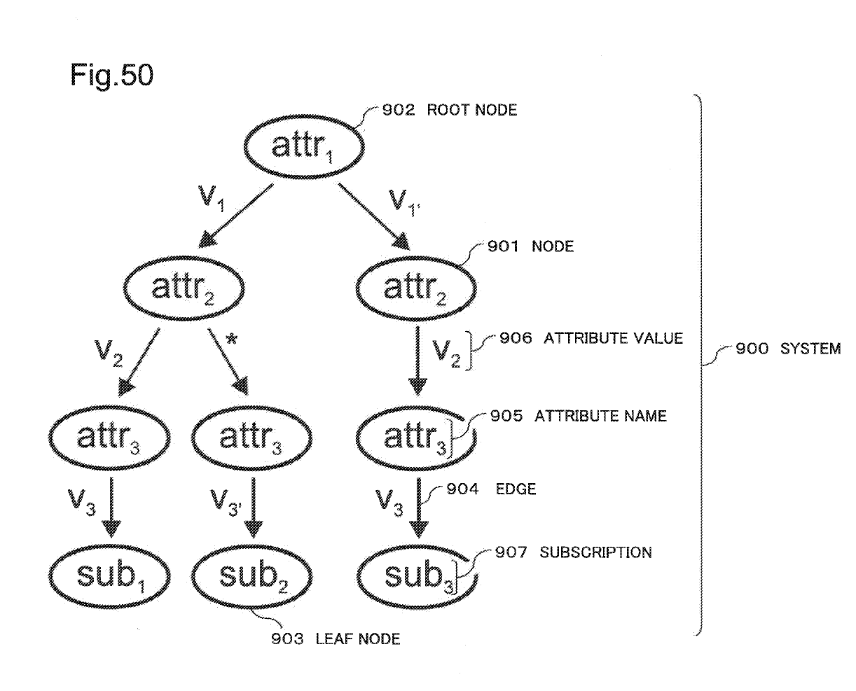

FIG. 51 is a block diagram showing a structure of an exemplary embodiment using computer equipment of the present invention.

FIG. 52 is a figure showing an example of a recording medium in which a program of the present invention is recorded.

### EXEMPLARY EMBODIMENTS FOR CARRYING OUT OF THE INVENTION

Next, exemplary embodiments of the present invention will be described in detail with reference to drawings.

### The First Exemplary Embodiment

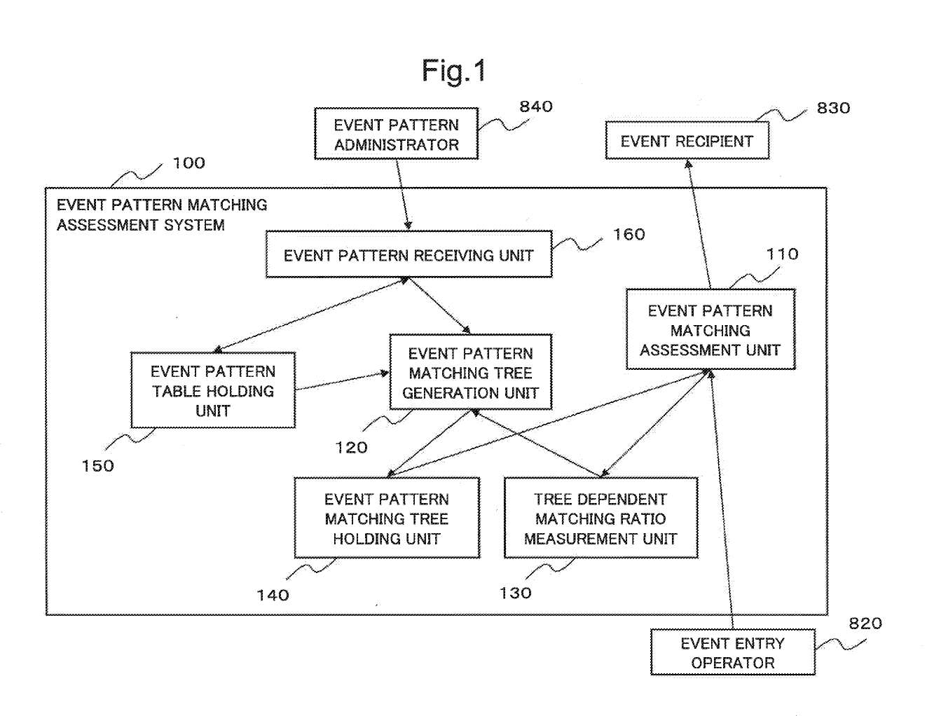

FIG. 1 is a block diagram showing a structure of the first exemplary embodiment of the present invention.

Referring to FIG. 1, the exemplary embodiment includes an event pattern matching assessment system (also called a pattern matching system) 100, an event entry operator 820, an event recipient 830 and an event pattern administrator 840.

The event pattern matching assessment system 100 includes: an event pattern matching assessment unit 110, an event pattern matching tree generation unit 120, a tree dependent matching ratio measurement unit (also called a matching ratio measurement unit) 130, an event pattern matching tree holding unit 140, an event pattern table holding unit 150 and an event pattern receiving unit 160.

The event entry operator 820, the event recipient 830 and the event pattern administrator 840 are terminals which a person (an event entry operator, an event recipient or an event pattern administrator) operates respectively. Also, they may be a terminal, a server and so on which operate by directions given in advance.

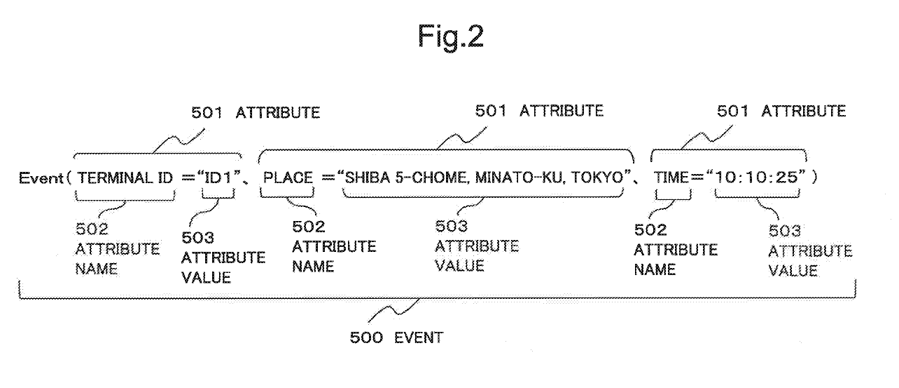

FIG. 2 is a figure showing an example of a structure and contents of an event 500. The event 500 is data generated by such as a portable terminal, an RF (Radio Frequency) tag and a sensor.

The event 500 is, for example, data including a terminal ID (Identification) which identifies the portable terminal, a position where the portable terminal existed at a time the data was generated and the time when the data is generated.

The data such as the terminal ID, the position and the time included in the event 500 are collectively called an attribute 501. The event 500 includes no smaller than one attributes 501.

‘Terminal ID’, ‘place’, ‘time’ and so on which are names of the attribute 501 are called an attribute name 502. Also, “ID1”, “Shiba 5-chome, Minato-ku, Tokyo”, “10:10:25” and so on which are values of the attribute 501 corresponding to the attribute name 502 are called attribute values 503. In the event 500, one which combined the attribute name 502 and the corresponding attribute value 503 together is called the attribute 501 as mentioned above.

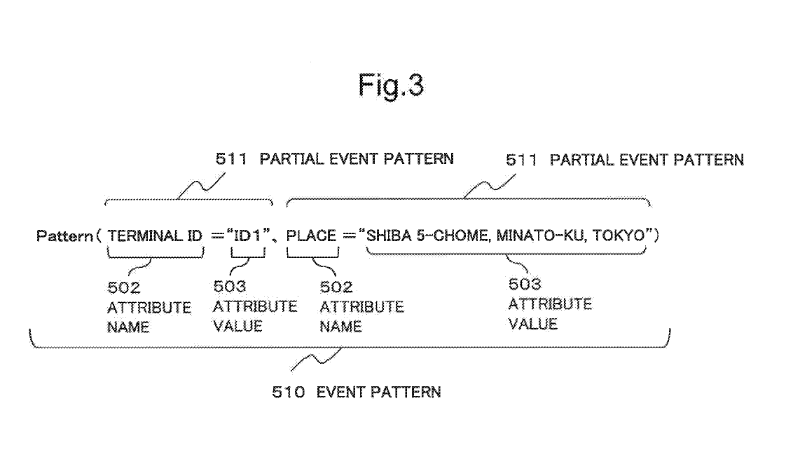

FIG. 3 is a figure showing an example of a structure and contents of an event pattern 510. The event pattern 510 is data which specifies a condition of the event 500.

The event pattern 510 includes the attribute value 503 corresponding to each of the attribute names 502 for a subset of the attribute names 502 of the attribute 501 of which the event 500 is structured. In the event pattern 510, one which combined the attribute name 502 and the corresponding attribute value 503 together is called a partial event pattern 511.

For example, in FIG. 3, the event pattern 510 includes the partial event pattern 511 for a subset {terminal ID, position} of a set {terminal ID, position, time} of the attribute names 502 included in the event 500.

The partial event patterns 511 are the attribute name 502 “terminal ID” and its corresponding attribute value 503 “ID1”, and the attribute name 502 “place” and its corresponding attribute value 503 “Shiba 5-chome, Minato-ku, Tokyo”.

Also, for example, the partial event patterns 511 in the event pattern 510 ‘Pattern(terminal ID=“ID1”, place=“Marunouchi 1-chome, Chiyoda-ku, Tokyo”)’ are ‘terminal ID=“ID1”’ and ‘place=“Marunouchi 1-chome, Chiyoda-ku, Tokyo”’.

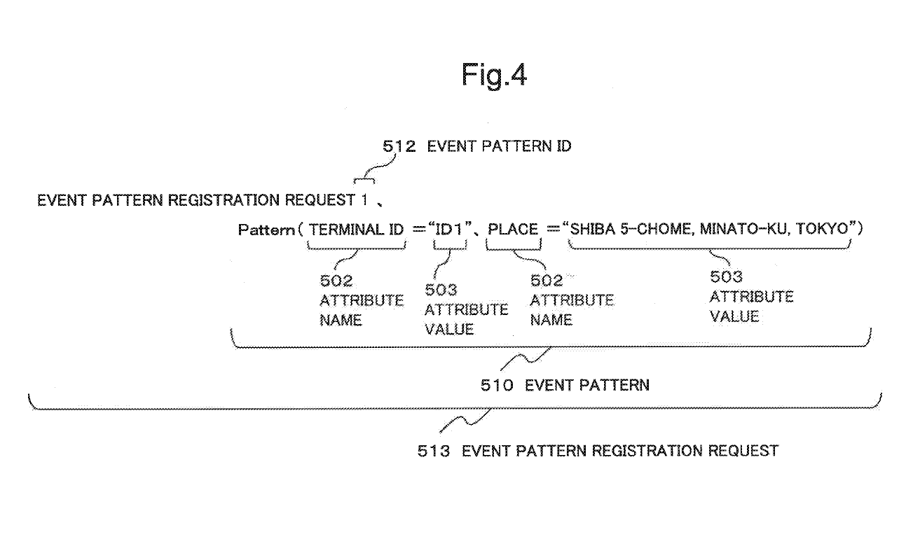

FIG. 4 is a figure showing an example of a structure and contents of an event pattern registration request 513. The event pattern registration request 513 includes the event pattern 510 and an event pattern ID 512 as arguments.

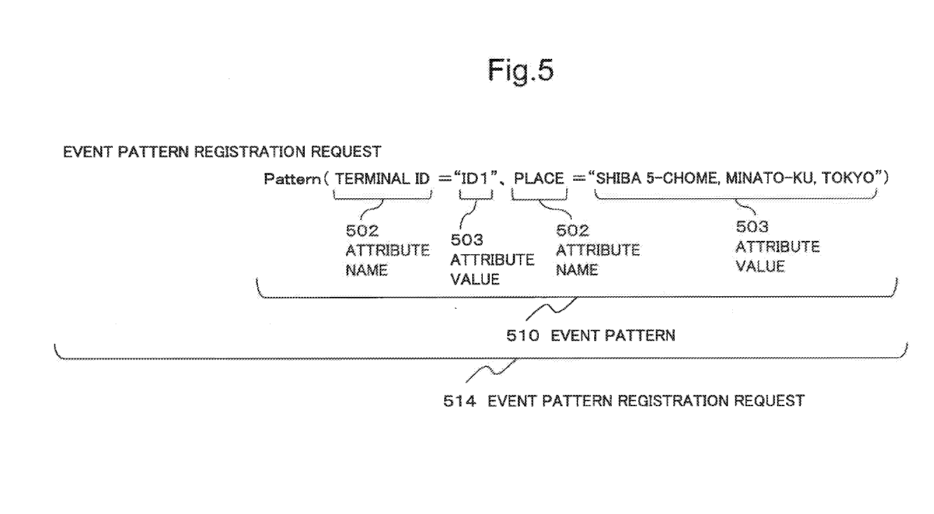

FIG. 5 is a figure showing an example of a structure and contents of an event pattern registration request 514. The event pattern registration request 514 includes the event pattern 510 as an argument.

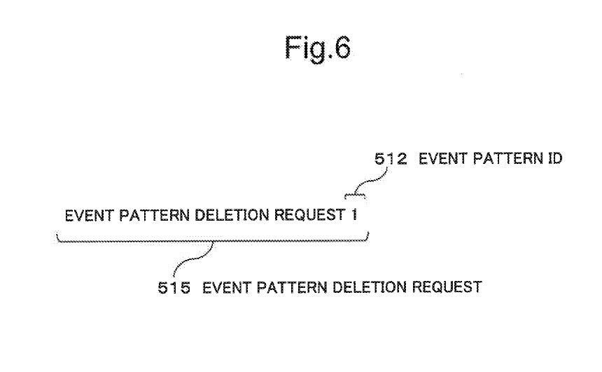

FIG. 6 is a figure showing an example of a structure and contents of an event pattern deletion request 515. The event pattern deletion request 515 includes the event pattern ID 512 as an argument.

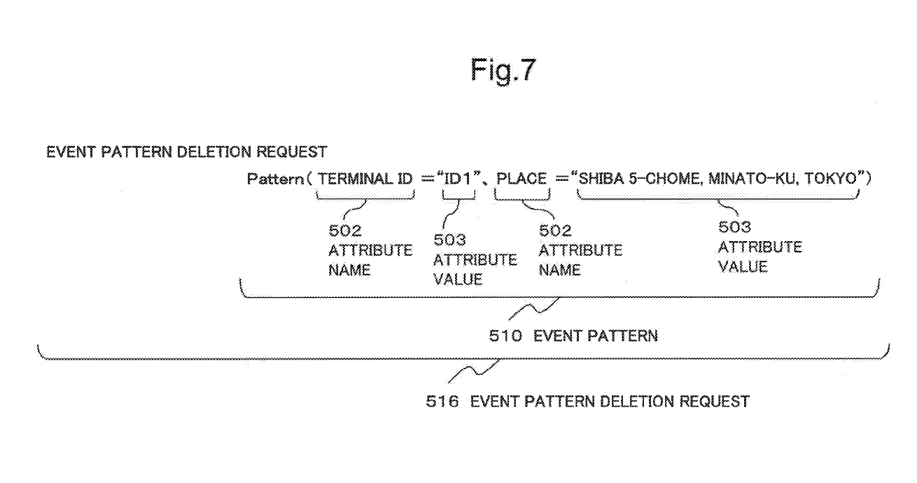

FIG. 7 is a figure showing an example of a structure and contents of an event pattern deletion request 516. The event pattern deletion request 516 includes the event pattern 510 as an argument.

The event pattern matching assessment unit 110 performs event matching of the event 500 on the basis of each of the attribute value matching assessment instances 142 of which an event pattern matching tree 141 (detailed description will be made later) is structured.

The event pattern matching assessment unit 110 receives the event 500 from the event entry operator 820. Also, the event pattern matching assessment unit 110 performs event matching of the received event 500 on the basis of the event pattern matching tree 141 held in the event pattern matching tree holding unit 140.

Moreover, in case the event 500 matches with the event pattern 510, the event pattern matching assessment unit 110 transmits the event 500 to the event recipient 830.

That the event 500 matches with the event pattern 510 means that the attribute values 503 corresponding to all the attribute names 502 included in the event pattern 510 match with the attribute values 503 corresponding to the same attribute names 502 of the event 500.

For example, the attribute value 503 “ID1” corresponding to the attribute name 502 “terminal ID” included in the event pattern 510 of FIG. 3 matches with the attribute value 503 “ID1” corresponding to the attribute name 502 “terminal ID” included in the event 500 of FIG. 2. And the attribute value 503 “Shiba 5-chome, Minato-ku, Tokyo” corresponding to the attribute name 502 “place” included in the event pattern 510 of FIG. 3 matches with the attribute value 503 “Shiba 5-chome, Minato-ku, Tokyo” corresponding to the attribute name 502 “place” included in the event 500 of FIG. 2.

Accordingly, the event 500 of FIG. 2 matches with the event pattern 510 of FIG. 3. The event pattern 510 of FIG. 3 does not include the attribute value 503 corresponding to the attribute name 502 “time” included in the event 500. This means that the event 500 matches with the event pattern 510 whatever a value the attribute name 502 “time” included in the event 500 takes.

Also, in case event matching is executed, the event pattern matching assessment unit 110 transmits the attribute name 502 held in an attribute name field 143 of the attribute value matching assessment instance 142 and a matching result to the tree dependent matching ratio measurement unit 130.

The matching result is, for example, in case there exists an instance 540 which can be referred next, ‘1’, and in case not, ‘0’.

Further, a case when the instance 540 which can be referred exists is the case when the same value as the attribute value 503 of the event 500 which the attribute value matching assessment instance 142 received exists in a key 148 of a hash table 145 of the attribute value matching assessment instance 142. Or a case when the instance 540 which can be referred exists is the case when an * field 144 is not NULL.

Also, a case when the instance 540 which can be referred does not exist is the case when the same value as the attribute value 503 of the event 500 which the attribute value matching assessment instance 142 received does not exist in the key 148 of the hash table 145 of the attribute value matching assessment instance 142, and the * field 144 is NULL.

The event pattern matching tree generation unit 120 refers a matching ratio measurement table 131 (detailed description will be made later) and generates the event pattern matching tree 141 (detailed description will be made later) which arranged on an upper level the instance 540 including the same attribute name 502 as an attribute name 132 which has a relatively low matching ratio 135. Successively, the event pattern matching tree generation unit 120 records the generated event pattern matching tree 141 in the event pattern matching tree holding unit 140. In this way, the event pattern matching tree generation unit 120 organizes or reorganizes the event pattern matching tree 141.

Further, for example, timing when the event pattern matching tree generation unit 120 reorganizes the event pattern matching tree 141 may be at fixed time intervals.

Also, for example, in case the matching ratio 135 corresponding to a certain attribute name 502 is lower than the matching ratio 135 corresponding to the attribute name 502 held in a root node 192 of the event pattern matching tree 141, the event pattern matching tree generation unit 120 may reorganize the event pattern matching tree 141.

Also, for example, in case it is detected that the attribute name 502 does not appear in the ascending order of the matching ratio 135 from the root node 192 to a leaf node 193 of the event pattern matching tree 141, the event pattern matching tree generation unit 120 may reorganize the event pattern matching tree 141.

By making reception of the event pattern registration request 514 from the event pattern receiving unit 160 as a trigger, the event pattern matching tree generation unit 120 starts operation.

Also, by making reception of the event pattern deletion request 516 from the event pattern receiving unit 160 as a trigger, the event pattern matching tree generation unit 120 starts operation.

The tree dependent matching ratio measurement unit 130 measures the matching ratio 135 of all the attribute names 502 included in the event pattern 510.

Definition of the matching ratio 135 is as follows. The matching ratio 135 of the attribute name 502 ‘A’ of the event pattern 510 ‘P’ will be N/NALL. NALL is a number of the events 500 which become a target to calculate the matching ratio 135. N is, among the events 500 which become the target, a number of the events 500 of which the attribute value 503 corresponding to the attribute name 502 ‘A’ of the event pattern 510 ‘P’ matches with the attribute value 503 corresponding to the attribute name 502 ‘A’ of the event 500.

Description will be made by showing a specific example. For example, suppose that the events 500 which become the target to calculate the matching ratio 135 are two of ‘EVENT(terminal ID=“ID1”, place=“Shiba 5-chome, Minato-ku, Tokyo”, time=“10:10:25”)’ and ‘EVENT(terminal ID=“ID2”, place=“Shiba 5-chome, Minato-ku, Tokyo”, time=“10:10:25”)’.

In this case, for example, in the event pattern 510 of FIG. 3, the attribute value 503 ‘ID1’ of the attribute name 502 ‘terminal ID’ matches with the first event 500 and does not match with the second event 500. Accordingly, the matching ratio 135 of the attribute name 132 ‘terminal ID’ in the matching ratio measurement table 131 (detailed description will be made later) will become, as NALL=2 and N=1, 1/2.

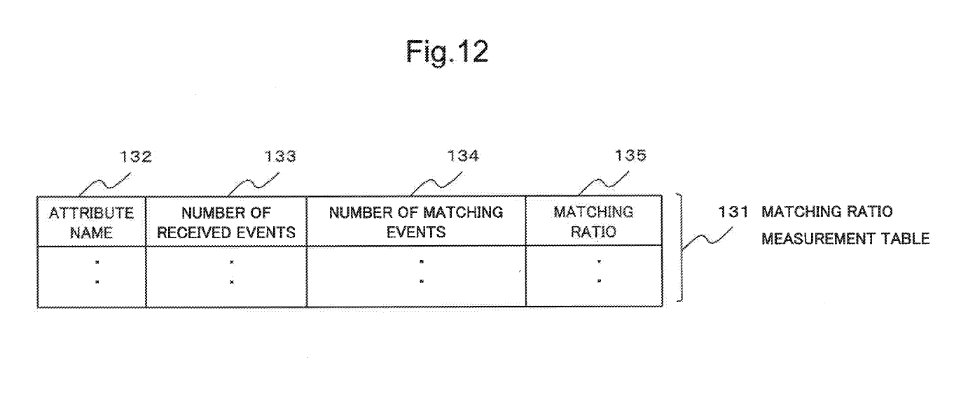

The tree dependent matching ratio measurement unit 130 holds the matching ratio measurement table 131 shown in FIG. 12.

FIG. 12 is a figure showing a structure of the matching ratio measurement table 131. The matching ratio measurement table 131 is stored in a memory which is not illustrated in the tree dependent matching ratio measurement unit 130. The matching ratio measurement table 131 includes arbitrary number of lines including columns which store the attribute name 132, a number of received events 133, a number of matching events 134 and the matching ratio 135 respectively.

In the number of received events 133, a total number of the matching results received from the event pattern matching assessment unit 110 is stored. That is, the total number is, in each of the attribute value matching assessment instances 142 which has the attribute name 502 with the same value as the attribute name 132 as a value of the attribute name field 143, the total number of the events 500 for which event matching is executed.

In the number of matching events 134, a total number of cases when the matching result received from the event pattern matching assessment unit 110 is ‘1’ is stored. That is, the total number is, in the attribute value matching assessment instance 142 which has the attribute name 502 with the same value as the attribute name 132 as a value of the attribute name field 143, the number of cases when the instance 540 which can be referred next exists when event matching is executed.

In the matching ratio 135, a value which divided the number of matching events 134 by the number of received events 133 is stored. Further, the matching ratio 135 does not need to be included in the matching ratio measurement table 131 necessarily. That is, the matching ratio 135 may be obtained by dividing the number of matching events 134 by the number of received events 133 when the matching ratio 135 is acquired by the event pattern matching tree generation unit 120.

The tree dependent matching ratio measurement unit 130 receives the attribute name 502 and the matching result from the event pattern matching assessment unit 110.

Also, the tree dependent matching ratio measurement unit 130 detects, in the matching ratio measurement table 131, a line including the attribute name 132 which matches with the received attribute name 502.

Successively, in case the matching result received from the event pattern matching assessment unit 110 is ‘1’, the tree dependent matching ratio measurement unit 130 increments, in the detected line, the values of the number of received events 133 and the number of matching events 134.

Successively, the tree dependent matching ratio measurement unit 130 updates the matching ratio 135 corresponding to the result which incremented the values of the number of received events 133 and the number of matching events 134. Also, in case the matching result is ‘0’, the tree dependent matching ratio measurement unit 130 increments, in the detected line, only the value of the number of received events 133.

Successively, the tree dependent matching ratio measurement unit 130 updates the matching ratio 135 corresponding to the result which incremented the value of the number of received events 133.

The event pattern matching tree holding unit 140 holds the event pattern matching tree 141.

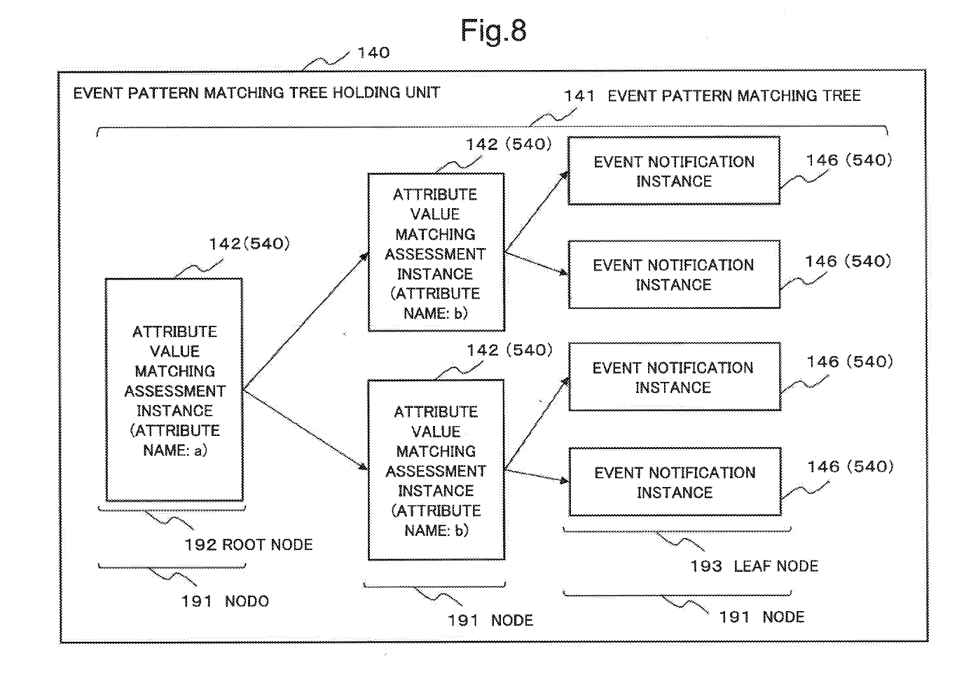

FIG. 8 is a figure showing a structure of the event pattern matching tree 141 held in the event pattern matching tree holding unit 140.

As shown in FIG. 8, the event pattern matching tree 141 includes a tree structure including a node 191. The node 191 other than the leaf node 193 among the nodes 191 is the attribute value matching assessment instance 142. Also, the leaf node 193 among the nodes 191 is an event notification instance 146.

An initial state of the event pattern matching tree holding unit 140 is a state where the attribute value matching assessment instance 142 and event notification instance 146 do not exist at all, and the event pattern matching tree 141 does not exist. Hereinafter, in case the attribute value matching assessment instance 142 and the event notification instance 146 are expressed without distinction, they are collectively called the instance 540.

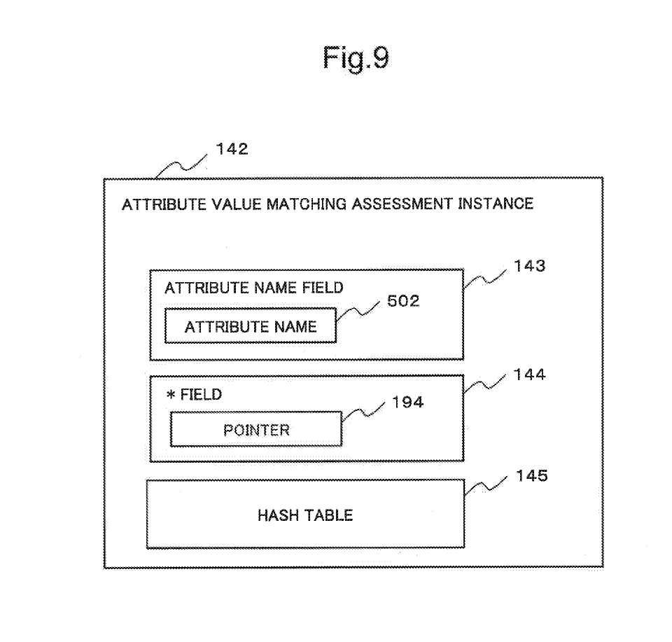

FIG. 9 is a figure showing a structure of the attribute value matching assessment instance 142. As shown in FIG. 9, the attribute value matching assessment instance 142 includes the attribute name field 143, the * field 144 and the hash table 145.

The attribute name field 143 holds the attribute name 502 which the attribute value matching assessment instance 142 makes a target of assessment.

The * field 144 holds a pointer 194 to the instance 540 which can be referred next in the processing of event matching of the event 500 regardless of the attribute value 503 included in the event 500.

Further, event matching is to assess whether the attribute 501 of which the event 500 is structured matches with the partial event pattern 511 included in the event pattern 510 registered in advance.

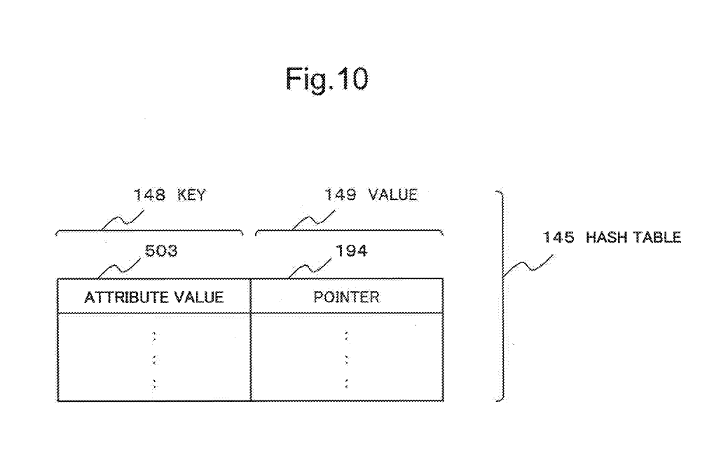

FIG. 10 is a figure showing a structure of the hash table 145. The hash table 145 holds the attribute value 503 as the key 148, and the pointer 194 as a value 149 as shown in FIG. 10. Here, the pointer 194 is the pointer 194 to the instance 540 which can be referred next in case the attribute value 503 of the event 500 is the same value as the key 148.

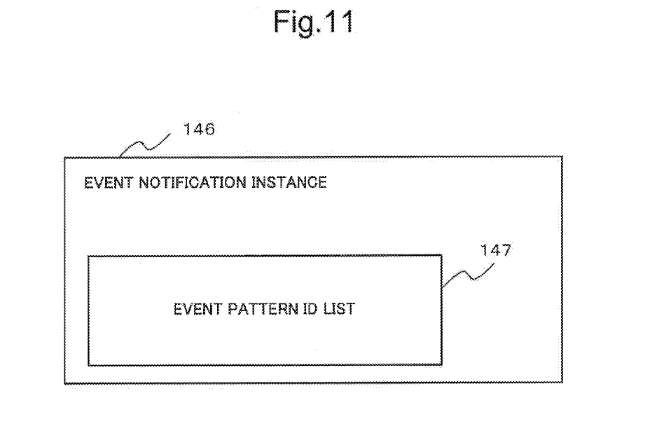

FIG. 11 is a figure showing a structure of the event notification instance 146. As shown in FIG. 11, the event notification instance 146 holds an event pattern ID list 147 described later comprising the event pattern ID 512.

In case the event 500 matches with the event pattern 510 identified by the event pattern ID 512, the event pattern matching assessment unit 110 gives those event pattern IDs 512 to the events 500, and notifies the event recipient 830.

The event pattern table holding unit 150 holds the event pattern 510 and its event pattern ID 512 registered in the event pattern matching assessment system 100 in an event pattern table 151.

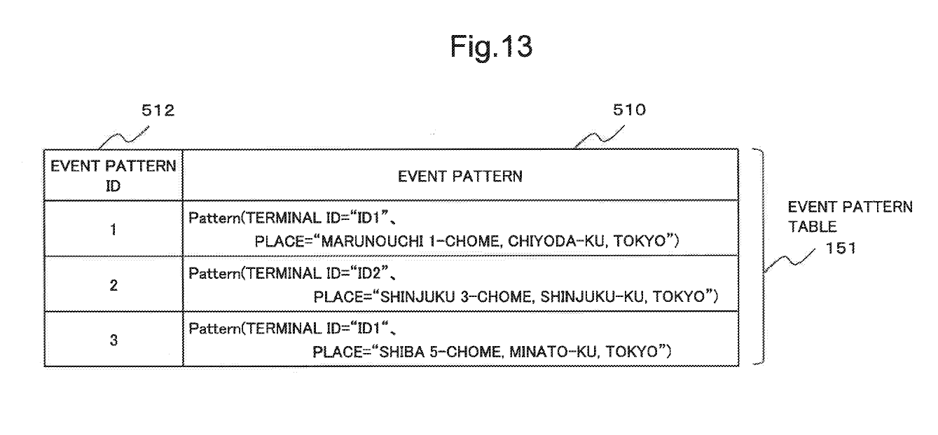

FIG. 13 is a figure showing an example of a structure and contents of the event pattern table 151. The event pattern table 151 includes arbitrary number of lines including columns which store the event pattern 510 and the event pattern ID 512 which identifies the event pattern 510.

In an example shown in FIG. 13, the event pattern table 151 includes following three lines.

A first line includes the event pattern 510 ‘Pattern(terminal ID=“ID1”, place=“Marunouchi 1-chome, Chiyoda-ku, Tokyo”)’ and its event pattern ID 512 ‘1’.

A second line includes the event pattern 510 ‘Pattern(terminal ID=“ID2”, place=“Shinjuku 3-chome, Shinjuku-ku, Tokyo”)’ and its event pattern ID 512 ‘2’.

A third body includes the event pattern 510 ‘Pattern(terminal ID=“ID1”, place=“Shiba 5-chome, Minato-ku, Tokyo”)’ and its event pattern ID 512 ‘3’. That is, three event patterns 510 mentioned above are registered in the event pattern matching assessment system 100.

When the event pattern registration request 513 is received from the event pattern administrator 840, the event pattern receiving unit 160 records the event pattern 510 and the event pattern ID 512 included in the event pattern registration request 513 in the event pattern table 151 of the event pattern table holding unit 150.

Next, the event pattern receiving unit 160 transmits the event pattern registration request 514 to the event pattern matching tree generation unit 120.

Also, the event pattern receiving unit 160 receives the event pattern deletion request 515 from the event pattern administrator 840. At this time, the event pattern receiving unit 160 refers the event pattern table 151 of the event pattern table holding unit 150 and acquires the event pattern 510 with the event pattern ID 512 included in the event pattern deletion request 515.

Next, the event pattern receiving unit 160 transmits the event pattern deletion request 516 including the acquired event pattern 510 to the event pattern matching tree generation unit 120.

Next, the event pattern receiving unit 160 deletes the line in which the event pattern ID 512 included in the event pattern deletion request 515 is recorded from the event pattern table 151 of the event pattern table holding unit 150.

Next, operation of the whole of this exemplary embodiment will be described in detail with reference to drawings. Operation of this exemplary embodiment can be divided roughly into two. One operation is operation of event matching of the event 500. The other operation is operation of organization and reorganization of the event pattern matching tree 141.

First, operation of event matching of the event 500 will be described.

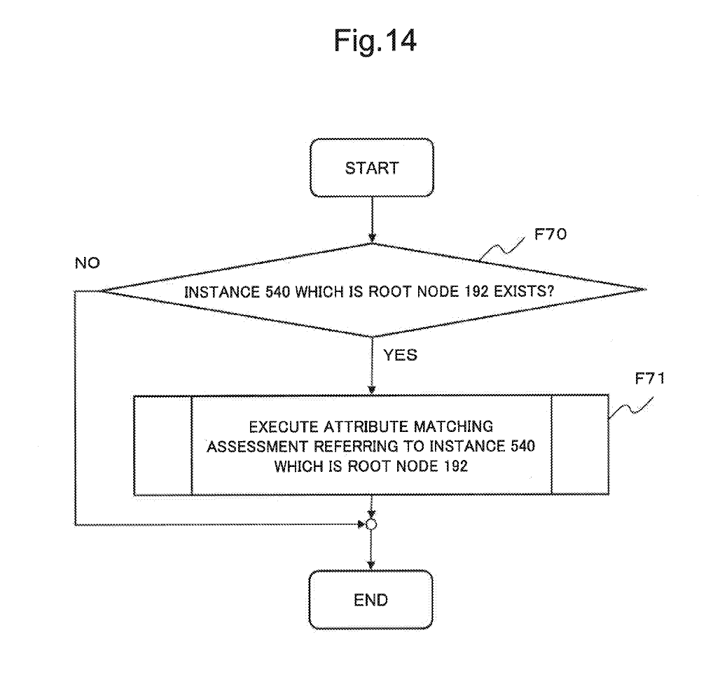

FIG. 14 is a flow chart showing operation, among operations of event matching of the event 500, when the event 500 is inputted to the event pattern matching assessment unit 110.

When the event 500 is inputted, the event pattern matching assessment unit 110 confirms existence of the instance 540 which is the root node 192 of the event pattern matching tree 141 (Step F70).

And in case the instance 540 which is the root node 192 exists (YES in Step F70), the event pattern matching assessment unit 110 executes attribute matching assessment with reference to the instance 540 which is the root node 192 (Step F71).

Also, in case the instance 540 which is the root node 192 does not exist (NO in Step F70), the event pattern matching assessment unit 110 ends event matching.

Attribute matching assessment of Step F71 will be described in detail.

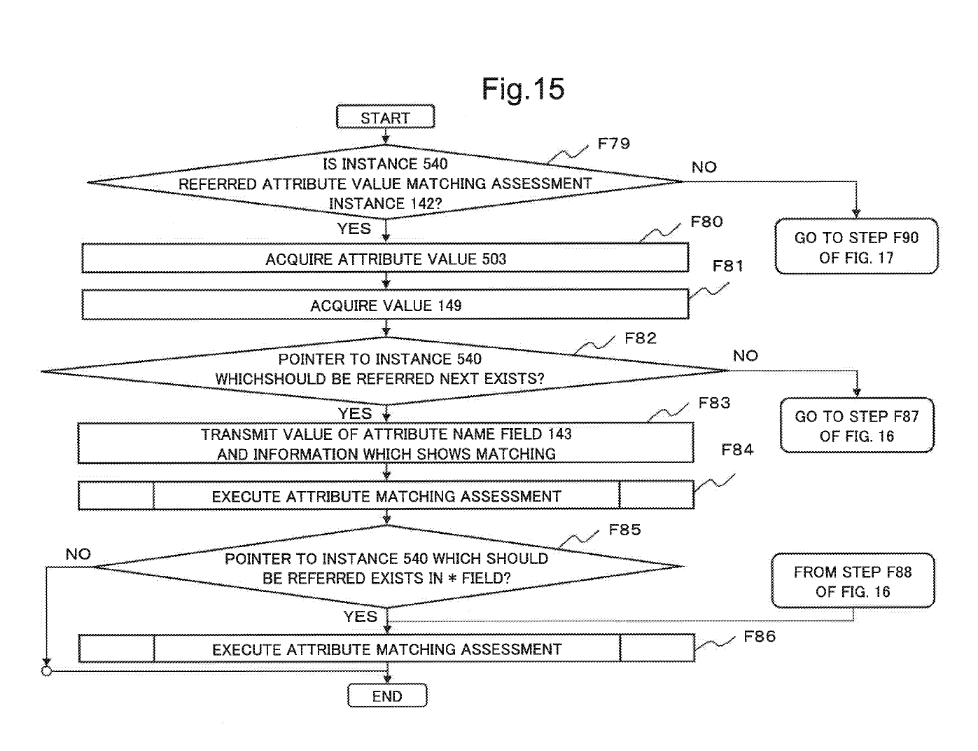

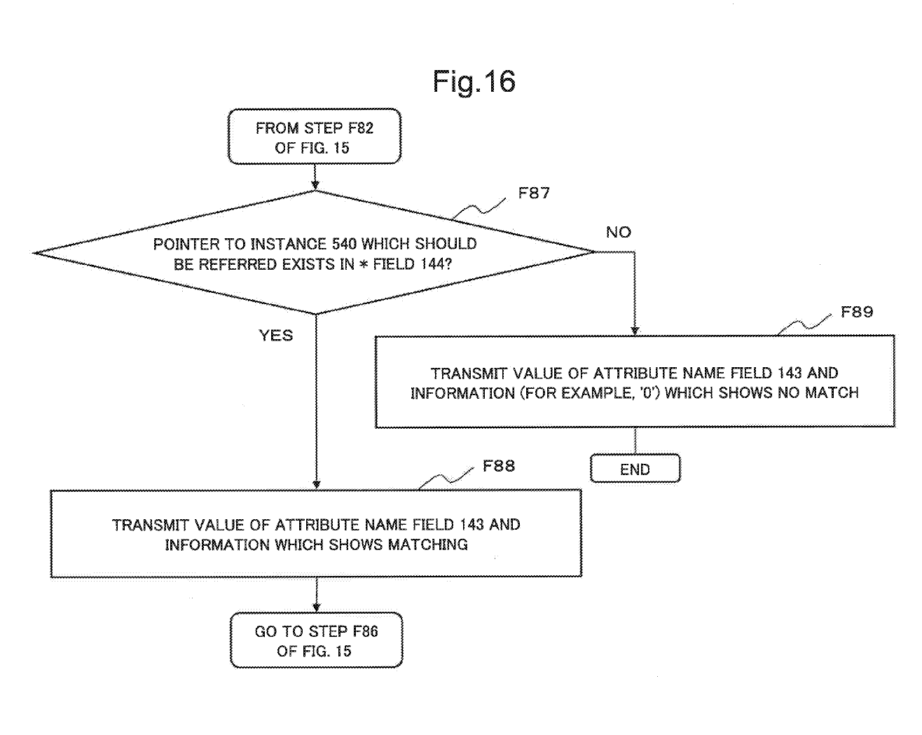

FIG. 15 and FIG. 16 are flow charts showing, among operations of event matching of the event 500, operation of attribute matching assessment in case the instance 540 referred is the attribute value matching assessment instance 142.

First, the event pattern matching assessment unit 110 assesses whether the instance 540 referred is the attribute value matching assessment instance 142 or the event notification instance 146 (Step F79).

And in case of the attribute value matching assessment instance 142 (YES in Step F79), processing proceeds to Step F80.

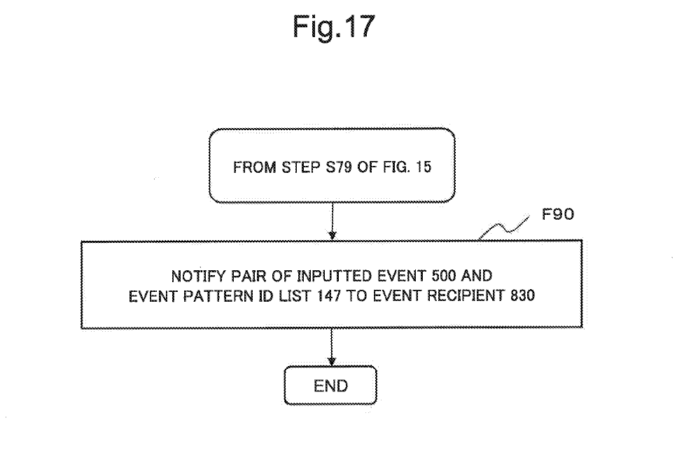

Also, in case of the event notification instance 146 (NO in Step F79), processing proceeds to Step F90 of FIG. 17.

In Step F80, the event pattern matching assessment unit 110 acquires the attribute value 503 corresponding to the attribute name 502 of the attribute value matching assessment instance 142 referred from the inputted event 500 (Step F80).

Next, the event pattern matching assessment unit 110 refers the hash table 145 making the attribute value 503 as the key 148 and acquires the value 149 (Step F81).

Next, the event pattern matching assessment unit 110 confirms whether the value 149 corresponding to the attribute value 503, that is, the pointer 194 to the instance 540 which can be referred next exists (Step F82).

And in case the pointer 194 exists (YES in Step F82), processing proceeds to Step F83, and in case the pointer does not exist (NO in Step F82), processing proceeds to Step F87.

In Step F83, the event pattern matching assessment unit 110 transmits a value of the attribute name field 143 and information which shows matching (for example, ‘1’) to the tree dependent matching ratio measurement unit 130 (Step F83).

Next, the event pattern matching assessment unit 110 executes attribute matching assessment with reference to the instance 540 whose existence is confirmed in Step F82 (Step F84). Further, Step F84 operates with processing of Steps F79 to F90 as a nested structure.

Next, the event pattern matching assessment unit 110 confirms whether the pointer 194 to the instance 540 which can be referred exists in the * field 144 of the attribute value matching assessment instance 142 referred (Step F85).

And in case the pointer 194 exists (YES in Step F85), the event pattern matching assessment unit 110 executes attribute matching assessment with reference to the instance 540 whose existence is confirmed in Step F85 (Step F86). Further, Step F86 operates with processing of Steps F79 to F90 as a nested structure.

Also, in case the pointer 194 does not exist (NO in Step F85), processing ends.

In Step F87, the event pattern matching assessment unit 110 confirms whether the pointer 194 to the instance 540 which can be referred exists in the * field 144 (Step F87).

And in case the pointer 194 exists (YES in Step F87), processing proceeds to Step F88, and in case the pointer 194 does not exist (NO in Step F87), processing proceeds to Step F89.

In Step F88, the event pattern matching assessment unit 110 transmits a value of the attribute name field 143 and information which shows matching (for example, ‘1’) to the tree dependent matching ratio measurement unit 130 (Step F88).

In Step F89, the event pattern matching assessment unit 110 transmits a value of the attribute name field 143 and information which shows no match (for example, ‘0’) to the tree dependent matching ratio measurement unit 130 (Step F89).

Next, the event pattern matching assessment unit 110 executes attribute matching assessment with reference to the instance 540 whose existence is confirmed in Step F85 or Step F87 (Step F86).

FIG. 17 is a flow chart showing, among operations of event matching of the event 500, operation of attribute matching assessment in case the instance 540 referred is the event notification instance 146.

In Step F90, the event pattern matching assessment unit 110 notifies the event recipient 830 of a pair of the inputted event 500 and the event pattern ID list 147 recorded in the event notification instance 146 referred (Step F90).

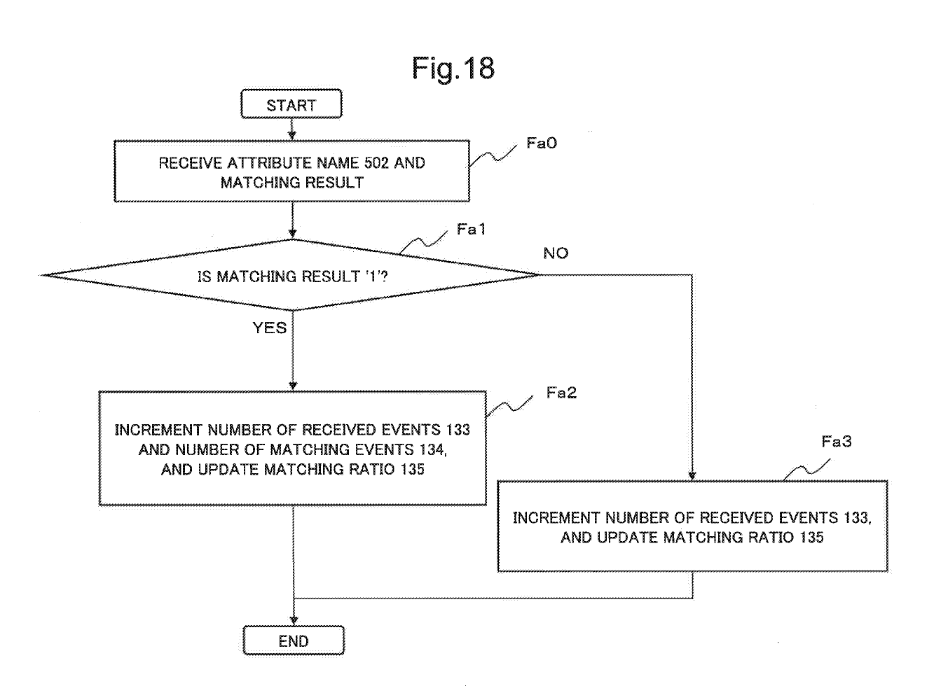

FIG. 18 is a flow chart showing, among operations of event matching of the event 500, operation which updates the matching ratio 135 corresponding to each of the attribute names 502 in the tree dependent matching ratio measurement unit 130.

First, the tree dependent matching ratio measurement unit 130 receives the attribute name 502 and the matching result from the event pattern matching assessment unit 110 (Step Fa0).

Next, the tree dependent matching ratio measurement unit 130 assesses the matching result (Step Fa1). And in case the matching result is ‘1’ (YES in Step Fa1), processing proceeds to Step Fa2, and in case the matching result is ‘0’ (NO in Step Fa1), processing proceeds to Step Fa3.

In Step Fa2, the tree dependent matching ratio measurement unit 130 increments, in the matching ratio measurement table 131, the number of received events 133 and the number of matching events 134 in a line including the same attribute name 132 as the attribute name 502 of the instance 540. And the tree dependent matching ratio measurement unit 130 updates the matching ratio 135 (Step Fa2).

In Step Fa3, the tree dependent matching ratio measurement unit 130 increments, in the matching ratio measurement table 131, the number of received events 133 in a line including the same attribute name 132 as the attribute name 502 of the instance 540. And the tree dependent matching ratio measurement unit 130 updates the matching ratio 135 (Step Fa3).

Next, operation of event matching of the event 500 will be described using a specific example.

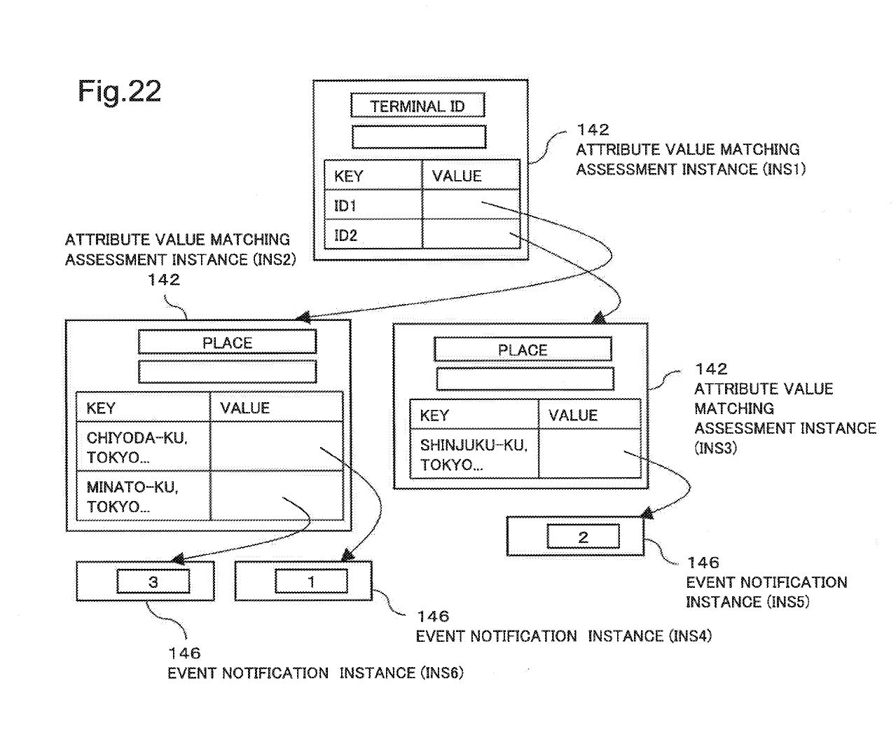

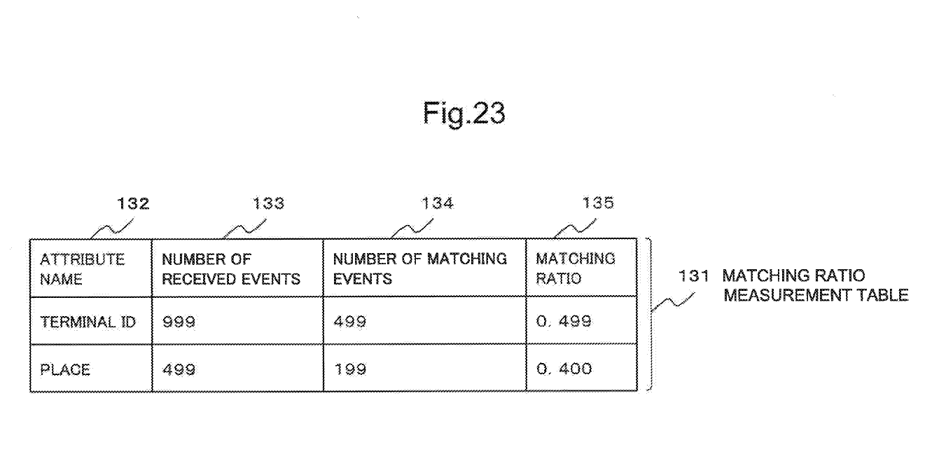

As a premise, it is supposed that the event pattern matching tree 141 shown in FIG. 22 is registered in the event pattern matching assessment system 100. Also and similarly, it is supposed that the matching ratio measurement table 131 shown in FIG. 23 is held in the tree dependent matching ratio measurement unit 130.

Also and similarly, it is supposed that the event pattern matching assessment system 100 received in the event pattern matching assessment unit 110 the event 500 ‘EVENT(terminal ID=“ID1”, place=“Shiba 5-chome, Minato-ku, Tokyo”, time=“10:10:25”)’ shown in FIG. 2.

First, the event pattern matching assessment unit 110 which received the event 500 shown in FIG. 2 confirms whether the attribute value matching assessment instance 142 ‘INS1’ which is the root node 192 of the event pattern matching tree 141 exists as shown in FIG. 22 (Step F70).

Next, the event pattern matching assessment unit 110 executes attribute matching assessment with reference to the attribute value matching assessment instance 142 ‘INS1’ (Step F71).

In Step F71, the event pattern matching assessment unit 110 operates as follows.

First, the event pattern matching assessment unit 110 assesses whether the instance 540 ‘INS1’ is the attribute value matching assessment instance 142 or the event notification instance 146 (Step F79). And since it is the attribute value matching assessment instance 142, processing proceeds to Step F80.

Next, since the attribute name 502 held in the attribute name field 143 of the attribute value matching assessment instance 142 ‘INS1’ is ‘terminal ID’, the event pattern matching assessment unit 110 acquires the attribute value 503 ‘ID1’ of the attribute name 502 ‘terminal ID’ of the received event 500 (Step F80).

Next, the event pattern matching assessment unit 110 refers the hash table 145 making the attribute value 503 ‘ID1’ as the key 148 (Step F81).

And since the attribute value matching assessment instance 142 ‘INS2’ exists (YES in Step F82), the event pattern matching assessment unit 110 transmits the attribute name 502 ‘terminal ID’ and ‘1’ (information which shows matching) to the tree dependent matching ratio measurement unit 130 (Step F83).

The tree dependent matching ratio measurement unit 130 which received the attribute name 502 ‘terminal ID’ and ‘1’ increments a value of the number of received events 133 from ‘999’ to ‘1000’ and a value of the number of matching events 134 from ‘499’ to ‘500’ in the line where the attribute name 132 is ‘terminal ID’ in the matching ratio measurement table 131. Successively, the tree dependent matching ratio measurement unit 130 updates the matching ratio 135 to ‘0.5 (500/1000=0.5)’ (Step Fa2).

Next, the event pattern matching assessment unit 110 executes attribute matching assessment with reference to the attribute value matching assessment instance 142 ‘INS2’ (Step F84).

In the Step F84 (referred to as Step F84 (1)), the event pattern matching assessment unit 110 assesses whether the instance 540 ‘INS2’ is the attribute value matching assessment instance 142 or the event notification instance 146 (Step F79).

And since the instance 540 ‘INS2’ is the attribute value matching assessment instance 142, processing proceeds to Step F80.

Since the attribute name 502 held in the attribute name field 143 of the attribute value matching assessment instance 142 ‘INS2’ is ‘place’, the event pattern matching assessment unit 110 acquires the attribute value 503 ‘Shiba 5-chome, Minato-ku, Tokyo’ of the attribute name 502 ‘place’ of the received event 500 (Step F80).

Next, the event pattern matching assessment unit 110 refers the hash table 145 making the value ‘Shiba 5-chome, Minato-ku, Tokyo’ as the key 148 (Step F81).

And since the event notification instance 146 ‘INS6’ exists (YES in Step F82), the event pattern matching assessment unit 110 transmits the attribute name 502 ‘place’ and ‘1’ to the tree dependent matching ratio measurement unit 130 (Step F83).

The tree dependent matching ratio measurement unit 130 which received the attribute name 502 ‘place’ and ‘1’ increments a value of the number of received events 133 from ‘499’ to ‘500’ and a value of the number of matching events 134 from ‘199’ to ‘200’ in the line where the attribute name 132 is ‘place’ in the matching ratio measurement table 131. Successively, the tree dependent matching ratio measurement unit 130 updates the matching ratio 135 to ‘0.4 (200/500=0.4)’ (Step Fa2).

Next, the event pattern matching assessment unit 110 executes attribute matching assessment with reference to the attribute value matching assessment instance 142 ‘INS6’ (Step F84).

In the Step F84 (referred to as Step F84 (2)), the event pattern matching assessment unit 110 assesses whether the instance 540 ‘INS6’ is the attribute value matching assessment instance 142 or the event notification instance 146 (Step F79).

And since the instance 540 ‘INS6’ is the event notification instance 146, processing proceeds to Step F90.

The event pattern matching assessment unit 110 notifies the event recipient 830 of the event 500 and the event pattern ID 512 ‘3’ held in the event notification instance 146 ‘INS6’ (Step F90). After that, processing of Step F84 (2) ends.

Next, the event pattern matching assessment unit 110 confirms whether the pointer 194 to the instance 540 which can be referred exists in the * field 144 of the attribute value matching assessment instance 142 ‘INS2’ referred (Step F85).

And since the pointer 194 does not exist (NO in Step F85), processing of Step F84 (1) ends.

Next, the event pattern matching assessment unit 110 confirms whether the pointer 194 to the instance 540 which can be referred exists in the * field 144 of the attribute value matching assessment instance 142 ‘INS1’ referred (Step F85).

And since the pointer 194 does not exist (NO in Step F85), processing of Step F71 ends, and processing of event matching ends.

This concludes the description of operation of event matching of the event 500.

Next, operation of organization and reorganization of the event pattern matching tree 141 will be described.

In case of an initial state, that is, the event pattern matching tree 141 does not exist, the event pattern matching tree generation unit 120 organizes the event pattern matching tree 141 by the following operation. Further, for example, by making reception of the event pattern registration request 513 as a trigger, the event pattern matching tree generation unit 120 performs the following operation.

In case the event pattern registration request 513 is received, the event pattern matching tree generation unit 120 generates the attribute value matching assessment instance 142 on the basis of the received event pattern 510.

Successively, the event pattern matching tree generation unit 120 generates the event notification instance 146 which includes the event pattern ID 512 of the received event pattern 510 in the event pattern ID list 147.

Successively, the event pattern matching tree generation unit 120 generates the event pattern matching tree 141 which makes these generated attribute value matching assessment instance 142 and event notification instance 146 the root node 192 and the leaf node 193 respectively.

Next, the event pattern matching tree generation unit 120 records the generated event pattern matching tree 141 in the event pattern matching tree holding unit 140.

Further, for example, by making that it has reached a time set in advance or that a fixed time has passed as a trigger, the event pattern matching tree generation unit 120 may execute reorganization of the event pattern matching tree 141.

Or, by making that the event patterns 510 with a number set in advance are registered in the event pattern table 151 and so on as a trigger, the event pattern matching tree generation unit 120 may execute reorganization of the event pattern matching tree 141.

Also, for example, in case the events 500 which the event pattern matching assessment system 100 receives are few, the event pattern matching tree generation unit 120 may execute reorganization of the event pattern matching tree 141.

Also, for example, in case the matching ratio 135 corresponding to the attribute name 502 which the root node 192 of the event pattern matching tree 141 holds exceeds a threshold value, the event pattern matching tree generation unit 120 may execute reorganization of the event pattern matching tree 141.

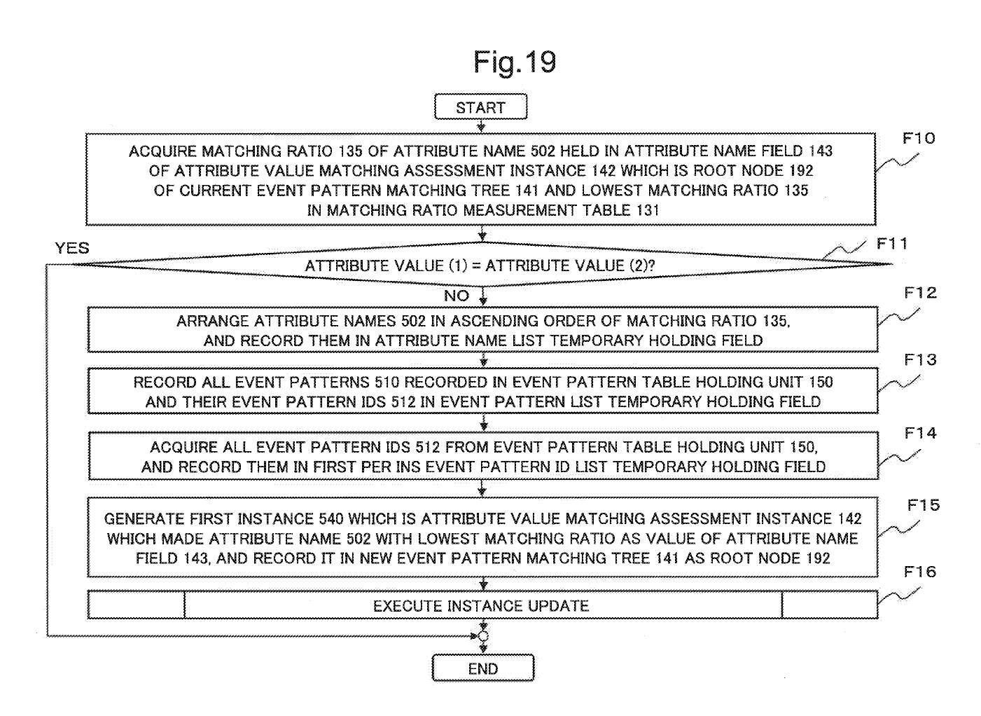

In case the event pattern matching tree generation unit 120 executes reorganization of the event pattern matching tree 141 by these triggers, the processing starts from Step F12 of FIG. 19 mentioned later.

In case the event pattern matching tree 141 already exists, the event pattern matching tree generation unit 120 reorganizes the event pattern matching tree 141 by the following operation.

Hereinafter, for convenience of explanation, the event pattern matching tree 141 before reorganization is called a current event pattern matching tree 141. Also, the event pattern matching tree 141 after reorganization is called a new event pattern matching tree 141.

Also, similarly for convenience of explanation, there may be cases when a prefix of such as “first” and “second” is added to such as a per INS event pattern ID list temporary holding field and the instance 540.

Moreover, similarly for convenience of explanation, there may be cases when a suffix such as (1) and (2) is added to such as the matching ratio 135, the per INS event pattern ID list temporary holding field and steps of processing.

FIG. 19 is a flow chart showing, among operations by which the event pattern matching tree generation unit 120 reorganizes the event pattern matching tree 141, preprocessing and operation which generates the instance 540 which is the root node 192.

The event pattern matching tree generation unit 120 acquires a matching ratio 135 (1) and a matching ratio 135 (2) with reference to the matching ratio measurement table 131 of the tree dependent matching ratio measurement unit 130.

The matching ratio 135 (1) is the matching ratio 135 of the attribute name 502 held in the attribute name field 143 of the attribute value matching assessment instance 142 which is the root node 192 of the current event pattern matching tree 141.

Also, the matching ratio 135 (2) is the lowest matching ratio 135 among the matching ratios 135 included in the matching ratio measurement table 131 (Step F10).

Next, the event pattern matching tree generation unit 120 compares the matching ratio 135 (1) and the matching ratio 135 (2) (Step F11).

And in case the matching ratio 135 (1) and the matching ratio 135 (2) are equal (YES in Step F11), processing ends. That is, in case the matching ratio 135 (1) is the matching ratio 135 (2), since it is a tree structure with good event processing efficiency, the event pattern matching tree generation unit 120 does not reorganize the tree.

On the other hand, in case the matching ratio 135 (1) and the matching ratio 135 (2) are not equal (NO in Step F11), processing proceeds to Step F12. That is, the event pattern matching tree generation unit 120 reorganizes the new event pattern matching tree 141.

In Step F12, the event pattern matching tree generation unit 120 refers the matching ratio measurement table 131 of the tree dependent matching ratio measurement unit 130, arranges the attribute names 132 in the ascending order of the matching ratio 135, and records them in an attribute name list temporary holding field (Step F12).

Further, in case there exist a plurality of the attribute names 132 whose matching ratios 135 are same, the event pattern matching tree generation unit 120 arranges the attribute names 132 in the order the matching ratio 135 is referred. That is, the attribute name list temporary holding field holds the attribute names 132 used in the event pattern 510 registered in the event pattern matching assessment system 100, that is, the attribute names 502, in the ascending order of the matching ratio 135.

Next, the event pattern matching tree generation unit 120 acquires all the event patterns 510 and their event pattern IDs 512 recorded in the event pattern table holding unit 150. Successively, the event pattern matching tree generation unit 120 makes the acquired event patterns 510 and the corresponding event patterns ID 512 pairs and records them in an event pattern list temporary holding field (Step F13).

That is, the event pattern list temporary holding field holds pairs of all the event patterns 510 and their event pattern IDs 512 registered in the event pattern matching assessment system 100.

Next, the event pattern matching tree generation unit 120 acquires all the event pattern IDs 512 from the event pattern table holding unit 150 and records them in a first per INS event pattern ID list temporary holding field (Step F14).

Further, the per INS event pattern ID list temporary holding field is generated successively for each of the instances 540.

And in case the instance 540 is the event notification instance 146, the per INS event pattern ID list temporary holding field holds a set of the event patterns ID 512 registered in the instance 540 itself. Or in case the instance 540 is the attribute value matching assessment instance 142, the per INS event pattern ID list temporary holding field holds a set of the event pattern IDs 512 registered in the child instance 540 of the instance 540.

Next, the event pattern matching tree generation unit 120 refers the attribute name list temporary holding field, and generates a first instance 540 which is the attribute value matching assessment instance 142 which made the attribute name 502 with the lowest matching ratio 135 as a value of the attribute name field 143. Successively, the event pattern matching tree generation unit 120 makes the generated attribute value matching assessment instance 142 as the root node 192, and records it in the new event pattern matching tree 141 (Step F15).

Next, the event pattern matching tree generation unit 120 executes instance update on the basis of the value of the first per INS event pattern ID list temporary holding field and the generated first instance 540 (Step F16).

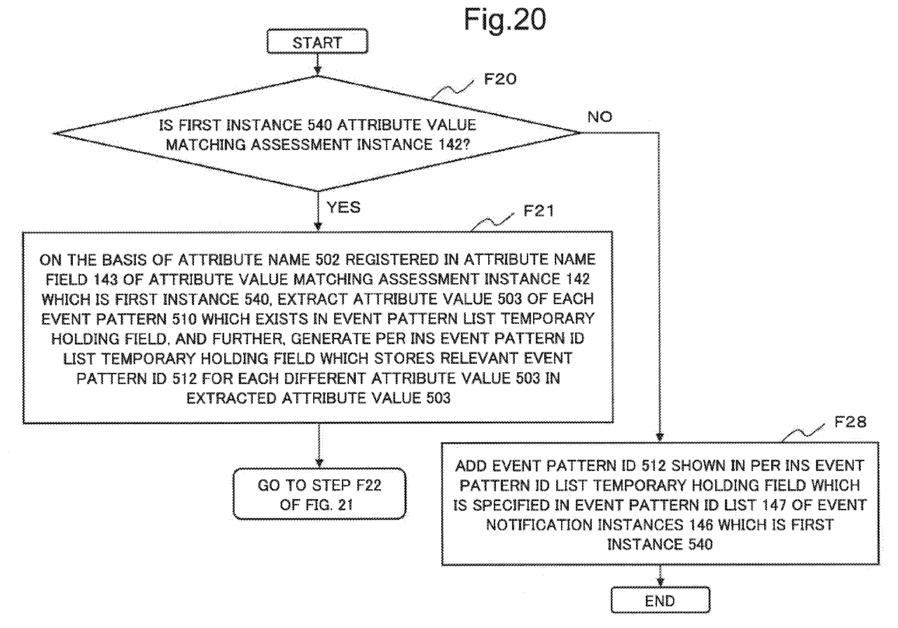

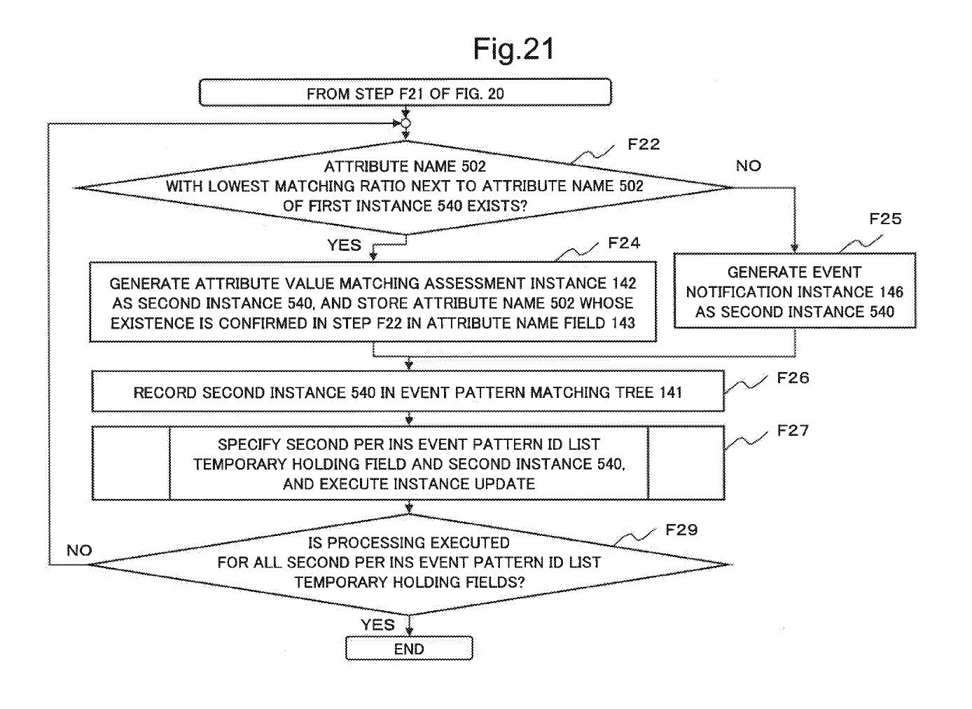

FIG. 20 and FIG. 21 are flow charts showing detailed operation of instance update processing of Step F16.

First, the event pattern matching tree generation unit 120 confirms whether the first instance 540 is the attribute value matching assessment instance 142 (Step F20).

And in case the first instance 540 is the attribute value matching assessment instance 142 (YES in Step F20), processing proceeds to Step F21.

Also, in case the first instance 540 is not the attribute value matching assessment instance 142 (NO in Step F20, that is, it is the event notification instance 146, processing proceeds to Step F28.

In Step F21, the event pattern matching tree generation unit 120 extracts the attribute name 502 registered in the attribute name field 143 of the attribute value matching assessment instance 142 which is the first instance 540.

Successively, the event pattern matching tree generation unit 120 extracts the attribute value 503 of each of the event patterns 510 which exists in the event pattern list temporary holding field on the basis of the extracted attribute name 502.

Further successively, the event pattern matching tree generation unit 120 generates a second per INS event pattern ID list temporary holding field which stores the relevant event pattern ID 512 for each of the singular attribute values 503 among the extracted attribute values 503 (Step F21).

Next, for each per INS event pattern ID list temporary holding field, the event pattern matching tree generation unit 120 updates information of the instance 540 or generates a new instance 540 (Steps F22-F26).

Next, the event pattern matching tree generation unit 120 performs instance update for the generated instance 540 (Step F27). Further, Step F27 operates with instance update processing shown in flow charts of FIG. 20 and FIG. 21 as a nested structure.

Next, the event pattern matching tree generation unit 120 confirms whether processing has been executed for all the second per INS event pattern ID list temporary holding fields generated in Step S21 (Step F29).

And in case processing has been executed for all the second per INS event pattern ID list temporary holding fields (YES in Step F29), processing ends.

Also, in case there exists the second per INS event pattern ID list temporary holding field for which processing has not been executed (NO in Step F29), processing returns to Step F22.

In Step F28, the event pattern matching tree generation unit 120 adds the event pattern ID 512 shown in the specified per INS event pattern ID list temporary holding field to the event pattern ID list 147 of the event notification instance 146 which is the first instance 540 (Step F28). After that, processing ends.

Next, processing of Steps F21-F27 is described in detail by showing a specific example.

First, the event pattern matching tree generation unit 120 extracts the attribute name 502 registered in the attribute name field 143 of the attribute value matching assessment instance 142 which is the first instance 540.

Successively, the event pattern matching tree generation unit 120 extracts the attribute value 503 of each of the event patterns 510 which exists in the event pattern list temporary holding field corresponding to the extracted attribute name 502.

Further successively, the event pattern matching tree generation unit 120 generates the second per INS event pattern ID list temporary holding field for each of the different attribute values 503 among the extracted attribute values 503.

And the event pattern matching tree generation unit 120 stores the relevant event pattern ID 512 in the generated second per INS event pattern ID list temporary holding field.

Further, the event pattern matching tree generation unit 120 also generates the second per INS event pattern ID list temporary holding field for the event patterns 510 of which the attribute value 503 corresponding to the attribute name 502 in the attribute name field 143 of the first instance 540 does not exist in the event pattern 510.

And the event pattern matching tree generation unit 120 stores the relevant event pattern ID 512 in the generated second per INS event pattern ID list temporary holding field (Step F21).

Operation of Step F21 mentioned above will be described by showing a specific example.

For example, it is supposed that the following four event patterns are stored in an event pattern list temporary holding field.

{1, Pattern(terminal ID=“ID1”, place=“Marunouchi 1-chome, Chiyoda-ku, Tokyo”)}.

{2, Pattern(terminal ID=“ID2”, place=“Shinjuku 3-chome, Shinjuku-ku, Tokyo”)}.

{3, Pattern(terminal ID=“ID1”, place=“Shiba 5-chome, Minato-ku, Tokyo”)}.

{4, Pattern(place=“Dogenzaka 1-chome, Shibuya-ku, Tokyo”)}.

Moreover, it is supposed that the attribute name 502 stored in the attribute name field 143 of the attribute value matching assessment instance 142 is ‘terminal ID’.

At this time, the event pattern matching tree generation unit 120 generates three of the second per INS event pattern ID list temporary holding fields including the following values respectively.

“1, 3” (a set of the event pattern IDs 512 of which the attribute name 502 ‘terminal ID’ is “ID1”).

“2” (a set of the event pattern IDs 512 of which the attribute name 502 ‘terminal ID’ is “ID2”).

“4” (a set of the event pattern IDs 512 without the attribute value 503 with the attribute name 502 ‘terminal ID’).

Next, the event pattern matching tree generation unit 120 executes processing of Steps F22 to F27 for each of the generated second per INS event pattern ID list temporary holding fields.

In Step F22, the event pattern matching tree generation unit 120, for the event pattern 510 corresponding to the event pattern ID 512 included in the second per INS event pattern ID list temporary holding field, refers the attribute name list temporary holding field and confirms existence of the attribute name 502 whose matching ratio 135 is lowest next to the attribute name 502 included in the first instance 540 (Step F22).

In case such attribute name 502 exists (YES in Step F22), the event pattern matching tree generation unit 120 generates the attribute value matching assessment instance 142 as a second instance 540 and stores the attribute name 502 whose existence is confirmed in Step F22 in the attribute name field 143 (Step F24).

Also, in case such attribute name 502 does not exist (NO in Step F23), the event pattern matching tree generation unit 120 generates the event notification instance 146 as the second instance 540 (Step F25).

Next, the event pattern matching tree generation unit 120 records the second instance 540 generated in Step F24 or Step F25 in the event pattern matching tree 141 (Step F26).

Specifically, in case the attribute name 502 whose existence is confirmed in Step F22 exists in the second instance 540, the event pattern matching tree generation unit 120 generates the key 148 with the value of the attribute value 503 of the attribute name 502 in the hash table 145 of the first attribute value matching assessment instance 142. And the event pattern matching tree generation unit 120 records the pointer 194 to the second instance 540 in the value 149.

Also, in case the attribute name 502 whose existence is confirmed in Step F22 does not exist in the second attribute value matching assessment instance 142, the event pattern matching tree generation unit 120 records the pointer 194 to the second instance 540 in the * field 144 of the first attribute value matching assessment instance 142.

Also, in case the second instance 540 is the event notification instance 146, the event pattern matching tree generation unit 120 refers the per INS event pattern ID list temporary holding field corresponding to the event notification instance 146.

Successively, the event pattern matching tree generation unit 120 refers the event pattern 510 included in the event pattern ID 512 of the per INS event pattern ID list temporary holding field.

Successively, the event pattern matching tree generation unit 120 generates the key 148 with the value of the attribute value 503 of the attribute name 502 in the event pattern 510 and whose existence is confirmed in Step F22 and records the pointer 194 to the second instance 540 in the value 149.

Next, the event pattern matching tree generation unit 120 specifies the second per INS event pattern ID list temporary holding field and the second instance 540 and executes instance update (Step F27).

Next, operation of the event pattern matching tree 141 reorganization mentioned above will be described by a specific example.

Further, as a premise, it is supposed that the event pattern matching tree holding unit 140 holds the event pattern matching tree 141 shown in FIG. 22.

Similarly, it is supposed that the event pattern table 151 which the event pattern table holding unit 150 holds is in a state shown in FIG. 13.

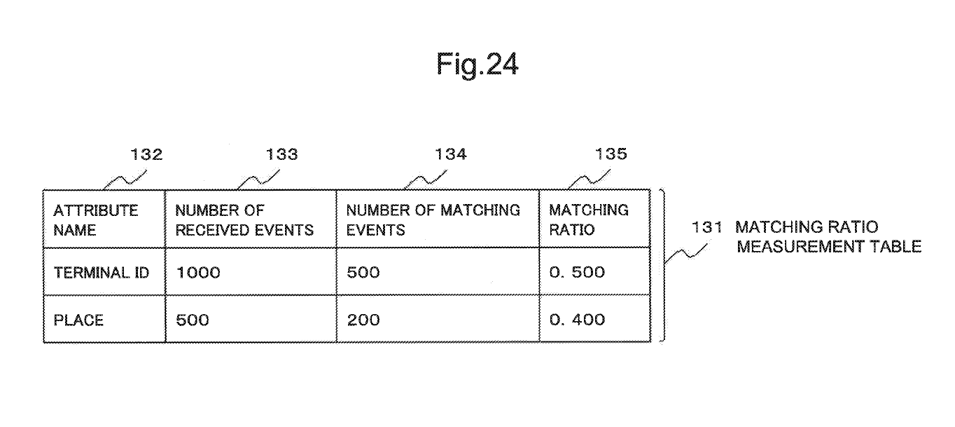

Also and similarly, it is supposed that the matching ratio measurement table 131 which the tree dependent matching ratio measurement unit 130 holds is in a state of FIG. 24.

Also, it is supposed that the event pattern matching tree generation unit 120 reorganizes the event pattern matching tree 141, for example, once a day.

Further, the event pattern matching tree generation unit 120, frequency of reorganization may not be limited to once a day and reorganization may be performed by making the matching ratio 135 of a certain attribute name 132 of the tree dependent matching ratio measurement unit 130 reaching a threshold value as a trigger. Also, reorganization may be performed by making an event input frequency from the event entry operator 820 reaching a threshold value as a trigger. Further, the event pattern matching tree generation unit 120 may not limit reorganization frequency to once a day, and reorganization may be performed by making the matching ratio 135 of a certain attribute name 132 of the tree dependent matching ratio measurement unit 130 reaching a threshold value as a trigger.

The event pattern matching tree generation unit 120 refers the matching ratio measurement table 131 (FIG. 24) of the tree dependent matching ratio measurement unit 130, and acquires the matching ratio 135 ‘0.500’ of ‘terminal ID’ which is the attribute name 502 in the attribute name field 143 of the instance 540 which is the root node 192 of the event pattern matching tree 141 and ‘0.400’ which is the lowest matching ratio 135 in the matching ratio measurement table 131 (Step F10).

Since the matching ratio 135 of the attribute name 132 ‘terminal ID’ and the lowest matching ratio 135 in the matching ratio measurement table 131 are not equal (NO in Step F11), the event pattern matching tree generation unit 120 reorganizes the event pattern matching tree 141.

First, the event pattern matching tree generation unit 120 refers the matching ratio measurement table 131 of the tree dependent matching ratio measurement unit 130, arranges the attribute names 132 in the ascending order of the matching ratio 135 and records them in the attribute name list temporary holding field (Step F12). At this time, the attribute name list temporary holding field will be ‘{position, terminal ID}’.

Next, the event pattern matching tree generation unit 120 acquires all pairs of the event pattern 510 and its event pattern ID 512 from the event pattern table holding unit 150. Successively, the event pattern matching tree generation unit 120 records the acquired pairs in the event pattern list temporary holding field (Step F13).

In the premise of this example, the event pattern list temporary holding field will be: ‘{1, Pattern(terminal ID=“ID1”, place=“Marunouchi 1-chome, Chiyoda-ku, Tokyo”)}, {2, Pattern(terminal ID=“ID2”, place=“Shinjuku 3-chome, Shinjuku-ku, Tokyo”)}, {3, Pattern(terminal ID=“ID1”, place=“Shiba 5-chome, Minato-ku, Tokyo”)}’.

Next, the event pattern matching tree generation unit 120 acquires all the event pattern IDs 512 from the event pattern table holding unit 150 and records the first per INS event pattern ID list temporary holding field (Step F14). In the premise of this example, the first per INS event pattern ID list temporary holding field will be ‘{1, 2, 3}’.

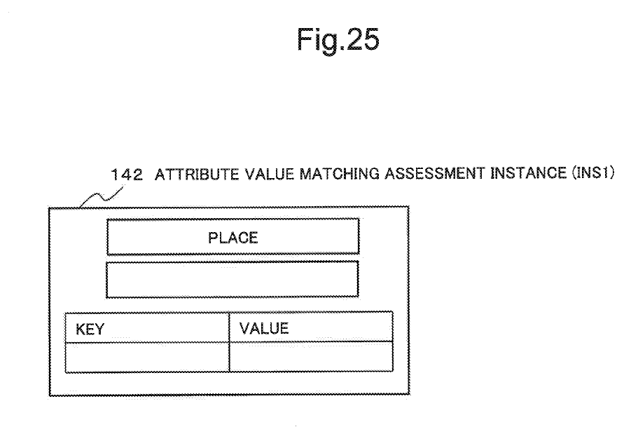

Next, the event pattern matching tree generation unit 120 refers the attribute name list temporary holding field, and generates the attribute value matching assessment instance 142 ‘INS1’ as shown in FIG. 25 as the first instance 540 which made ‘place’ which is the attribute name 502 with the lowest matching ratio 135 as a value of the attribute name field 143 (Step F15). The attribute value matching assessment instance 142 ‘INS1’ is the root node 192 of the new event pattern matching tree 141.

Next, the event pattern matching tree generation unit 120 executes instance update on the basis of the value ‘{1, 2, 3}’ of the first per INS event pattern ID list temporary holding field and the generated first instance 540 ‘attribute value matching assessment instance 142 ‘INS1’’ (Step F16).

In the first Step F20 of Step F16, the event pattern matching tree generation unit 120 confirms whether the first instance 540 is the attribute value matching assessment instance 142. And since the first instance 540 is the attribute value matching assessment instance 142 ‘INS1’ (YES in Step F20), processing proceeds to Step F21.

In Step F21, the event pattern matching tree generation unit 120 generates the second per INS event pattern ID list temporary holding field for the attribute name 502 ‘place’ registered in the attribute name field 143 of the attribute value matching assessment instance 142 ‘INS1’.

Each of the attribute values 503 of the attribute name 502 ‘place’ of each of the event patterns 510 corresponding to the event pattern IDs 512 ‘1’, ‘2’ and ‘3’ included in the first per INS event pattern ID list temporary holding field is different. Accordingly, the event pattern matching tree generation unit 120 generates following three of the second per INS event pattern ID list temporary holding fields.

A second per INS event pattern ID list temporary holding field (1) corresponding to the attribute value 503 “Marunouchi 1-chome, Chiyoda-ku, Tokyo”.

A second per INS event pattern ID list temporary holding field (2) corresponding to the attribute value 503 “Shinjuku 3-chome, Shinjuku-ku, Tokyo”.

A second per INS event pattern ID list temporary holding field (3) corresponding to the attribute value 503 “Shiba 5-chome, Minato-ku, Tokyo”.

And the event pattern matching tree generation unit 120 stores the relevant event pattern IDs 512 in these second per INS event pattern ID list temporary holding fields (1), (2) and (3).

Specifically, the correspondence of the second per INS event pattern ID list temporary holding fields (1), (2) and (3) to event pattern IDs 512 to be stored are: the second per INS event pattern ID list temporary holding field (1)={1}, the second per INS event pattern ID list temporary holding field (2)={2} and the second per INS event pattern ID list temporary holding field (3)={3} (Step F21).

Next, the event pattern matching tree generation unit 120 refers the attribute name list temporary holding field for the event pattern 510 corresponding to the event pattern ID 512 included in the second per INS event pattern ID list temporary holding field (1), and confirms existence of the attribute name 502 whose matching ratio 135 is lowest next to the attribute name 502 ‘place’ of the attribute value matching assessment instance 142 ‘INS1’ (Step F22).

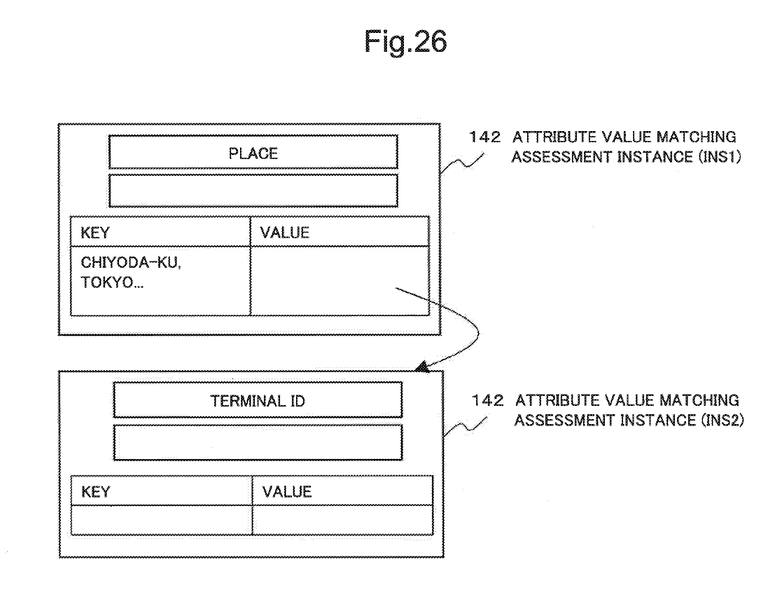

Since the attribute name 502 ‘terminal ID’ exists in the event pattern 510 corresponding to the event pattern ID 512 included in the second per INS event pattern ID list temporary holding field (1) (YES in Step F22), the event pattern matching tree generation unit 120 generates the attribute value matching assessment instance 142 ‘INS2’ which is the second instance 540 shown in FIG. 26.

Successively, the event pattern matching tree generation unit 120 stores the attribute name 502 ‘terminal ID’ whose existence is confirmed in Step F22 in the attribute name field 143 of the attribute value matching assessment instance 142 ‘INS2’ (Step F24).

Next, the event pattern matching tree generation unit 120 records the key ‘Marunouchi 1-chome, Chiyoda-ku, Tokyo’ and its value ‘INS2’ in the hash table 145 of the attribute value matching assessment instance 142 (INS1) (Step F26). At this point, the new event pattern matching tree 141 will be in a state shown in FIG. 26.

Next, the event pattern matching tree generation unit 120 executes instance update (Step F27) on the basis of the second per INS event pattern ID list temporary holding field (1) and the attribute value matching assessment instance 142 ‘INS2’.

In Step F27 (this is made Step F27 (1)), the event pattern matching tree generation unit 120 operates as follows with the second per INS event pattern ID list temporary holding field (1) and the attribute value matching assessment instance 142 ‘INS2’ as the first per INS event pattern ID list temporary holding field and the first instance 540 respectively.

Since the specified first instance 540 is the attribute value matching assessment instance 142 ‘INS2’ (YES in Step F20), the event pattern matching tree generation unit 120 extracts the attribute name 502 ‘terminal ID’ registered in the attribute name field 143 of the attribute value matching assessment instance 142 ‘INS2’.

Successively, the event pattern matching tree generation unit 120 generates, for the attribute name 502 ‘terminal ID’, a second per INS event pattern ID list temporary holding field (4) which corresponds to the attribute value 503 ‘ID1’ of the attribute name 502 ‘terminal ID’ of the event pattern 510 corresponding to the event pattern ID 512 ‘1’ included in the first per INS event pattern ID list temporary holding field ‘{1}’.

Successively, the event pattern matching tree generation unit 120 stores the relevant event pattern ID 512 ‘1’ in the per INS event pattern ID list temporary holding field (4). Specifically, that is the second per INS event pattern ID list temporary holding field (4)={1} (Step F21).

Next, the event pattern matching tree generation unit 120, for the event pattern 510 corresponding to the event pattern ID 512 included in the second per INS event pattern ID list temporary holding field (4), confirms existence of the attribute name 502 whose matching ratio 135 is lowest next to the attribute name 502 ‘terminal ID’ of the attribute value matching assessment instance 142 ‘INS2’ (Step F22).

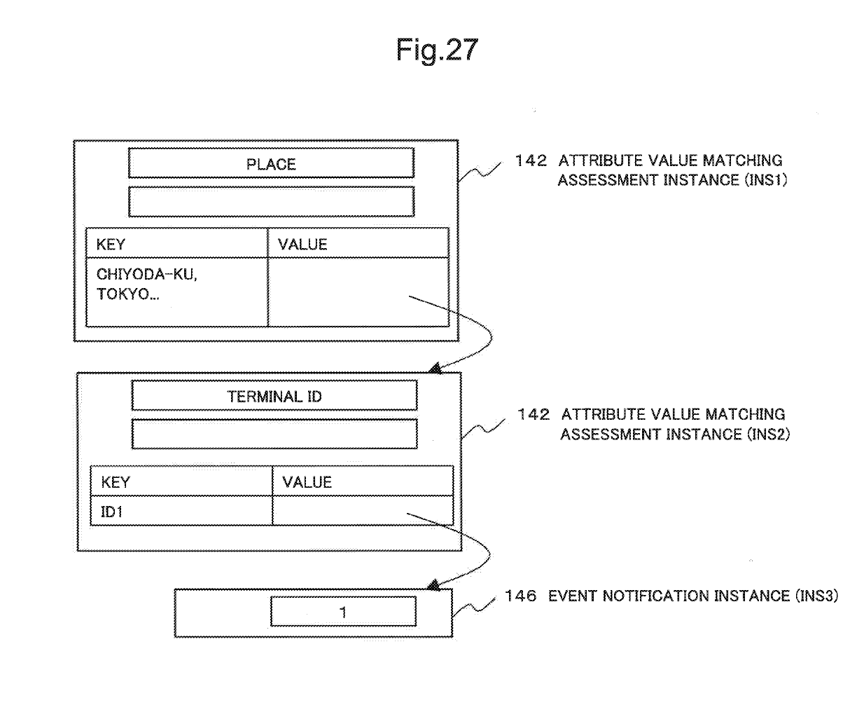

The attribute name 502 whose matching ratio 135 is lowest next to the attribute name 502 ‘terminal ID’ does not exist in the event pattern 510 corresponding to the event pattern ID 512 ‘1’ included in the second per INS event pattern ID list temporary holding field (4) (NO in Step F22). Accordingly, the event pattern matching tree generation unit 120 generates the event notification instance 146 ‘INS3’ which is the second instance 540 shown in FIG. 27 (Step F25).

Next, the event pattern matching tree generation unit 120 records the key ‘ID1’ and its value ‘INS3’ in the hash table 145 of the attribute value matching assessment instance 142 (INS2) (Step F26). At this point, the new event pattern matching tree 141 will be in a state shown in FIG. 27.

Next, the event pattern matching tree generation unit 120 executes instance update (Step F27) on the basis of the second per INS event pattern ID list temporary holding field (4) and the event notification instance 146 ‘INS3’.

In Step F27 (this is made Step F27 (2)), the event pattern matching tree generation unit 120 operates as follows with the second per INS event pattern ID list temporary holding field (4) and the event notification instance 146 ‘INS3’ as the first per INS event pattern ID list temporary holding field and the first instance 540 respectively.

Since the specified first instance 540 is the event notification instance 146 ‘INS3’ (NO in Step F20), the event pattern matching tree generation unit 120 records ‘1’ in the event pattern ID list 147 corresponding to the event notification instance 146. And processing of Step F27 (2) ends. At this point, the new event pattern matching tree 141 will be in a state shown in FIG. 27.

Also, as above, Step F27 (1) ends.

Also, as above, processing of Steps F22-F27 for the per INS event pattern ID list temporary holding field (1) ends.

The event pattern matching tree generation unit 120 further performs similar processing for the per INS event pattern ID list temporary holding fields (2) and (3) (Step F29).

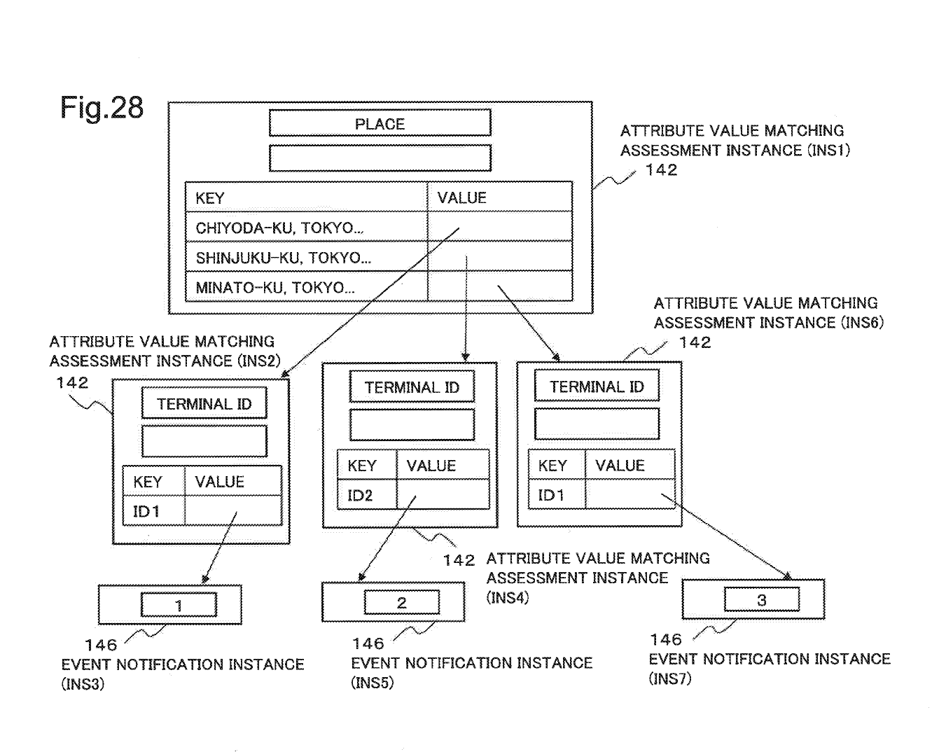

As above, processing of Step F16 ends. At this point, the new event pattern matching tree 141 will be in a state shown in FIG. 28, and the event pattern matching tree generation unit 120 ends reorganization of the event pattern matching tree 141.

The effect of this exemplary embodiment mentioned above is a point that generating an event pattern matching tree optimal for efficiently performing pattern matching assessment becomes possible.

The reason is because the event pattern matching tree generation unit 120 is made to refer the tree dependent matching ratio measurement unit 130, and generate the event pattern matching tree 141 which has arranged on an upper level the instance 540 including the attribute name 502 which has the low matching ratio 135.

As a result, when the event pattern matching assessment system 100 receives the event 500, the event pattern matching assessment unit 110 can detect the event 500 which does not match early in the processing on an upper level of the event pattern matching tree 141, and end matching.

### The Second Exemplary Embodiment

Next, the second exemplary embodiment of the present invention will be described in detail with reference to drawings. Hereinafter, within a range that the description of this exemplary embodiment will not become indefinite, the contents overlapping with the description mentioned above will be omitted.

In the first exemplary embodiment, the event pattern matching assessment unit 110 assesses matching of each attribute, and the tree dependent matching ratio measurement unit 130 measures a matching ratio on the basis of the assessment. In contrast, in the second exemplary embodiment, a matching ratio measurement unit 270 receives an event from an event receiving unit 280 and measures a matching ratio of each attribute.

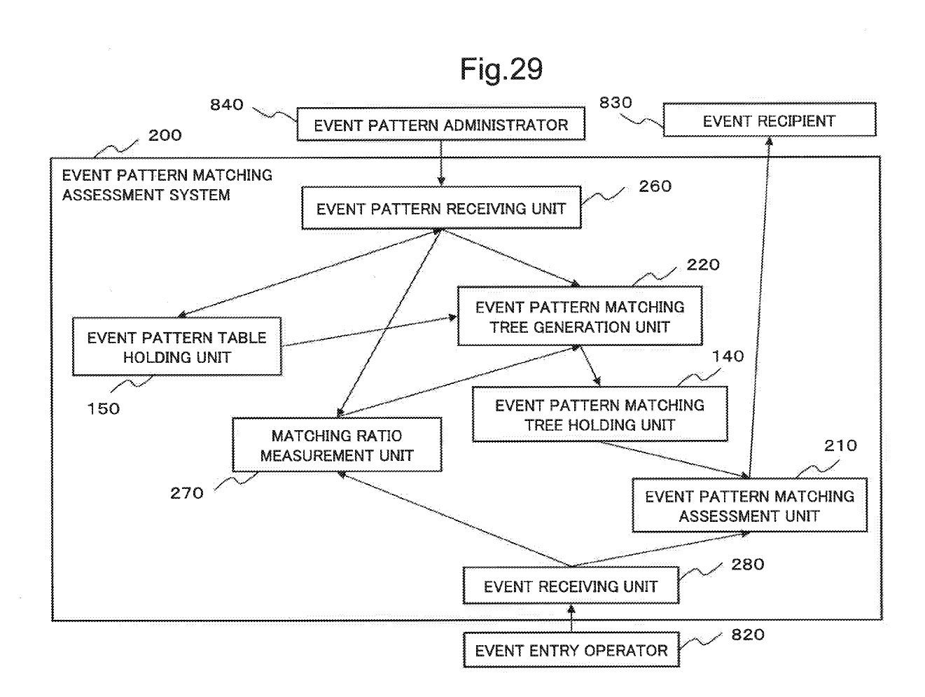

FIG. 29 is a block diagram showing a structure of the second exemplary embodiment.

Referring to FIG. 29, in an event pattern matching assessment system 200 according to the second exemplary embodiment, the event pattern matching assessment unit 110 is replaced by an event pattern matching assessment unit 210 compared with the event pattern matching assessment system 100 of the first exemplary embodiment.

Similarly, the event pattern matching tree generation unit 120 is replaced by an event pattern matching tree generation unit 220. Further and similarly, the event pattern receiving unit 160 is replaced by an event pattern receiving unit 260.

Also, in the event pattern matching assessment system 200, compared with the event pattern matching assessment system 100, the tree dependent matching ratio measurement unit 130 is deleted and the matching ratio measurement unit 270 and the event receiving unit 280 are added.

The event pattern receiving unit 260 receives the event pattern registration request 513 from the event pattern administrator 840. At this time, the event pattern receiving unit 260 records the event pattern 510 and the event pattern ID 512 included in the event pattern registration request 513 in the event pattern table holding unit 150.

Next, the event pattern receiving unit 260 transmits the event pattern 510 and the event pattern ID 512 included in the event pattern registration request 513 to the matching ratio measurement unit 270.

At the same time, the event pattern receiving unit 260 transmits the event pattern registration request 514 to the event pattern matching tree generation unit 220.

Also, the event pattern receiving unit 260 receives the event pattern deletion request 515 from the event pattern administrator 840. At this time, the event pattern receiving unit 260 transmits the event pattern ID 512 included in the event pattern deletion request 515 to the matching ratio measurement unit 270.

Next, the event pattern receiving unit 260 deletes the line in which the event pattern 510 with the event pattern ID 512 included in the event pattern deletion request 515 is recorded from the event pattern table holding unit 150.

Next, the event pattern receiving unit 260 transmits the event pattern deletion request 516 to the event pattern matching tree generation unit 220.

The event receiving unit 280 receives the event 500 from the event entry operator 820. Also, the event receiving unit 280 transmits the received event 500 to the event pattern matching assessment unit 210 and the matching ratio measurement unit 270.

The event pattern matching assessment unit 210 receives the event 500 from the event receiving unit 280.

Also, the event pattern matching assessment unit 210 performs event matching of the received event 500 on the basis of the event pattern matching tree 141 held in the event pattern matching tree holding unit 140.

Moreover, in case the received event 500 matches, the event pattern matching assessment unit 210 transmits the event 500 to the event recipient 830.

The matching ratio measurement unit 270 receives the event 500 from the event receiving unit 280. Also, the matching ratio measurement unit 270 measures matching ratios 275 corresponding to each of all the partial event patterns 511 included in the event pattern 510, in parallel with processing of the event pattern matching assessment unit 210 mentioned above.

Also, the matching ratio measurement unit 270 holds a matching ratio measurement table 271.

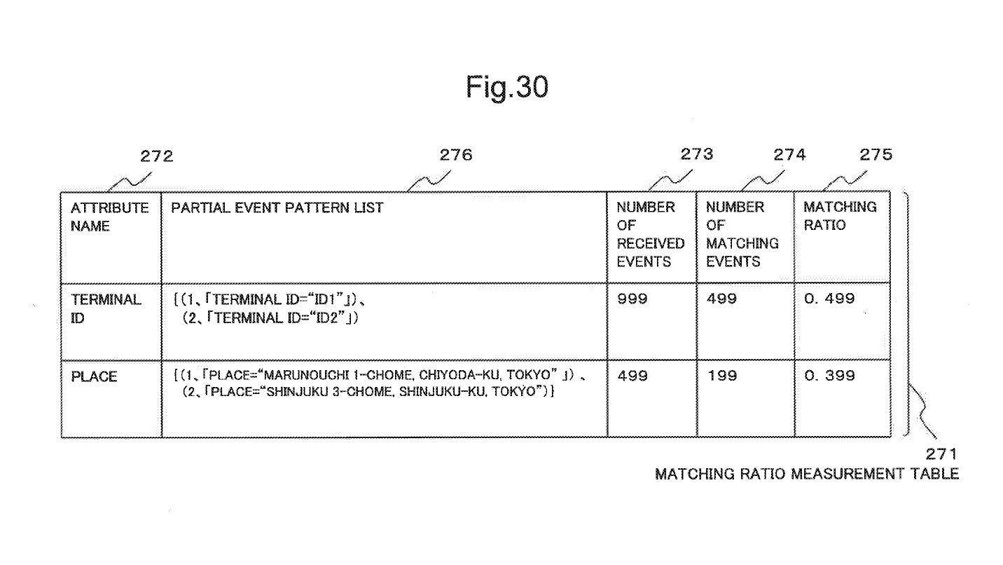

FIG. 30 is a figure showing an example of a structure and contents of the matching ratio measurement table 271. The matching ratio measurement table 271 includes arbitrary number of lines including columns which store: an attribute name 272, a partial event pattern list 276, a number of received events 273, a number of matching events 274 and the matching ratio 275 respectively as shown in FIG. 30.

A list of arbitrary number of pairs is registered in the partial event pattern list 276. Here, the pair is a pair of the partial event pattern 511 including the same attribute name 502 as the attribute name 272 and the event pattern ID 512 of the event pattern 510 including the partial event pattern 511.

For example, in case the event pattern registration request 513 is ‘event pattern registration request 1, Pattern(terminal ID=“ID1”, place=“Marunouchi 1-chome, Chiyoda-ku, Tokyo”)’, the matching ratio measurement unit 270 registers the partial event pattern list 276 (1, ‘terminal ID=“ID1”’) in the line with the attribute name 272 ‘terminal ID’ in the matching ratio measurement table 271. Similarly, the matching ratio measurement unit 270 registers the partial event pattern list 276 (1, place=“Marunouchi 1-chome, Chiyoda-ku, Tokyo”) in the line with the attribute name 272 ‘place’.

A total number of the events 500 received from the event receiving unit 280 is stored in the number of received events 273.

A total number of the events 500 matched with at least one partial event pattern 511 of the partial event pattern list 276 among the received events 500 is stored in the number of matching events 274. A value which divided the number of matching events 274 by the number of received events 273 is stored in the matching ratio 275.

The event pattern matching tree generation unit 220 refers the matching ratio measurement table 271 and generates the event pattern matching tree 141 which has arranged on an upper level the instance 540 including the same attribute name 502 as the attribute name 272 which has the relatively low matching ratio 275.

Next, operation of this exemplary embodiment will be described in detail with reference to drawings.

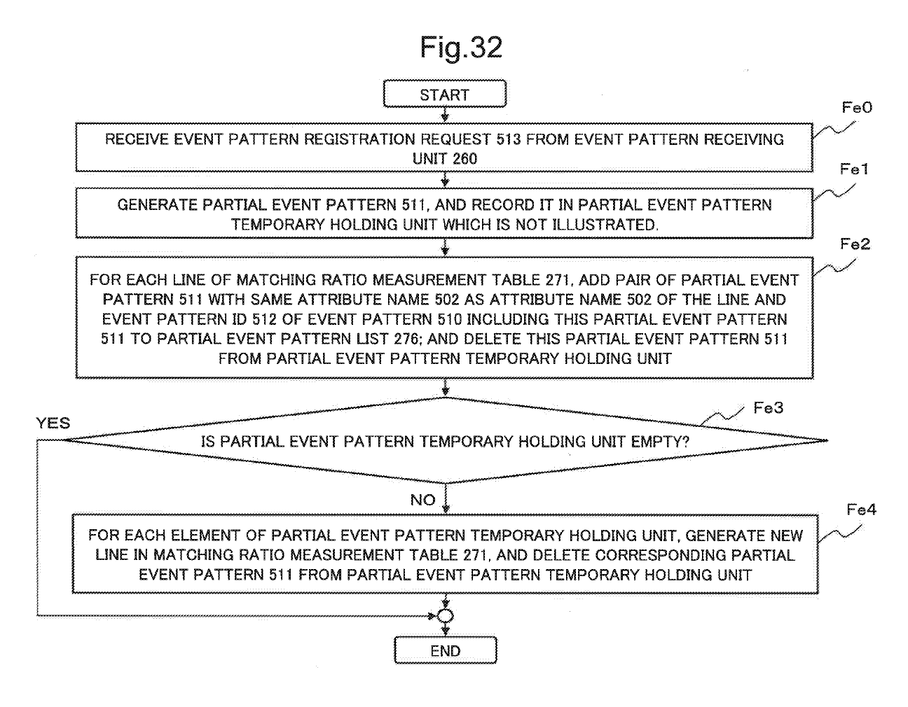

FIG. 32 is a flow chart showing operation of event pattern registration of the matching ratio measurement unit 270.

The matching ratio measurement unit 270 receives the event pattern 510 and the event pattern ID 512 from the event pattern receiving unit 260 (Step Fe0).

At this time, the matching ratio measurement unit 270 generates the partial event pattern 511 on the basis of the received event pattern 510 and the event pattern ID 512, and records it in a partial event pattern temporary holding unit which is not illustrated (Step Fe1).

Next, for each line of the matching ratio measurement table 271, the matching ratio measurement unit 270 adds a pair of the partial event pattern 511 including the attribute name 502 with the same value as the attribute name 272 of the line and the event pattern ID 512 of the event pattern 510 including the partial event pattern 511 to the partial event pattern list 276. Moreover, the matching ratio measurement unit 270 deletes the partial event pattern 511 from the partial event pattern temporary holding unit (Step Fe2).

Next, the matching ratio measurement unit 270 confirms whether the partial event pattern temporary holding unit is empty (Step Fe3). And in case the partial event pattern temporary holding unit is empty (YES in Step Fe3), processing ends. Also, in case the partial event pattern temporary holding unit is not empty (NO in Step Fe3), processing proceeds to Step Fe4.

In Step Fe4, the matching ratio measurement unit 270 generates a new line in the matching ratio measurement table 271 for each element of the partial event pattern temporary holding unit.

Successively, the matching ratio measurement unit 270 records in the attribute name 272 the attribute name 502 of the partial event pattern 511.

Further successively, the matching ratio measurement unit 270 records in the partial event pattern list 276 a pair of the event pattern ID 512 of the event pattern 510 in which the partial event pattern 511 was included and the partial event pattern 511.

Further successively, the matching ratio measurement unit 270 records ‘0’ in the number of received events 273, ‘0’ in the number of matching events 274, and ‘0’ in the matching ratio 275. Further successively, the matching ratio measurement unit 270 deletes the partial event pattern 511 from the partial event pattern temporary holding unit (Step Fe4).

Operation of event pattern registration of the matching ratio measurement unit 270 will be described using a specific example.

As a premise, it is supposed that event patterns ‘Pattern(terminal ID=“ID1”, place=“Marunouchi 1-chome, Chiyoda-ku, Tokyo”)’ and ‘Pattern(terminal ID=“ID2”, place=“Shinjuku 3-chome, Shinjuku-ku, Tokyo”)’ are registered in the event pattern matching assessment system 200. Also and similarly, it is supposed that the matching ratio measurement table 271 is in a state shown in FIG. 30.

Also and similarly, it is supposed that the event pattern matching assessment system 200 received the event pattern registration request 513 ‘event pattern registration request 3 Pattern(terminal ID=“ID1”, place=“Shiba 5-chome, Minato-ku, Tokyo”)’ in the event pattern receiving unit 260.

The event pattern receiving unit 260 transmits the event pattern 510 and the event pattern ID 512 included in the received event pattern registration request 513 to the matching ratio measurement unit 270.

The matching ratio measurement unit 270 receives the event pattern 510 ‘Pattern(terminal ID=“ID1”, place=“Shiba 5-chome, Minato-ku, Tokyo”)’ and the event pattern ID 512 ‘3’ (Step Fe0).

At this time, the matching ratio measurement unit 270 extracts the partial event patterns 511 ‘terminal ID=“ID1”’ and ‘place=“Shiba 5-chome, Minato-ku, Tokyo”’ from the received event pattern 510 and records them in the partial event pattern temporary holding unit (Step Fe1).

Next, for each line of the matching ratio measurement table 271, the matching ratio measurement unit 270 adds a pair of the partial event pattern 511 including the attribute name 502 with the same value as the attribute name 272 of the line and the event pattern ID 512 of the event pattern 510 in which the partial event pattern 511 was included to the partial event pattern list 276 (Step Fe2).

An example of operation of Step Fe2 will be described more specifically. First, since the attribute name 272 is ‘terminal ID’ in the first line of the matching ratio measurement table 271, the matching ratio measurement unit 270 adds a pair of the event pattern ID 512 ‘3’ and the partial event pattern 511 ‘terminal ID=“ID1”’ to the partial event pattern list 276.

Successively, the matching ratio measurement unit 270 deletes ‘terminal ID=“ID1”’ from the partial event pattern temporary holding unit and makes the contents of the partial event pattern temporary holding unit {‘place=“Shiba 5-chome, Minato-ku, Tokyo”’}.

Next, in the second line of the matching ratio measurement table 271, since the attribute name 272 is ‘place’, the matching ratio measurement unit 270 adds a pair of the event pattern ID 512 ‘3’ and the partial event pattern 511 ‘place=“Shiba 5-chome, Minato-ku, Tokyo”’ to the partial event pattern list 276. Successively, the matching ratio measurement unit 270 deletes ‘place=“Shiba 5-chome, Minato-ku, Tokyo”’ from the partial event pattern temporary holding unit, and the partial event pattern temporary holding unit becomes empty.

Next, the matching ratio measurement unit 270 assesses whether the partial event pattern temporary holding unit is empty. And since the partial event pattern temporary holding unit is empty (YES in Step Fe3), processing ends.

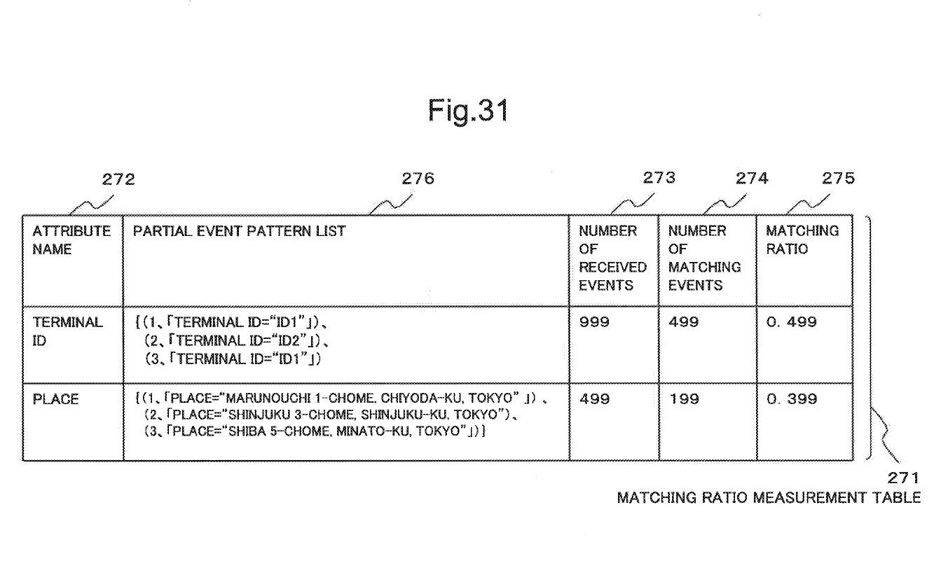

At this time, the matching ratio measurement table 271 is in a state shown in FIG. 31.

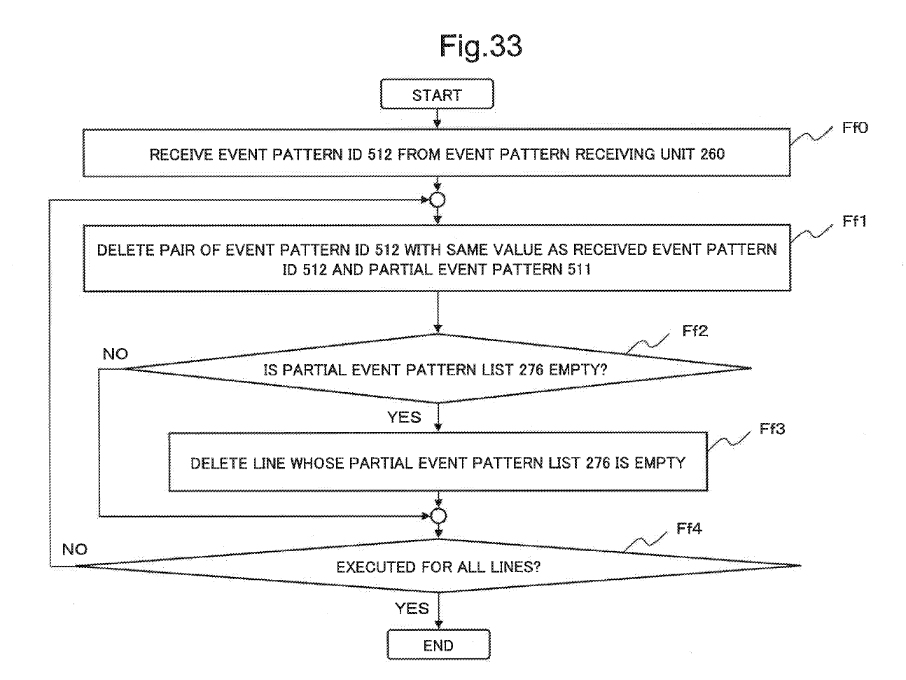

FIG. 33 is a flow chart showing operation of event pattern deletion of the matching ratio measurement unit 270.

The event pattern matching ratio measurement unit 270 receives the event pattern ID 512 from the event pattern receiving unit 260 (Step Ff0).

Next, in the partial event pattern list 276 in one line of the matching ratio measurement table 271, the matching ratio measurement unit 270 deletes the pair of the event pattern ID 512 including the same value as the received event pattern ID 512 and the partial event pattern 511 (Step Ff1).

Next, the matching ratio measurement unit 270 confirms whether the partial event pattern list 276 in the line where the pair of the event pattern ID 512 and the partial event pattern 511 is deleted is empty (Step Ff2).

And in case of empty (YES in Step Ff2), the matching ratio measurement unit 270 delete the line whose partial event pattern list 276 is empty (Step Ff3). Also, in case not empty (NO in Step Ff2), processing proceeds to Step Ff4.

Next, the matching ratio measurement unit 270 confirms whether processing from Step Fe1 to Step Fe3 was executed for all lines of the matching ratio measurement table 271 (Step Ff4).

And in case executed for all lines (YES in Step Ff4), processing ends. Also, in case there exists a line not executed (NO in Step Ff4), processing returns to Step Ff1.

Operation of event pattern deletion of the matching ratio measurement unit 270 will be described using a specific example.

As a premise, it is supposed that the matching ratio measurement table 271 is in a state shown in FIG. 31.

Also and similarly, it is supposed that the event pattern matching assessment system 200 received the event pattern deletion request 515 ‘event pattern deletion request 3’ in the event pattern receiving unit 260.

The event pattern receiving unit 260 transmits the event pattern ID 512 ‘3’ included in the received event pattern deletion request 515 to the matching ratio measurement unit 270.

The matching ratio measurement unit 270 deletes the pair of the event pattern ID 512 with the same value as the received event pattern ID 512 and the partial event pattern 511 from the partial event pattern list 276 of each line of the matching ratio measurement table 271.

Specifically, deletes ‘(3, ‘terminal ID=“ID1”’)’ from the partial event pattern list 276 of which the attribute name 272 is ‘place’ in the matching ratio measurement tables 271 and ‘(3, ‘place=“Shiba 5-chome, Minato-ku, Tokyo”’)’ from the first line of the partial event pattern list 276.

As above, processing of event pattern deletion of the matching ratio measurement unit 270 ends.

At this time, the matching ratio measurement table 271 is in a state of FIG. 30.

Next, operation of event matching of the event 500 in this exemplary embodiment will be described.

When the event 500 is inputted from the event entry operator 820 to the event receiving unit 280, the event receiving unit 280 transmits the event 500 to the event pattern matching assessment unit 210 and the matching ratio measurement unit 270.

The event pattern matching assessment unit 210 performs event matching, gives the event pattern ID 512 of the matched event pattern 510 to the event 500 and notifies it to the event recipient 830. Also, the matching ratio measurement unit 270 updates the matching ratio corresponding to each of the attribute names 502.

Among operations of event matching of the event 500, operation of the event pattern matching assessment unit 210 in this exemplary embodiment when the event 500 is inputted is same as the operation of the event pattern matching assessment unit 110 shown by the flow chart of FIG. 14 described in the first exemplary embodiment.

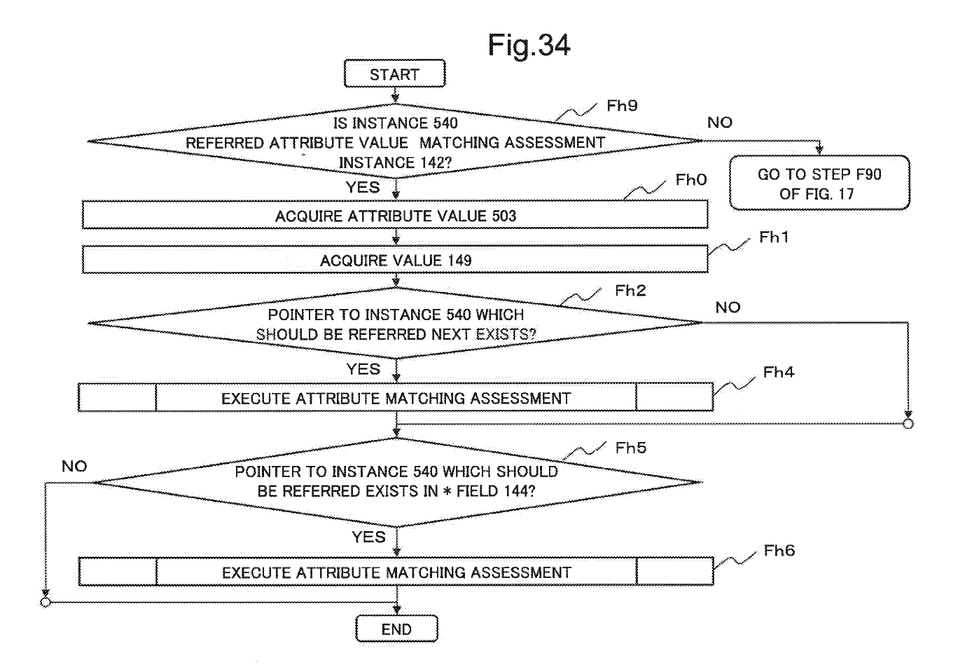

FIG. 34 is a flow chart showing operation of attribute matching assessment, among operations of event matching of the event 500, in case the instance 540 referred is the attribute value matching assessment instance 142.

Operation of attribute matching assessment of the event pattern matching assessment unit 210 shown in FIG. 34 is different, compared with operation of the event pattern matching assessment unit 110 shown in FIG. 15 and FIG. 16, in that operation of the event pattern matching assessment unit 210 to transmit the attribute name 502 and the matching result to the tree dependent matching ratio measurement unit 130 does not exist.

Accordingly, in FIG. 15 and FIG. 34, Step F79 and Step Fh9, Step F80 and Step Fh0, Step F81 and Step Fh1, Step F84 and Step Fh4, Step F85 and Step Fh5, Step F86 and Step Fh6, are the same operation respectively.

Also, they are different at a point where: in case of NO in Step F82 of FIG. 15, processing proceeds to Step F87 of FIG. 16, and in case of NO in Step Fh2 of FIG. 34, processing proceeds to Step Fh5. Also, they are different at a point where: in case of YES in Step F82 of FIG. 15, processing proceeds to Step F83 of FIG. 16, and in case of YES in Step Fh2 of FIG. 34, processing proceeds to Step Fh4.

Also, operations corresponding to operations of Step F83 of FIG. 15, Step F87, Step F88 and Step F89 of FIG. 16 do not exist in FIG. 34.

Next, update processing of a matching ratio of the matching ratio measurement unit 270 will be described.

When the event 500 is received, the matching ratio measurement unit 270 performs event matching of the event 500 using the partial event pattern list 276 in each line of the matching ratio measurement table 271. Successively, the matching ratio measurement unit 270 updates the matching ratio measurement table 271 on the basis of the result of the event matching.

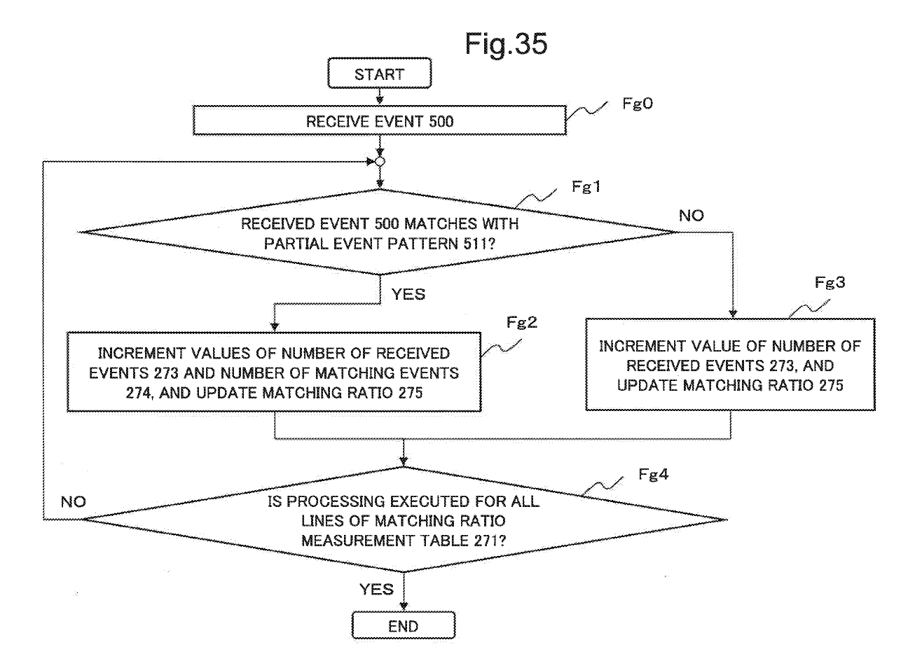

FIG. 35 is a flow chart showing, among operations of event matching of the event 500, operation which updates a matching ratio corresponding to each of the attribute names 502.

The matching ratio measurement unit 270 receives the event 500 from the event receiving unit 280 (Step Fg0).

Next, the matching ratio measurement unit 270 executes processing of Step Fg1, Step Fg2 and Step Fg3 shown below for all lines of the matching ratio measurement table 271.

First, the matching ratio measurement unit 270 assesses whether the received event 500 matches with at least one partial event pattern 511 in the partial event pattern list 276 of one line of the matching ratio measurement table 271 (Step Fg1).

And in case the received event 500 matches (YES in Step Fg1), the matching ratio measurement unit 270 increments values of the number of received events 273 and the number of matching events 274 of the line and updates the matching ratio (Step Fg2).

Also, in case the received event 500 does not mach with any partial event patterns 511 in the partial event pattern list 276 (NO in Step Fg1), the matching ratio measurement unit 270 increments the value of the number of received events 273 of the line and updates the matching ratio 275 (Step Fg3).

Next, the matching ratio measurement unit 270 assesses whether processing is executed for all lines of the matching ratio measurement table 271 (Step Fg4).

Next, operation of event matching of the event 500 will be described using a specific example.

As a premise, it is supposed that three event patterns 510 ‘Pattern(terminal ID=“ID1”, place=“Marunouchi 1-chome, Chiyoda-ku, Tokyo”)’, ‘Pattern(terminal ID=“ID2”, place=“Shinjuku 3-chome, Shinjuku-ku, Tokyo”)’ and ‘Pattern(terminal ID=“ID1”, place=“Shiba 5-chome, Minato-ku, Tokyo”)’ are registered in the event pattern matching assessment system 200.

Also and similarly, it is supposed that the event pattern matching tree 141 is in a state shown in FIG. 22 and the tree matching ratio measurement table 271 is in a state shown in FIG. 31.

Also and similarly, it is supposed that the event pattern matching assessment system 200 received the event 500 ‘EVENT(terminal ID=“ID1”, place=“Shiba 5-chome, Minato-ku, Tokyo”, time=“10:10:25”)’ shown in FIG. 2 in the event receiving unit 280.

The event receiving unit 280 transmits the received event 500 to the event pattern matching assessment unit 210 and the matching ratio measurement unit 270.

The event pattern matching assessment unit 210 performs matching assessment of the received event 500. And the event pattern matching assessment unit 210 notifies the event recipient 830 of the event 500 and the event pattern ID 512 held in INS6 of FIG. 22.

Since operation of the event pattern matching assessment unit 210 is same as the operation of the event pattern matching assessment unit 110 shown in the first exemplary embodiment except that the attribute name 502 and the matching result are not sent to the tree dependent matching ratio measurement unit 130, the detailed description will be omitted.

Operation of the matching ratio measurement unit 270 will be described. First, in the first line of the matching ratio measurement table 271, the event 500 matches with ‘terminal ID=“ID1”’ of the partial event pattern list 276 (YES in Step Fg1). Accordingly, the matching ratio measurement unit 270 updates the number of received events 273 to ‘1000’, the number of matching events 274 to ‘500’, and the matching ratio 275 to (500/1000=) ‘0.500’.

Next, in the second line of the matching ratio measurement table 271, the event 500 matches with ‘place=“Shiba 5-chome, Minato-ku, Tokyo”’ of the partial event pattern list 276 (YES in Step Fg1). Accordingly, the matching ratio measurement unit 270 updates the number of received events 273 to ‘500’, the number of matching events 274 to ‘200’, and the matching ratio 275 to ‘0.400 (200/500=0.400)’.

As above, description of the specific example of operation of event matching of the event 500 ends.

In this exemplary embodiment mentioned above, the matching ratio measurement unit 270 is made to perform event pattern matching assessment for all the events 500 received from the event receiving unit 280 and for all lines of the matching ratio measurement table 271.

However, the matching ratio measurement unit 270 may also be made to perform event pattern matching assessment, for example, for the event 500 selected at random or according to a standard set in advance by the matching ratio measurement unit 270 or the event receiving unit 280.

Or the matching ratio measurement unit 270 may also be made to perform event pattern matching assessment for the partial event pattern 511 in a line selected at random or according to a standard set in advance among all lines of the matching ratio measurement table 271.

The first effect of this exemplary embodiment mentioned above is a point that, in addition to the effect of the first exemplary embodiment, the event pattern matching tree 141 whose optimization is more correct can be obtained.

The reason is because the matching ratio measurement unit 270 is made to measure the matching ratio 275 corresponding to each of the attribute names 502 independent of the event pattern matching tree 141.

Hereinafter, this effect will be described specifically.

According to the first exemplary embodiment, the matching ratio of each attribute name 502 is measured using each of the attribute value matching assessment instances 142 of the event pattern matching tree 141. For this reason, in case there is dependence relationship in the attributes 501 corresponding to the attribute names 502 which the parent node 191 and the child node 191 of the event pattern matching tree 141 hold respectively, there is a case when the matching ratio of the attribute 501 corresponding to the child node 191 may not be measured correctly.

That there exists dependence relationship between the attribute 501 of the attribute name 502 ‘age’ and the attribute 501 of the attribute name 502 ‘hobby’ means that there are often cases where the hobby of a person of the same generation is same and so on, for example, the hobby of a person whose age is in the teens is often game, the hobby of a person whose age is in the twenties is often travel and so on.

In such a case, in case the event pattern 510 includes the partial event pattern 511 of the attribute names 502 ‘age’ and ‘hobby’, the event 500 which matches with the partial event pattern 511 of which the attribute name 502 is ‘age’ also matches with the partial event pattern 511 of which the attribute name 502 is ‘hobby’.

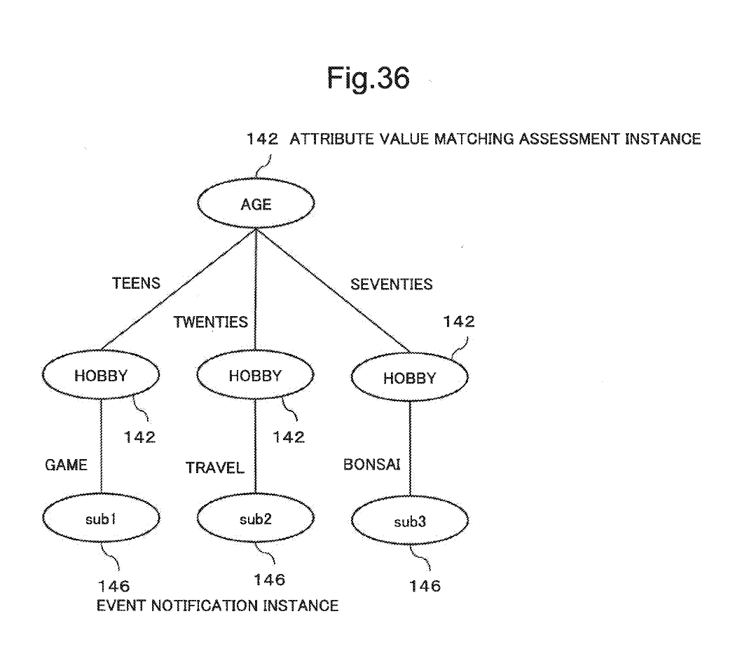

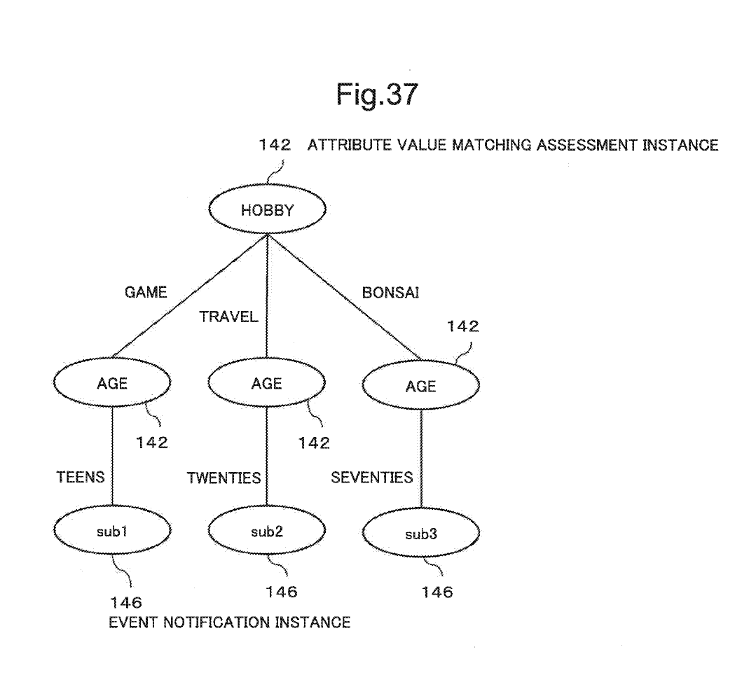

This will be described by a specific example with reference to FIG. 36 and FIG. 37. FIG. 36 and FIG. 37 are figures, for describing the effect of the this exemplary embodiment, and for showing examples of the event pattern matching tree 141 and the matching ratio 135 corresponding to each of the attribute names 502 in the first exemplary embodiment.

As a premise, it is supposed that there exists dependence relationship between the age and the hobby, and in the event pattern matching assessment system 100 and the event pattern matching assessment system 200, ‘Pattern(age=“teens”, hobby=“game”)’, ‘Pattern(age=“twenties”, hobby=“travel”)’ and ‘Pattern(age=“seventies”, hobby=“bonsai”)’ are registered as the event patterns 510.

And it is supposed that the event pattern matching tree holding unit 140 holds the event pattern matching trees 141 shown in FIG. 36 or FIG. 37 generated from these event patterns 510.

Similarly, as a premise, it is supposed that four events 500 ‘EVENT1(age=teens, hobby=game)’, ‘EVENT2(age=twenties, hobby=travel)’, ‘EVENT3(age=thirties, hobby=shopping)’ and ‘EVENT4(age=forties, hobby=reading)’ are transmitted to the event pattern matching assessment system 100 or the event pattern matching assessment system 200 from the event entry operator 820.

In the event pattern matching tree 141 shown in FIG. 36, the attribute value matching assessment instance 142 which is the root node 192 is with the attribute name 502 ‘age’ and the next attribute value matching assessment instance 142 is with the attribute name 502 ‘hobby’. In case the matching ratio 135 of each of the attribute names 502 is measured using the event pattern matching tree 141 shown in FIG. 36, the event pattern matching assessment system 100 measures the matching ratio 135 of the attribute name 502 ‘age’ as 2/4=0.5 and the matching ratio 135 of the attribute name 502 ‘hobby’ as 2/2=1.

On the other hand, in the event pattern matching tree 141 shown in FIG. 37, the attribute value matching assessment instance 142 which is the root node 192 is with the attribute name 502 ‘hobby’ and the next attribute value matching assessment instance 142 is with the attribute name 502 ‘age’.

In case the matching ratio 135 of each of the attribute names 502 is measured using the event pattern matching tree 141 shown in FIG. 37, the event pattern matching assessment system 100 measures the matching ratio 135 of the attribute name 502 ‘age’ as 2/2=1 and the matching ratio 135 of the attribute name 502 ‘hobby’ as 2/4=0.5. That is, the matching ratio 135 of each of the attribute names 502 which the event pattern matching assessment system 100 measures changes depending on the structure of the event pattern matching tree 141.

In case the matching ratio 275 of each of the attribute names 502 is measured in the event pattern matching assessment system 200, the matching ratio 275 of each of the attribute names 502 is measured in the matching ratio measurement unit 270 independent of the event pattern matching tree 141.

For this reason, whichever case shown in FIG. 36 and FIG. 37 the event pattern matching tree 141 is, the matching ratio 275 of the attribute name 502 ‘age’ will be 2/4=0.5, and the matching ratio 275 of the attribute name 502 ‘hobby’ will be 2/4=0.5.

That is, even if dependence relationship exists between two attributes 501, the event pattern matching assessment system 200 can measure the correct matching ratio of the attribute name 502 corresponding to each of the attributes 501.

Therefore, even in case the attributes 501 with dependence relationship exist, the event pattern matching assessment system 200 can generate the event pattern matching tree 141 on the basis of the correct matching ratio 275. For this reason, the attribute name 502 corresponding to each of the attributes 501 appears from the root node 192 to the leaf node 193 of the event pattern matching tree 141 in ascending order of the matching ratio.

The event pattern matching assessment system 200 performs event pattern matching assessment on the basis of the event pattern matching tree 141. For this reason, the event 500 which does not match with the event pattern 510 is discarded at an upper level of the event pattern matching tree 141, and event processing becomes at high speed.

The second effect of this exemplary embodiment mentioned above is a point that a load of the matching ratio measurement unit 270 can be reduced.

The reason is because the matching ratio measurement unit 270 is made to perform event pattern matching assessment by selecting the event 500 received from the event receiving unit 280, and by selecting the line in the matching ratio measurement table 271.

### The Third Exemplary Embodiment

Next, the third exemplary embodiment of the present invention will be described in detail with reference to drawings. Hereinafter, within a range that the description of this exemplary embodiment will not become indefinite, the contents overlapping with the description mentioned above will be omitted.

An event pattern matching assessment system 600 of this exemplary embodiment measures the matching ratio 135 of each of the attribute names 502 in the tree dependent matching ratio measurement unit 130 by the same method as the event pattern matching assessment system 100 of the first exemplary embodiment. At the same time, the event pattern matching assessment system 600 of this exemplary embodiment measures the matching ratio 275 of the specific attribute name 502 in a matching ratio measurement unit 670 by the same method as the event pattern matching assessment system 200 of the second exemplary embodiment.

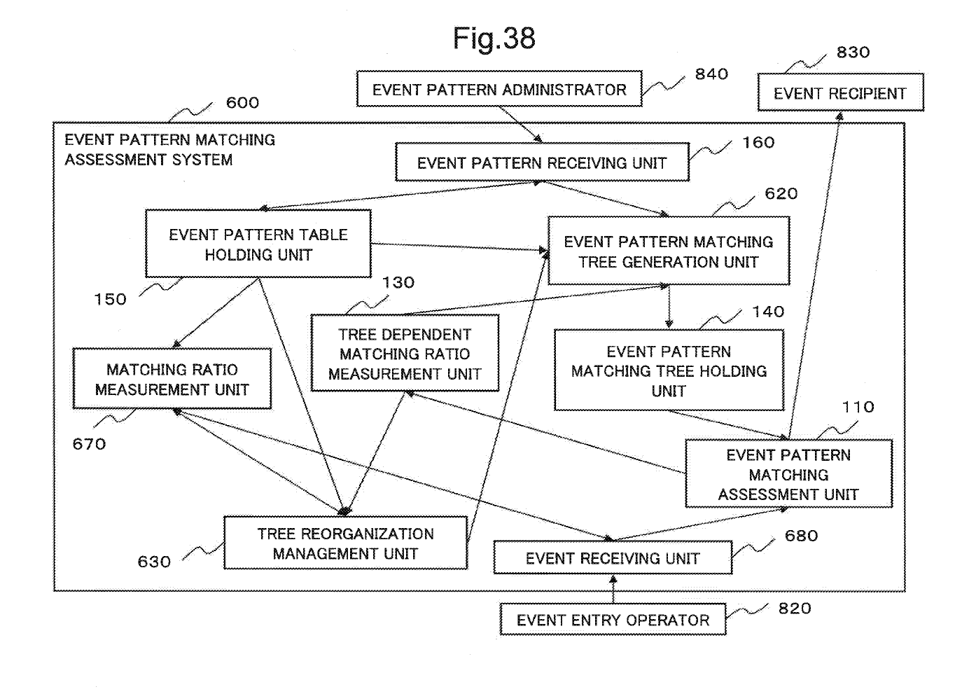

FIG. 38 is a block diagram showing a structure of the third exemplary embodiment.

Referring to FIG. 38, compared with the event pattern matching assessment system 100 of the first exemplary embodiment, the event pattern matching tree generation unit 120 is replaced by an event pattern matching tree generation unit 620 in the event pattern matching assessment system 600.

Also, compared with the event pattern matching assessment system 100, the matching ratio measurement unit 670, a tree reorganization management unit 630 and an event receiving unit 680 are added to the event pattern matching assessment system 600.

The event receiving unit 680 receives the event 500 from the event entry operator 820 and transmits the received event 500, in an initial state, to the event pattern matching assessment unit 110.

Also, in case an event transmission starting request is received from the matching ratio measurement unit 670, the event receiving unit 680 transmits the event 500 received after that (after becoming a non-initial state) to the event pattern matching assessment unit 110 and the matching ratio measurement unit 670.

In case an event transmission end request is received from the matching ratio measurement unit 670, the event receiving unit 680 transmits the event 500 received after that to the event pattern matching assessment unit 110 and does not transmit it to the matching ratio measurement unit 670.

The matching ratio measurement unit 670 measures the matching ratio 275 of the attribute name 502 requested from the tree reorganization management unit 630. The matching ratio measurement unit 670 holds the matching ratio measurement table 271 as shown in FIG. 30.

The matching ratio measurement unit 670 receives a matching ratio measurement starting request including no smaller than one of the attribute names 502 as an argument from the tree reorganization management unit 630.

Next, the matching ratio measurement unit 670 acquires all the partial event patterns 511 including the attribute name 502 included in the matching ratio measurement starting request as the argument from the event pattern table holding unit 150 and stores them in the matching ratio measurement table 271. Specifically, the matching ratio measurement unit 670 generates a line in the matching ratio measurement table 271 for each of the received attribute names 502.

Successively, the matching ratio measurement unit 670 stores the received attribute name 502 in the attribute name 132 of each line. At the same time, the matching ratio measurement unit 670 stores a list of all the partial event patterns 511 in which the value of the received attribute name 502 is included in the partial event pattern list 276.

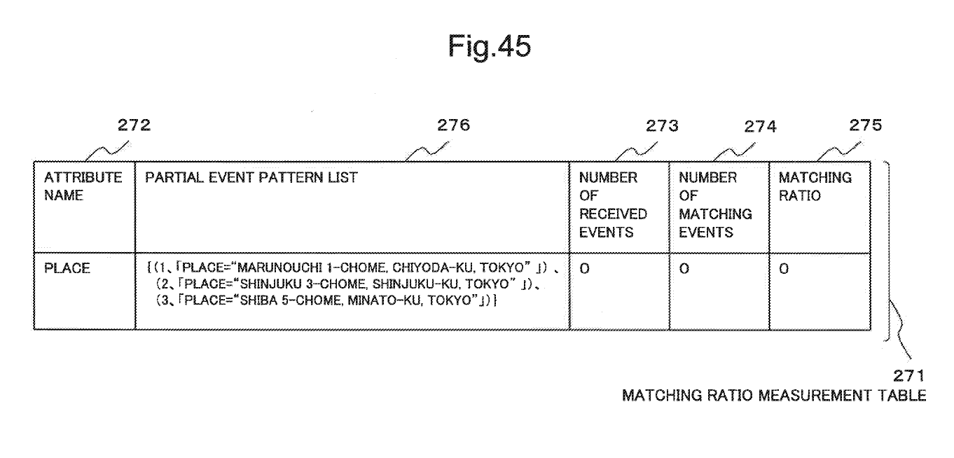

Successively, the matching ratio measurement unit 670 stores ‘0’ in the number of received events 273, ‘0’ in the number of matching events 274, and ‘0’ in the matching ratio 275. For example, in case the event pattern table holding unit 150 is as shown in FIG. 13, when the matching ratio measurement starting request of the attribute name 502 ‘place’ is received from the tree reorganization management unit 630, the matching ratio measurement unit 670 stores a line shown in FIG. 45 in the matching ratio measurement table 271.

Next, in order to receive the event 500 from the event receiving unit 680, the matching ratio measurement unit 670 transmits the event transmission starting request to the event receiving unit 680. As a result, the event 500 becomes to be transmitted from the event receiving unit 680, and the matching ratio measurement unit 670 measures the matching ratio 275 on the basis of the received event 500.

In case a matching ratio measurement end request is received from the tree reorganization management unit 630, the matching ratio measurement unit 670 returns a list of the measured matching ratio 275 to the tree reorganization management unit 630.

Next, in order to end receiving of the event 500 from the event receiving unit 680, the matching ratio measurement unit 670 transmits the event transmission end request to the event receiving unit 680. Finally, the matching ratio measurement unit 670 deletes each line of the matching ratio measurement table 271 and ends matching ratio measurement.

The tree reorganization management unit 630 decides whether to reorganize the event pattern matching tree 141 on the basis of the matching ratio 135 measured in the tree dependent matching ratio measurement unit 130 and the matching ratio 275 measured in the matching ratio measurement unit 670.

Next, in case it is decided to reorganize the event pattern matching tree 141, the tree reorganization management unit 630 transmits a tree reorganization request to the event pattern matching tree generation unit 620.

The tree reorganization management unit 630 acquires all the attribute names 132 except for a root attribute name and their matching ratios 135 from the tree dependent matching ratio measurement unit 130 at fixed time intervals. Here, the root attribute name indicates the attribute name 502 stored in the attribute name field 143 of the attribute value matching assessment instance 142 which is the root node 192 of the event pattern matching tree 141.

In case there exist no smaller than one of the attribute names 132 of which the matching ratio 135 is no more than a fixed value in the acquired attribute names 132 and the matching ratios 135, the tree reorganization management unit 630 transmits the matching ratio measurement starting request to the matching ratio measurement unit 670.

Next, the matching ratio measurement unit 670 measures the matching ratio 275 of the attribute name 132. By transmitting the matching ratio measurement end request to the matching ratio measurement unit 670, the tree reorganization management unit 630 acquires the matching ratio 275 which the matching ratio measurement unit 670 measured.

In case there exist no smaller than one of the attribute names 132 of which the acquired matching ratio 275 is no more than a fixed value, the tree reorganization management unit 630 transmits the tree reorganization request which requests reorganization of the event pattern matching tree 141 to the event pattern matching tree generation unit 620.

The event pattern matching tree generation unit 620 generates the event pattern matching tree 141. When the tree reorganization request is received from the tree reorganization management unit 630, the event pattern matching tree generation unit 620 generates a tree which made the instance 540 which holds the attribute name 502 of which the corresponding matching ratio 275 is low at an upper level of the tree.

And the event pattern matching tree generation unit 620 records the tree generated newly in the event pattern matching tree holding unit 140. Further, since processing when the event pattern registration request 514 and the event pattern deletion request 516 are received is same as that of the first exemplary embodiment, the description will be omitted.

Next, operation of this exemplary embodiment will be described in detail with reference to drawings.

Since processing of event matching of the event 500 is same as that of the first exemplary embodiment, the description will be omitted.

Next, a reorganization procedure of the event pattern matching tree 141 will be described.

The tree reorganization management unit 630 decides whether to reorganize the event pattern matching tree 141 on the basis of the matching ratio measured by the tree dependent matching ratio measurement unit 130 and the matching ratio measurement unit 670.

Also, the tree reorganization management unit 630 transmits the tree reorganization request to the event pattern matching tree generation unit 620.

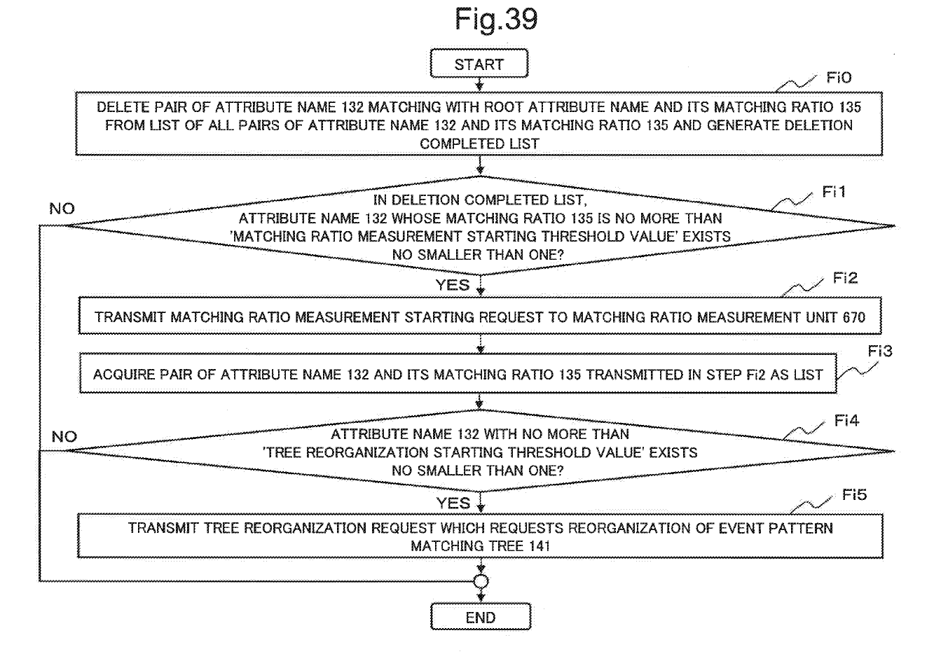

FIG. 39 is a flow chart showing operation by which the tree reorganization management unit 630 requests reorganization of the event pattern matching tree 141.

Further, the tree reorganization management unit 630 acquires in advance the attribute name 502 stored in the attribute name field 143 of the attribute value matching assessment instance 142 which is the root node 192 of the event pattern matching tree 141 from the event pattern matching tree holding unit 140.

And the tree reorganization management unit 630 registers the attribute name 502 in the root attribute name. In the tree reorganization management unit 630, the root attribute name is registered and held. Also, in the tree reorganization management unit 630, a matching ratio measurement starting threshold value used by the matching ratio measurement unit 670 to judge whether to measure the matching ratio 275 is registered in advance and held.

Also, in the tree reorganization management unit 630, a tree reorganization starting threshold value used to judge whether to perform reorganization of the event pattern matching tree 141 is registered in advance and held.

The tree reorganization management unit 630 acquires all pairs of the attribute name 132 and its matching ratio 135 as a list from the tree dependent matching ratio measurement unit 130 at fixed time intervals. Successively, the tree reorganization management unit 630 deletes the pair with the attribute name 132 which agrees with the root attribute name and its matching ratio 135 from the acquired list and generates a deletion completed list (Step Fi0).

Next, the tree reorganization management unit 630 assesses whether no smaller than one of the attribute names 132 of which the corresponding matching ratio 135 is no more than the matching ratio measurement starting threshold value exist in the deletion completed list (Step Fi1).

And in case no smaller than one of the relevant attribute names 132 exist (YES in Step Fi1), in order to measure the matching ratio 275 of the relevant attribute names 132, the tree reorganization management unit 630 transmits the matching ratio measurement starting request to the matching ratio measurement unit 670 (Step Fi2). Specifically, the relevant attribute names 132 are made a list and transmitted to the matching ratio measurement unit 670.

Also, in case the relevant attribute name 132 does not exist at all (NO in Step Fi1), processing ends.

Next, the tree reorganization management unit 630 transmits the matching ratio measurement end request to the matching ratio measurement unit 670 after a fixed time set in advance and acquires a pair of the attribute name 132 transmitted in Step Fit and its matching ratio 275 as a list (Step Fi3).

Next, the tree reorganization management unit 630 assesses whether no smaller than one of the attribute names 132 with no more than the tree reorganization starting threshold value exist in the received matching ratio 275.

And in case the relevant attribute name 132 exists (YES in Step Fi4), the tree reorganization management unit 630 transmits the tree reorganization request which requests reorganization of the event pattern matching tree 141 to the event pattern matching tree generation unit 620 (Step Fi5).

Also, in case the relevant attribute name 132 does not exist (NO in Step Fi4), processing ends.

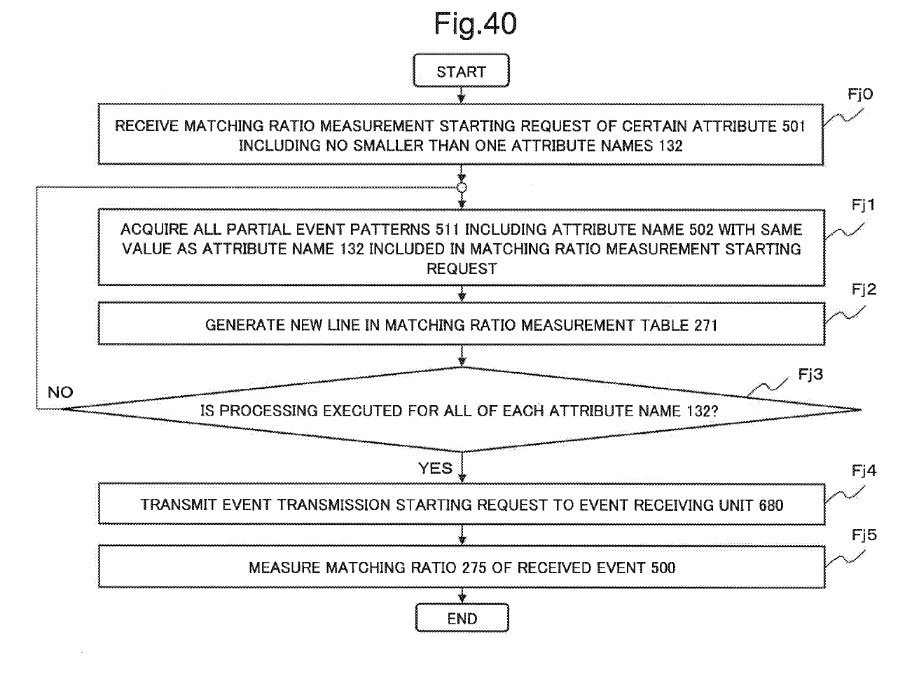

FIG. 40 is a flow chart showing operation of the matching ratio measurement unit 670 in case the matching ratio measurement unit 670 receives the matching ratio measurement starting request from the tree reorganization management unit 630.

The matching ratio measurement unit 670 receives the matching ratio measurement starting request including no smaller than one of the attribute names 132 from the tree reorganization management unit 630 (Step Fj0).

Next, the matching ratio measurement unit 670 performs processing of Step Fj1 and Step Fj2 for each of the attribute names 132 which is included in the received matching ratio measurement starting request.

First, the matching ratio measurement unit 670 acquires all the partial event patterns 511 including the attribute name 502 with the same value as the attribute name 132 from the event pattern table holding unit 150 (Step Fj1).

Next, the matching ratio measurement unit 670 generates a new line in the matching ratio measurement table 271 and stores the attribute name 502 in the attribute name 272 and the list of the acquired partial event patterns 511 in the partial event pattern list 276. Successively, the matching ratio measurement unit 670 stores ‘0’ in the number of received events 273, ‘0’ in the number of matching events 274, and ‘0’ in the matching ratio 275 (Step Fj2).

Next, the matching ratio measurement unit 670 confirms whether processing is executed for all of each of the attribute names 132 included in the received matching ratio measurement starting request (Step Fj3).

And in case processing is executed for all of them (YES in Step Fj3), processing proceeds to Step Fj4.

Also, in case the attribute name 132 for which processing is not executed exists (NO in Step Fj3), processing returns to Step Fj1.

Next, in order to receive the event 500 from the event receiving unit 680, the matching ratio measurement unit 670 transmits the event transmission starting request to the event receiving unit 680 (Step Fj4).

As a result, the event 500 becomes to be transmitted from the event receiving unit 680, and the matching ratio measurement unit 670 measures the matching ratio 275 of the received event 500 (Step Fj5).

Since measurement processing of the matching ratio 275 is same as that of the second exemplary embodiment, the description will be omitted.

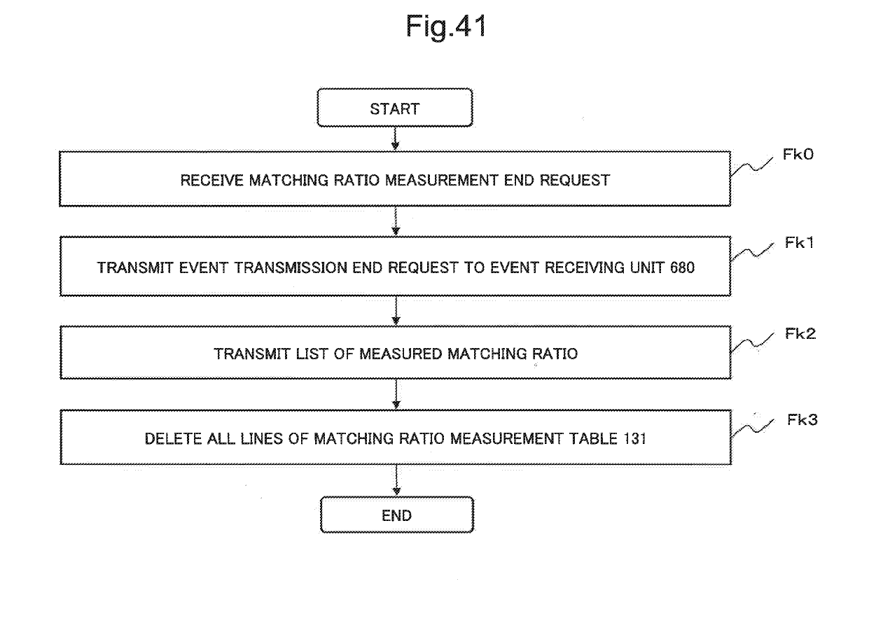

FIG. 41 is a flow chart showing operation in case the matching ratio measurement unit 670 receives the matching ratio measurement end request from the tree reorganization management unit 630.

The matching ratio measurement unit 670 receives the matching ratio measurement end request from the tree reorganization management unit 630 (Step Fk0).

Next, in order to end receiving of events from the event receiving unit 680, the matching ratio measurement unit 670 transmits the event transmission end request to the event receiving unit 680 (Step Fk1).

Next, the matching ratio measurement unit 670 transmits a list of the measured matching ratio to the tree reorganization management unit 630 (Step Fk2).

Finally, the matching ratio measurement unit 670 deletes all lines of the matching ratio measurement table 271 (Step Fk3).

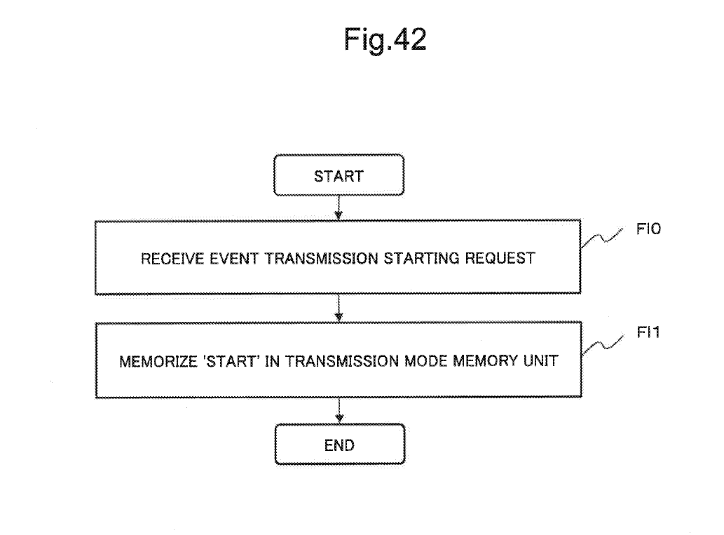

FIG. 42 is a flow chart showing operation in case the event receiving unit 680 receives the event transmission starting request from the matching ratio measurement unit 670.

The event receiving unit 680 receives the event transmission starting request from the matching ratio measurement unit 670 (Step F10).

Next, the event receiving unit 680 memorizes ‘start’ in a transmission mode memory unit which is not illustrated to show that the event transmission starting request is received (Step F11).

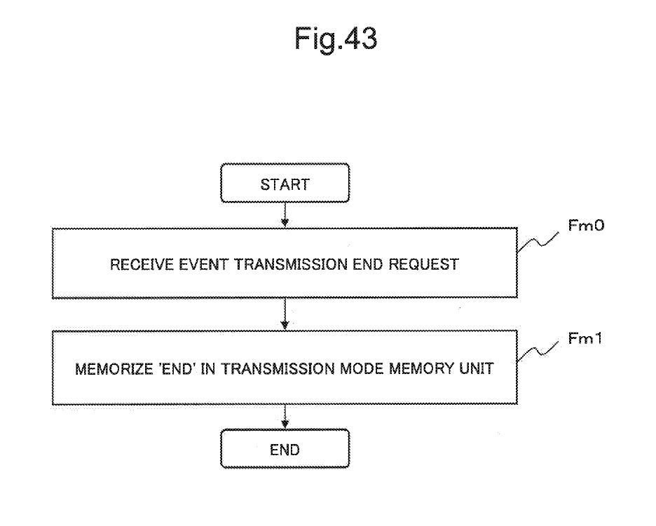

FIG. 43 is a flow chart showing operation in case the event receiving unit 680 receives the event transmission end request from the matching ratio measurement unit 670.

The event receiving unit 680 receives the event transmission end request from the matching ratio measurement unit 670 (Step Fm0).

Next, the event receiving unit 680 memorizes ‘end’ in the transmission mode memory unit which is not illustrated to show that the event transmission end request is received (Step Fm1).

Further, an initial state of the transmission mode memory unit is a state that ‘end’ is memorized.

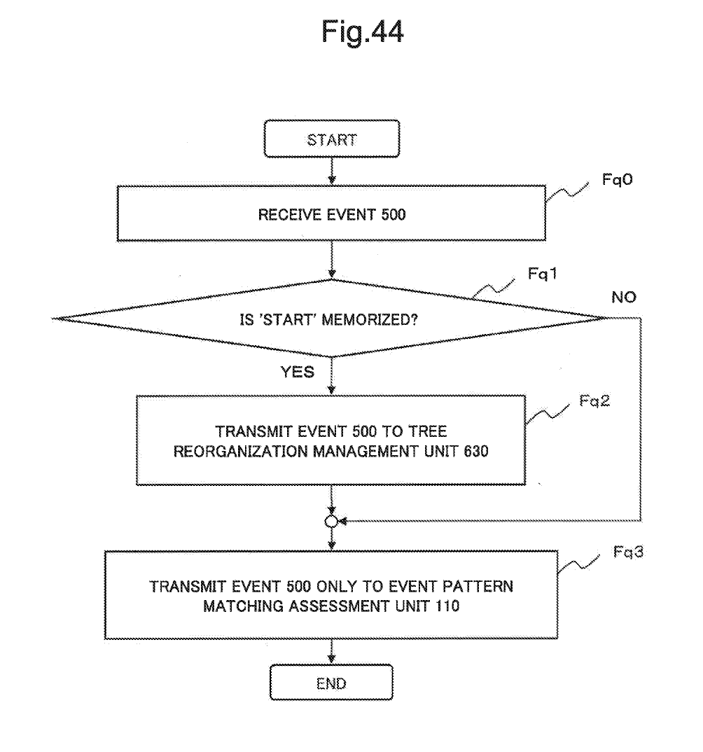

FIG. 44 is a flow chart showing operation in case the event receiving unit 680 receives the event 500.

The event receiving unit 680 receives the event 500 from the event entry operator 820 (Step Fq0).

Next, the event receiving unit 680 confirms whether ‘start’ is memorized in the transmission mode memory unit (Step Fq1).

And in case ‘start’ is memorized (YES in Step Fq1), the event receiving unit 680 transmits the event 500 to the tree reorganization management unit 630 (Step Fq2). Also, in case ‘end’ is memorized (NO in Step Fq1), processing proceeds to Step Fq3.

In Step Fq3, the event receiving unit 680 transmits the event 500 to the event pattern matching assessment unit 110 (Step Fq3).

Since processing by which the event pattern matching tree generation unit 620 executes reorganization of the event pattern matching tree 141 in case it receives the tree reorganization request from the tree reorganization management unit 630 is same as that of the first exemplary embodiment, the description will be omitted.

The effect of the this exemplary embodiment mentioned above is, in addition to the effect of the first and the second exemplary embodiment, that a load of processing in the event pattern matching assessment system 600 decreases.

The reason is because it is structured as follows. In this exemplary embodiment, the matching ratio measurement unit 670 does not measure the matching ratio 275 of all the attribute names 502. Instead, the matching ratio measurement unit 670 refers the matching ratio 135 measured in the tree dependent matching ratio measurement unit 130 and selects the attribute name 272 which has the relatively low matching ratio 135.

And the matching ratio measurement unit 670 measures the matching ratio 275 correctly only for the attribute name 502 corresponding to the attribute name 272.

### The Fourth Exemplary Embodiment

Next, the fourth exemplary embodiment of the present invention will be described in detail with reference to drawings. Hereinafter, within a range that the description of this exemplary embodiment will not become indefinite, the contents overlapping with the description mentioned above will be omitted.

The fourth exemplary embodiment measures, in the attribute value matching assessment instances 142 which is the root node 192 of the event pattern matching tree 141 held in a plurality of the event pattern matching tree holding units, the matching ratio 135 of the attribute name 502 which appears in the attribute value matching assessment instance 142.

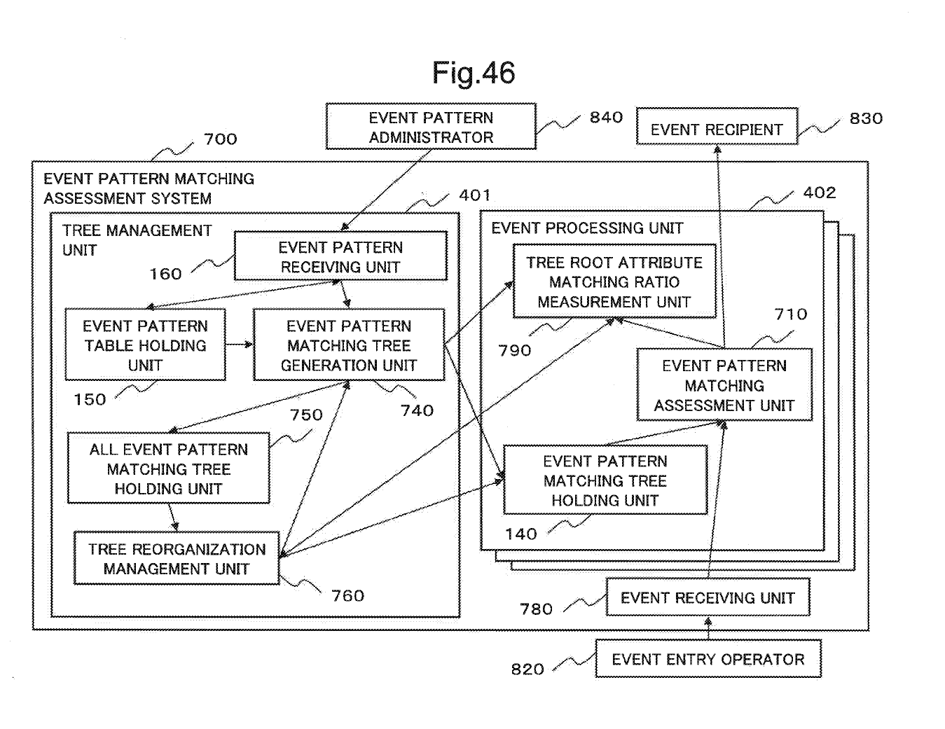

FIG. 46 is a block diagram showing a structure of the fourth exemplary embodiment.

Referring to FIG. 46, an event pattern matching assessment system 700 includes an event receiving unit 780, a tree management unit 401 and a plurality of the event processing units 402.

In case the event 500 is received from the event entry operator 820, the event receiving unit 780 selects one among a plurality of the event processing units 402 at random. Successively, the event receiving unit 780 transmits the received event 500 to the selected event processing unit 402.

The tree management unit 401 includes the event pattern receiving unit 160, the event pattern table holding unit 150, an event pattern matching tree generation unit 740, an all event pattern matching tree holding unit 750 and a tree reorganization management unit 760.

The tree reorganization management unit 760 decides whether to reorganize the event pattern matching tree 141 on the basis of the matching ratio 135 measured in a tree root attribute matching ratio measurement unit (also called a matching ratio measurement unit) 790 described later.

The tree reorganization management unit 760 acquires the matching ratio 135 from all the tree root attribute matching ratio measurement units 790 at fixed time intervals.

Also, the tree reorganization management unit 760 decides whether to reorganize the event pattern matching tree 141 on the basis of the acquired matching ratio 135.

Moreover, the tree reorganization management unit 760 decides the event pattern matching tree 141 to be held in the event pattern matching tree holding unit 140 of each of the event processing units 402 on the basis of the acquired matching ratio 135. Successively, the tree reorganization management unit 760 transmits, for the decided event pattern matching tree 141, the tree reorganization request to the event pattern matching tree generation unit 740.

Moreover, the tree reorganization management unit 760 acquires the decided event pattern matching tree 141 from the all event pattern matching tree holding unit 750. Successively, the tree reorganization management unit 760 records the decided event pattern matching tree 141 in the event pattern matching tree holding unit 140 of each of the event processing units 402.

Also, the tree reorganization management unit 760 transmits to the tree root attribute matching ratio measurement unit 790 the attribute name 502 which is stored in the root node 192 of the event pattern matching tree 141 transmitted to the event pattern matching tree holding unit 140.

By the processing, the tree root attribute matching ratio measurement unit 790 of each of the event processing units 402 can be made to measure only the matching ratio 135 corresponding to the attribute name 502 held in the root node 192 of the event pattern matching tree 141 recorded newly in the event pattern matching tree holding unit 140.

The event pattern matching tree generation unit 740 performs generation of the event pattern matching tree 141 on the basis of the received tree reorganization request. Successively, the event pattern matching tree generation unit 740 records the generated event pattern matching tree 141 in the all event pattern matching tree holding unit 750. In this way, the event pattern matching tree generation unit 740 organizes or reorganizes the event pattern matching tree 141.

The all event pattern matching tree holding unit 750 holds as many number of the event pattern matching trees 141 as received from the event pattern matching tree generation unit 740.

The event processing unit 402 includes an event pattern matching assessment unit 710, the tree root attribute matching ratio measurement unit 790 and the event pattern matching tree holding unit 140.

The event pattern matching assessment unit 710 performs matching of the event 500.

The event pattern matching assessment unit 710 receives the event 500 from the event entry operator 820.

Successively, the event pattern matching assessment unit 710 performs event matching of the received event 500 using the event pattern matching tree 141 held in the event pattern matching tree holding unit 140.

Further successively, in case the event 500 matches with the event pattern 510, the event pattern matching assessment unit 710 transmits the event 500 to the event recipient 830.

Also, in case the event 500 is processed on the basis of data of the attribute value matching assessment instance 142 which is the root node 192 of the event pattern matching tree 141, in order to update the matching ratio 135 corresponding to the attribute name 502 which the attribute value matching assessment instance 142 refers, the event pattern matching assessment unit 710 transmits the attribute name 502 stored in the attribute name field 143 of the attribute value matching assessment instance 142 and its corresponding matching result to the tree root attribute matching ratio measurement unit 790.

Further, since the matching result is same as the matching result described in the first exemplary embodiment, the description will be omitted.

The tree root attribute matching ratio measurement unit 790 measures the matching ratio 135 of the attribute name 502 included in the attribute value matching assessment instance 142 which is the root node 192 of the event pattern matching tree 141.

The tree root attribute matching ratio measurement unit 790 holds the matching ratio measurement table 131 of the structure shown in FIG. 12 same as the tree dependent matching ratio measurement unit 130 of the first exemplary embodiment.

However, in the matching ratio measurement table 131 held in the tree root attribute matching ratio measurement unit 790, the attribute name 502 included in the attribute value matching assessment instance 142 which is the root node 192 of the event pattern matching tree 141 is stored in the first line in the attribute name 132.

Since update method of the matching ratio measurement table 131 is same as that of described in the first exemplary embodiment, the description will be omitted.

Next, operation of this exemplary embodiment will be described in detail with reference to drawings.

As a premise, according to the fourth exemplary embodiment, it is supposed that the event processing units 402 with no smaller than the total number of the attribute names 502 exist.

First, operation of event matching of the event 500 will be described.

When the event 500 is inputted from the event entry operator 820 to the event receiving unit 780, the event receiving unit 780 selects one from among a plurality of the event pattern matching assessment units 710 at random. And the event receiving unit 780 transmits the event 500 to the selected event pattern matching assessment unit 710.

Next, the event pattern matching assessment unit 710 performs event matching and gives the event 500 the event pattern ID 512 of the event pattern 510 which matches. And the event pattern matching assessment unit 710 notifies the event recipient 830 of the event 500 to which the event pattern ID 512 was given.

Also, the event pattern matching assessment unit 710 updates only the matching ratio 135 corresponding to the attribute name 502 of the root node 192 of the event pattern matching tree 141.

That is, the event pattern matching assessment unit 710 is different, compared with the event pattern matching assessment unit 110 of the first exemplary embodiment, only in the operation of the part below.

The event pattern matching assessment unit 710 updates the matching ratio measurement table 131 in Step F83 of FIG. 15, Step F88 and Step F89 of FIG. 16 only when the attribute value matching assessment instance 142 of a target is the root node 192 of the event pattern matching tree 141.

Next, operation of reorganization of the event pattern matching tree 141 will be described.

The tree reorganization management unit 760 decides the event pattern matching tree 141 to be set to each of the event processing units 402 on the basis of the matching ratio 135 which the tree root attribute matching ratio measurement unit 790 measured. Successively, the tree reorganization management unit 760 transmits the tree reorganization request to the event pattern matching tree generation unit 740 for the decided event pattern matching tree 141.

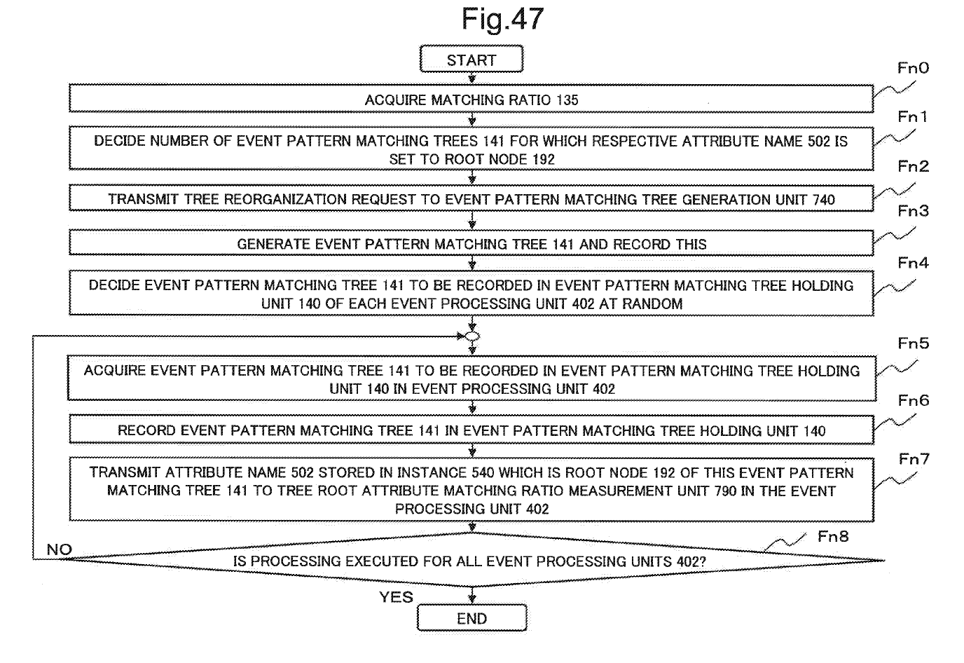

FIG. 47 is a flow chart showing operation by which the tree reorganization management unit 760 requests reorganization of the event pattern matching tree 141.

As a premise, it is supposed that the tree management unit 401 grasps in advance, so that it can communicate, identifiers (not shown) of each of the event processing units 402, and the tree root attribute matching ratio measurement unit 790 and the event pattern matching tree holding unit 140 of each of the event processing units 402.

The tree reorganization management unit 760 acquires the matching ratio 135 from all the tree root attribute matching ratio measurement units 790 at fixed time intervals (Step Fn0).

Next, the tree reorganization management unit 760 decides a number of the event pattern matching trees 141 in which the respective attribute name 502 are set to the root node 192 for all the attribute names 502 which the event pattern matching assessment system 700 holds so that both of the following first and second condition may be satisfied.

The first condition is to make the instance 540 which holds the attribute name 502 having the relatively low matching ratio 135 as many of the instances 540 as possible which are the root nodes 192 of the event pattern matching tree 141.

The object of the first condition is to make the event pattern matching tree 141 which makes the instance 540 which holds the attribute name 502 having the low matching ratio 135 as the root node 192 to be referred by as many event pattern matching assessment units 710 as possible.

The second condition is, for all the attribute names 502, to make the instance 540 which holds these each of the attribute names 502 the instance 540 which is the root node 192 of at least one event pattern matching tree 141.

The object of the second condition is to measure the matching ratio 135 for all the attribute names 502 (Step Fn1).

The tree reorganization management unit 760 decides, for example, in case a total number of the attribute names 502 is made n and a total number of the event processing units 402 is m, a number of the event pattern matching trees 141 which makes the instance 540 holding the attribute name 502 which has the lowest corresponding matching ratio 135 as the root node 192 to be (m−n+1) units. Moreover and similarly, the tree reorganization management unit 760 decides a number of the event pattern matching trees 141 which makes the instance 540 holding the attribute name 502 other than the attribute name 502 which has the lowest corresponding matching ratio 135 as the root node 192 as one respectively.

Also, the tree reorganization management unit 760 may decide the numbers of the event pattern matching trees 141 mentioned above by other method, for example, so that they may be proportional to an inverse of the matching ratio 135 which each of the attribute names 502 has.

Next, the tree reorganization management unit 760 transmits the tree reorganization request to the event pattern matching tree generation unit 740 (Step Fn2).

Next, the event pattern matching tree generation unit 740 performs generation of the event pattern matching tree 141 on the basis of the received tree reorganization request. Successively, the event pattern matching tree generation unit 740 records the generated event pattern matching tree 141 in the all event pattern matching tree holding unit 750 (Step Fn3).

Next, the tree reorganization management unit 760 decides the event pattern matching tree 141 to be recorded in the event pattern matching tree holding unit 140 of each of the event processing units 402 at random (Step Fn4).

Next, the tree reorganization management unit 760 performs processing of following Step Fn5, Step Fn6 and Step Fn7 to each of the event processing units 402.

First, the tree reorganization management unit 760 acquires the event pattern matching tree 141 to be recorded in the event pattern matching tree holding unit 140 in the event processing unit 402 from the all event pattern matching tree holding unit 750 (Step Fn5).

Next, the tree reorganization management unit 760 records the acquired event pattern matching tree 141 in the event pattern matching tree holding unit 140 (Step Fn6).

Next, the tree reorganization management unit 760 transmits the attribute name 502 stored in the instance 540 which is the root node 192 of the event pattern matching tree 141 to the tree root attribute matching ratio measurement unit 790 in the event processing unit 402 (Step Fn7).

Next, the tree reorganization management unit 760 assesses whether processing is executed for all the event processing units 402 (Step Fn8). And in case processing has been completed for all the event processing units 402 (YES in Step Fn8), processing ends. Also, in case the event processing unit 402 for which processing is not completed exists, processing returns to Step Fn5.

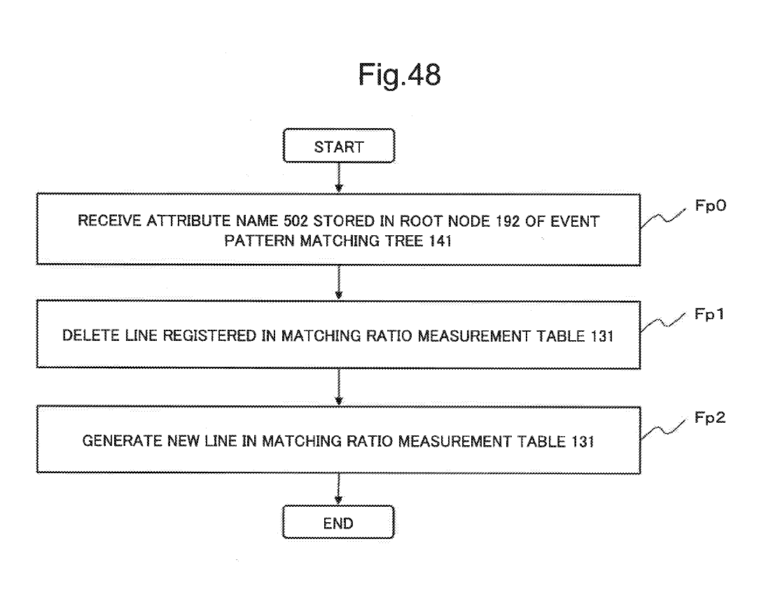

FIG. 48 is a flow chart showing operation by which the tree root attribute matching ratio measurement unit 790 updates the matching ratio measurement table 131.

The tree root attribute matching ratio measurement unit 790 receives the attribute name 502 stored in the root node 192 of the event pattern matching tree 141 from the tree reorganization management unit 760 (Step Fp0).

Next, the tree root attribute matching ratio measurement unit 790 deletes the line registered in the matching ratio measurement table 131 (Step Fp1).

Next, the tree root attribute matching ratio measurement unit 790 generates a new line in the matching ratio measurement table 131. And the tree root attribute matching ratio measurement unit 790 stores the attribute name 502 received in Step Fp0 in the attribute name 132, ‘0’ in the number of received events 133, ‘0’ in the number of matching events 134 and ‘0’ in the matching ratio 135 respectively (Step Fp2).

The effect of the this exemplary embodiment mentioned above is, in addition to the effect of the first exemplary embodiment, a processing load in the event pattern matching assessment system 700 decreases.

The reason is because, in the attribute value matching assessment instances 142 which are the root nodes 192 of the event pattern matching trees 141 held in a plurality of the event pattern matching tree holding units 140, the matching ratio 135 of the attribute name 502 which appears in the event pattern 510 is measured.

### The Fifth Exemplary Embodiment

Next, the fifth exemplary embodiment of the present invention will be described in detail with reference to drawings. This exemplary embodiment is an exemplary embodiment which includes only basic elements of the present invention. Hereinafter, within a range that the description of this exemplary embodiment will not become indefinite, the contents overlapping with the description mentioned above will be omitted.

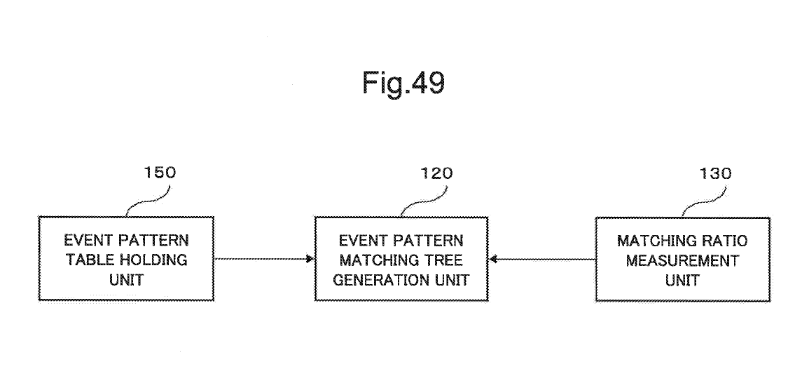

FIG. 49 is a block diagram showing a structure of the fifth exemplary embodiment.

Referring to FIG. 49, this exemplary embodiment includes the event pattern matching tree generation unit 120, the matching ratio measurement unit 130 and the event pattern table holding unit 150.

The event pattern table holding unit 150 holds at least one event pattern 510 including the partial event pattern 511 comprising the attribute name 502 and the attribute value 503.

The matching ratio measurement unit 130 measures the matching ratio 135 corresponding to the attribute name 502 on the basis of the event including the attribute 501 comprising the attribute name 502 and the attribute value 503 and the event pattern 510 held in the event pattern table holding unit 150.

The event pattern matching tree generation unit 120 generates, on the basis of the event pattern 510 held in the event pattern table holding unit 150 and the matching ratio 135 which the matching ratio measurement unit 130 measured, the event pattern matching tree 141 which has arranged on a relatively upper level the attribute value matching assessment instance 142 including the attribute name 502 which has the relatively low corresponding matching ratio 135.

The effect of this exemplary embodiment mentioned above is, generation of the event pattern matching tree optimal for efficiently performing pattern matching assessment can be made possible.

The reason is because the event pattern matching tree 141 is made to be generated by arranging in the upper level node 191 the instance 540 including the attribute name 502 which has the low corresponding matching ratio 135 on the basis of the measured matching ratio 135.

Accordingly, in the processing at an upper part of the event pattern matching tree, that is, in an early stage of the processing of pattern matching, to find that the received event does not match with the event pattern, that is, to perform pattern matching assessment at high speed becomes possible.

Each component described in each exemplary embodiment mentioned above may make, for example, a computer execute predetermined processing by a program.

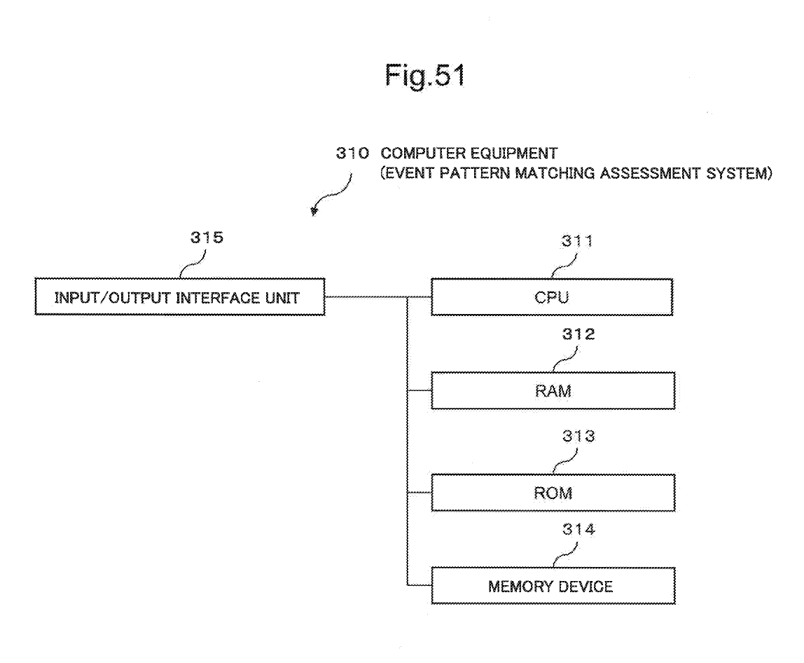

Here, the event pattern matching assessment systems 100, 200, 600 and 700 may be structured by general-purpose computer equipment 310 as shown in FIG. 51. FIG. 51 is a block diagram showing a structure of an exemplary embodiment using computer equipment of the present invention.

Referring to FIG. 51, computer equipment 310 includes a CPU (Central Processing Unit) 311, a RAM (Random Access Memory) 312, a ROM (Read Only Memory) 313 and a memory device (also called a memory medium, for example, hard disk device) 314.

Further, the computer equipment 310 includes an input/output interface unit 315.

In this case, each component included in the event pattern matching assessment systems 100, 200, 600 and 700 corresponds to the CPU 311, the RAM 312, the ROM 313 and the memory device 314. Similarly, the event pattern table holding unit 150, the event pattern matching tree generation unit 120 and the matching ratio measurement unit 130 of the fifth exemplary embodiment correspond to the CPU 311, the RAM 312, the ROM 313 and the memory device 314. Programs executed by the CPU 311 are memorized in the memory device 314. Further, a part of each of the programs mentioned above may be memorized in the ROM 313.

The CPU 311 reads the program memorized in the memory device 314 into the RAM 312, and on the basis of the program read, executes predetermined processing described by using the flow charts showing operation of each exemplary embodiment.

The input/output interface unit 315 executes sending and receiving of data between the event entry operator 820, the event recipient 830, the event pattern administrator 840 and the event pattern matching assessment systems 100, 200, 600 and 700 on the basis of the directions of the CPU 311. The input/output interface unit 315 may be included in the event pattern matching assessment units 110, 210 and 710, the event pattern receiving units 160 and 260 and the event receiving units 280, 680 and 780.

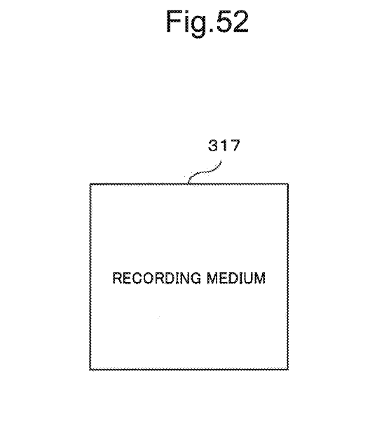

FIG. 52 is a figure showing an example of a non-transitory computer-readable medium (memory medium) 317 in which the programs are recorded (memorized). The non-transitory computer-readable medium 317 is a non-volatile recording medium which memorizes information not temporarily. Further, the non-transitory computer-readable medium 317 may be a recording medium memorizing information temporarily. The non-transitory computer-readable medium 317 records the programs (software) which make the computer equipment 310 (CPU 311) execute the operation shown in FIG. 51. Further, the non-transitory computer-readable medium 317 may record other arbitrary programs or data in addition.

The non-transitory computer-readable medium 317 in which codes of the programs (software) mentioned above are recorded may be supplied to the computer equipment 310, and the CPU 311 may be made to read the codes of the programs stored in the non-transitory computer-readable medium 317 and execute them. Or, the CPU 311 may be made to store the codes of the programs stored in the non-transitory computer-readable medium 317 in the RAM 312. That is, this exemplary embodiment includes an exemplary embodiment of the non-transitory computer-readable medium 317 which memorizes the programs which the computer equipment 310 (CPU 311) executes temporarily or not temporarily.

Each component described in each exemplary embodiment mentioned above does not need to be an independent being necessarily. For example, each component may be realized such that a plurality of components is realized by one module, or one component may be realized by a plurality of modules. Also, each component may be of a structure such that a certain component is part of other component or part of a certain component and part of other component overlap.

Also, according to each exemplary embodiment described above, although a plurality of operations has been described in sequence in the form of a flow chart, sequence of the description does not limit the sequence which executes a plurality of operations. For this reason, when each exemplary embodiment is carried out, the sequence of the plurality of operations can be changed within a range that does not disrupt the contents.

Moreover, according to each exemplary embodiment described above, a plurality of operations is not limited to be executed at timing which differ each other. For example, during execution of a certain operation, other operation may occur, or execution timing of a certain operation and other operation may overlap partially or entirely.

Moreover, according to each exemplary embodiment described above, though a certain operation is described to become a trigger of other operation, the description does not limit all the relations between the certain operation and the other operation. For this reason, when each exemplary embodiment is carried out, the relation of the plurality of operations can be changed within a range which does not disrupt the contents. Also, specific description of each operation of each component does not limit each operation of each component. For this reason, each specific operation of each component may be changed within a range which does not disrupt each exemplary embodiment function-wise, performance-wise, and in other characteristics when it is carried out.

Further, each component in each exemplary embodiment described above may be realized, as needed and when possible, by hardware, may be realized by software, or may be realized by a combination of hardware and software.

Also, a physical structure of each component is not limited to the description of the exemplary embodiment described above, and it may exist independently, it may exist combined, or it may be structured separately.

Although part or all of the exemplary embodiments mentioned above can also be described as following supplementary notes, they are not limited to the followings.

(Supplementary Note 1)

A pattern matching device comprising: an event pattern table holding unit which holds at least one event pattern including a partial event pattern comprising a first attribute name and an attribute value;

a first matching ratio measurement unit which measures a first matching ratio corresponding to said first attribute name on the basis of an event including attributes comprising a second attribute name and an attribute value and said event pattern held in said event pattern table holding unit; and

an event pattern matching tree generation unit which generates an event pattern matching tree which has arranged on a relatively upper level an attribute value matching assessment instance including said first attribute name of which corresponding said matching ratio is relatively low on the basis of said event pattern held in said event pattern table holding unit and said first matching ratio.

(Supplementary Note 2)

The pattern matching device described in supplementary note 1, wherein characterized by said first matching ratio measurement unit performs matching between said attribute and part or all of said partial event patterns included in said event pattern held in said event pattern table holding unit, and on the basis of a result of the matching concerned, measures said first matching ratio for each of said first attribute names.

(Supplementary Note 3)

The pattern matching device described in supplementary note 1 characterized by further comprising: an event pattern matching assessment unit which performs event matching for said event on the basis of said event pattern matching tree; wherein

said first matching ratio measurement unit measures said first matching ratio for each of said first attribute names on the basis of said result of the matching of said event pattern matching assessment unit.

(Supplementary Note 4)

The pattern matching device described in supplementary note 3 characterized by further comprising: a tree reorganization management unit which selects at least one among said first attribute names on the basis of said first matching ratio; and

a second matching ratio measurement unit which performs matching between said attribute and a partial event pattern including said attribute name which said tree reorganization management unit selected, and measures a second matching ratio for each of said first attribute names on the basis of the result of the matching concerned; wherein

said event pattern matching tree generation unit generates said event pattern matching tree on the basis of said second matching ratio.

(Supplementary Note 5)

The pattern matching device described in supplementary note 3 characterized by further comprising: said event pattern matching assessment unit;

a plurality of event processing units including said first matching ratio measurement unit which measures said first matching ratio corresponding to said attribute name included in said attribute value matching assessment instance which is a root node of said event pattern matching tree;

an event receiving unit which selects one among a plurality of said event processing units on the basis of a standard set in advance and transmits a received event to said event processing unit concerned;

an all event pattern matching tree holding unit which holds said event pattern matching tree which said event pattern matching tree generation unit generated; and

a tree reorganization management unit which decides said event pattern matching tree transmitted to said event processing unit respectively on the basis of each of said first matching ratios which said event processing unit measured.

(Supplementary Note 6)

The pattern matching device described in either one of supplementary note 1 to 5 characterized by comprising: an event pattern matching tree holding unit which holds said event pattern matching tree which said event pattern matching tree generation unit generated.

(Supplementary Note 7)

A pattern matching method comprising: measuring, on the basis of an event including attributes comprising a second attribute name and an attribute value and an event pattern including a partial event pattern comprising a first attribute name and an attribute value held in an event pattern table holding unit, a matching ratio corresponding to said first attribute name; and

generating an event pattern matching tree which has arranged on a relatively upper level an attribute value matching assessment instance including said first attribute name of which corresponding said matching ratio is relatively low on the basis of said event pattern held in said event pattern table holding unit and said first matching ratio.

(Supplementary Note 8)

The pattern matching method described in supplementary note 7, wherein characterized by measurement of said first matching ratio performs matching between said attribute and part or all of said partial event patterns included in said event pattern held in said event pattern table holding unit, and on the basis of a result of the matching concerned, measures said first matching ratio for each of said first attribute names.

(Supplementary Note 9)

The pattern matching method described in supplementary note 7 characterized by comprising: performing event matching for said event on the basis of said event pattern matching tree; wherein

said measurement of said first matching ratio measures said matching ratio for each of said first attribute names on the basis of said result of the event matching.

(Supplementary Note 10)

The pattern matching method described in supplementary note 9 characterized by comprising: selecting at least one among said first attribute names on the basis of said first matching ratio;

performing matching between said attribute and a partial event pattern including said selected first attribute name; and measuring a second matching ratio for each of said first attribute names on the basis of the result of the matching concerned; wherein

said generation of event pattern matching tree generates said event pattern matching tree on the basis of said second matching ratio.

(Supplementary Note 11)

The pattern matching method described in supplementary note 9, wherein characterized by said generation of event pattern matching tree transmits said event pattern matching tree generated to an all event pattern matching tree holding unit, and on the basis of each of said first matching ratios and among said event pattern matching trees held in the all event pattern matching tree holding unit, decides an event pattern matching tree for said performing event matching for said event on the basis thereof;

said matching of said event pattern on the basis of said event pattern matching tree performs matching for said event on the basis of the decided event pattern matching tree concerned; and

said measurement of said first matching ratio measures said first matching ratio corresponding to said attribute name included in said attribute value matching assessment instance which is a root node of said event pattern matching tree on the basis of the result of the matching concerned.

(Supplementary Note 12)

A non-transitory computer-readable medium in which a pattern matching program is recorded which make a computer execute processing comprising: measuring, on the basis of an event including attributes comprising a second attribute name and an attribute value and an event pattern including a partial event pattern comprising a first attribute name and an attribute value held in an event pattern table holding unit, a matching ratio corresponding to said first attribute name; and

generating an event pattern matching tree which has arranged on a relatively upper level an attribute value matching assessment instance including said first attribute name of which corresponding said matching ratio is relatively low on the basis of said event pattern held in said event pattern table holding unit and said first matching ratio.

(Supplementary Note 13)

The non-transitory computer-readable medium in which the pattern matching program described in supplementary note 12 is recorded characterized by making a computer execute processing, wherein measurement of said first matching ratio performs matching between said attribute and part or all of said partial event patterns included in said event pattern held in said event pattern table holding unit, and on the basis of a result of the matching concerned, measures said first matching ratio for each of said first attribute names.

(Supplementary Note 14)

The non-transitory computer-readable medium in which the pattern matching program described in supplementary note 12 is recorded characterized by making a computer execute processing comprising: performing event matching for said event on the basis of said event pattern matching tree; wherein

said measurement of said first matching ratio measures said first matching ratio for each of said first attribute names on the basis of said result of the event matching.

(Supplementary Note 15)

The non-transitory computer-readable medium in which the pattern matching program described in supplementary note 14 is recorded characterized by making a computer execute processing comprising: selecting at least one among said first attribute names on the basis of said first matching ratio;

performing matching between said attribute and a partial event pattern including said selected first attribute name; and measuring a second matching ratio for each of said first attribute names on the basis of the result of the matching concerned; wherein

said generation of event pattern matching tree generates said event pattern matching tree on the basis of said second matching ratio.

(Supplementary Note 16)

The non-transitory computer-readable medium in which the pattern matching program described in supplementary note 14 is recorded characterized by making a computer execute processing, wherein said generation of event pattern matching tree transmits said event pattern matching tree generated to an all event pattern matching tree holding unit, and

on the basis of each of said first matching ratios and among said event pattern matching trees held in said all event pattern matching tree holding unit, decides an event pattern matching tree for said performing event matching for said event on the basis thereof;

said matching of said event pattern on the basis of said decided event pattern matching tree concerned performs event matching for said event on the basis of said decided event pattern matching tree concerned; and

said measurement of said first matching ratio measures said first matching ratio corresponding to said attribute name included in said attribute value matching assessment instance which is a root node of said event pattern matching tree on the basis of the result of the matching concerned.

(Supplementary Note 17)

A pattern matching system comprising: an event pattern table holding unit which holds at least one event pattern including a partial event pattern comprising a first attribute name and an attribute value;

a first matching ratio measurement unit which measures a matching ratio corresponding to said first attribute name on the basis of an event including attributes comprising a second attribute name and an attribute value and said event pattern held in said event pattern table holding unit; and

an event pattern matching tree generation unit which generates an event pattern matching tree which has arranged on a relatively upper level an attribute value matching assessment instance including said first attribute name of which corresponding said matching ratio is relatively low on the basis of said event pattern held in said event pattern table holding unit and said first matching ratio.

(Supplementary Note 18)

The pattern matching system described in supplementary note 17, wherein characterized by said first matching ratio measurement unit performs matching between said attribute and part or all of said partial event patterns included in said event pattern held in said event pattern table holding unit, and on the basis of a result of the matching concerned, measures said first matching ratio for each of said first attribute names.

(Supplementary Note 19)

The pattern matching system described in supplementary note 17 characterized by further comprising: an event pattern matching assessment unit which performs event matching for said event on the basis of said event pattern matching tree; wherein

said first matching ratio measurement unit measures said first matching ratio for each of said first attribute names on the basis of said result of the matching of the event pattern matching assessment unit.

(Supplementary Note 20)

The pattern matching system described in supplementary note 19 characterized by further comprising: a tree reorganization management unit which selects at least one among said first attribute names on the basis of said first matching ratio; and

a second matching ratio measurement unit which performs matching between said attribute and a partial event pattern including said attribute name which said tree reorganization management unit selected, and measures a second matching ratio for each of said first attribute names on the basis of the result of the matching concerned; wherein

said event pattern matching tree generation unit generates said event pattern matching tree on the basis of said second matching ratio.

(Supplementary Note 21)

The pattern matching system described in supplementary note 19 characterized by further comprising: said event pattern matching assessment unit;

a plurality of event processing units including said first matching ratio measurement unit which measures said first matching ratio corresponding to said attribute name included in said attribute value matching assessment instance which is a root node of said event pattern matching tree;

an event receiving unit which selects one among a plurality of said event processing units on the basis of a standard set in advance and transmits a received event to said event processing unit concerned;

an all event pattern matching tree holding unit which holds said event pattern matching tree which said event pattern matching tree generation unit generated; and

a tree reorganization management unit which decides said event pattern matching tree transmitted to said event processing unit respectively on the basis of each of said first matching ratios which said event processing unit measured.

(Supplementary Note 22)

The pattern matching system described in either of supplementary notes 17 to 21 characterized by comprising: an event pattern matching tree holding unit which holds said event pattern matching tree which said event pattern matching tree generation unit generated.

Although the present invention has been described with reference to the exemplary embodiments above, the present invention is not limited to the above-mentioned exemplary embodiments. Various changes which a person skilled in the art can understand within the scope of the present invention can be performed in the composition of the present invention and details.

This application claims priority based on Japanese Patent Application No. 2010-043954 filed on Mar. 1, 2010 and the disclosure thereof is incorporated herein in its entirety.

### INDUSTRIAL APPLICABILITY

The present invention can be applied to the use such as an advertisement distribution system which distributes advertisement to a person who matched with a condition and a rendezvous support service (presence service) in which, when an appointed partner arrives at an appointed place, it will be notified.

### DESCRIPTION OF THE REFERENCE NUMERALS

100 Event pattern matching assessment system
110 Event pattern matching assessment unit
120 Event pattern matching tree generation unit
130 Tree dependent matching ratio measurement unit
131 Matching ratio measurement table
133 Number of received events
134 Number of matching events
135 Matching ratio
140 Event pattern matching tree holding unit
141 Event pattern matching tree
142 Attribute value matching assessment instance
143 Attribute name field
144* field
145 Hash table
146 Event notification instance
147 Event pattern ID list
148 Key
149 Value
192 Root node
193 Leaf node
194 Pointer
150 Event pattern table holding unit
151 Event pattern table
160 Event pattern receiving unit
200 Event pattern matching assessment system
210 Event pattern matching assessment unit
220 Event pattern matching tree generation unit
260 Event pattern receiving unit
270 Matching ratio measurement unit
271 Matching ratio measurement table
272 Attribute name
273 Number of received events
274 Number of matching events
275 Matching ratio
276 Partial event pattern list
280 Event receiving unit
310 Computer equipment
311 CPU
312 RAM
313 ROM
314 Memory device
315 Input/output interface unit
500 Event
501 Attribute
502 Attribute name
503 Attribute value
510 Event pattern
511 Partial event pattern
512 Event pattern ID
513 Event pattern registration request
514 Event pattern registration request
515 Event pattern deletion request
516 Event pattern deletion request
600 Event pattern matching assessment system
620 Event pattern matching tree generation unit
630 Tree reorganization management unit
670 Matching ratio measurement unit
680 Event receiving unit
700 Event pattern matching assessment system
710 Event pattern matching assessment unit
740 Event pattern matching tree generation unit
750 All event pattern matching tree holding unit
760 Tree reorganization management unit
780 Event receiving unit
790 Tree root attribute matching ratio measurement unit
820 Event entry operator
830 Event recipient
840 Event pattern administrator
900 System
901 Node
902 Root node
903 Leaf node
904 Edge
905 Attribute name
906 Attribute value
907 Subscription

1-10. (canceled)

11. A pattern matching device comprising: an event pattern table holding unit which holds at least one event pattern including a partial event pattern comprising a first attribute name and an attribute value;
a first matching ratio measurement unit which measures a first matching ratio corresponding to said first attribute name on the basis of an event including attributes comprising a second attribute name and an attribute value and said event pattern held in said event pattern table holding unit; and
an event pattern matching tree generation unit which generates an event pattern matching tree which has arranged on a relatively upper level an attribute value matching assessment instance including said first attribute name of which corresponding said matching ratio is relatively low on the basis of said event pattern held in said event pattern table holding unit and said first matching ratio.

12. The pattern matching device according to claim 11, wherein characterized by said first matching ratio measurement unit performs matching between said attribute and part or all of said partial event patterns included in said event pattern held in said event pattern table holding unit, and on the basis of a result of the matching concerned, measures said first matching ratio for each of said first attribute names.

13. The pattern matching device according to claim 11 characterized by further comprising: an event pattern matching assessment unit which performs event matching for said event on the basis of said event pattern matching tree; wherein
said first matching ratio measurement unit measures said first matching ratio for each of said first attribute names on the basis of said result of the matching of said event pattern matching assessment unit.

14. The pattern matching device according to claim 13 characterized by further comprising: a tree reorganization management unit which selects at least one among said first attribute names on the basis of said first matching ratio; and
a second matching ratio measurement unit which performs matching between said attribute and a partial event pattern including said attribute name which said tree reorganization management unit selected, and measures a second matching ratio for each of said first attribute names on the basis of the result of the matching concerned; wherein
said event pattern matching tree generation unit generates said event pattern matching tree on the basis of said second matching ratio.

15. The pattern matching device according to claim 13 characterized by further comprising: said event pattern matching assessment unit;
a plurality of event processing units including said first matching ratio measurement unit which measures said first matching ratio corresponding to said attribute name included in said attribute value matching assessment instance which is a root node of said event pattern matching tree;
an event receiving unit which selects one among a plurality of said event processing units on the basis of a standard set in advance and transmits a received event to said event processing unit concerned;
an all event pattern matching tree holding unit which holds said event pattern matching tree which said event pattern matching tree generation unit generated; and
a tree reorganization management unit which decides said event pattern matching tree transmitted to said event processing unit respectively on the basis of each of said first matching ratios which said event processing unit measured.

16. The pattern matching device according to either one of claim 11 characterized by comprising: an event pattern matching tree holding unit which holds said event pattern matching tree which said event pattern matching tree generation unit generated.

17. A pattern matching method comprising: measuring, on the basis of an event including attributes comprising a second attribute name and an attribute value and an event pattern including a partial event pattern comprising a first attribute name and an attribute value held in an event pattern table holding unit, a matching ratio corresponding to said first attribute name; and
generating an event pattern matching tree which has arranged on a relatively upper level an attribute value matching assessment instance of which corresponding said matching ratio is relatively low including said first attribute name on the basis of said event pattern held in said event pattern table holding unit and said first matching ratio.

18. The pattern matching method according to claim 11, wherein characterized by measurement of said first matching ratio performs matching between said attribute and part or all of said partial event patterns included in said event pattern held in said event pattern table holding unit, and on the basis of a result of the matching concerned, measures said first matching ratio for each of said first attribute names.

19. The pattern matching method according to claim 17 characterized by comprising: performing event matching for said event on the basis of said event pattern matching tree; wherein
said measurement of said first matching ratio measures said matching ratio for each of said first attribute names on the basis of said result of the event matching.

20. The pattern matching method according to claim 19 characterized by comprising: selecting at least one among said first attribute names on the basis of said first matching ratio;
performing matching between said attribute and a partial event pattern including said selected first attribute name; and measuring a second matching ratio for each of said first attribute names on the basis of the result of the matching concerned; wherein
said generation of event pattern matching tree generates said event pattern matching tree on the basis of said second matching ratio.

21. The pattern matching method according to claim 19, wherein characterized by said generation of event pattern matching tree transmits said event pattern matching tree generated to an all event pattern matching tree holding unit, and
on the basis of each of said first matching ratios and among said event pattern matching trees held in said all event pattern matching tree holding unit, decides an event pattern matching tree for said performing event matching for said event on the basis thereof;
said matching of said event pattern on the basis of said event pattern matching tree performs matching for said event on the basis of the decided event pattern matching tree concerned; and
said measurement of said first matching ratio measures said first matching ratio corresponding to said attribute name included in said attribute value matching assessment instance which is a root node of said event pattern matching tree on the basis of the result of the matching concerned.

22. A non-transitory computer-readable medium in which a pattern matching program is recorded which make a computer execute processing comprising: measuring, on the basis of an event including attributes comprising a second attribute name and an attribute value and an event pattern including a partial event pattern comprising a first attribute name and an attribute value held in an event pattern table holding unit, a matching ratio corresponding to said first attribute name; and
generating an event pattern matching tree which has arranged on a relatively upper level an attribute value matching assessment instance including said first attribute name of which corresponding said matching ratio is relatively low on the basis of said event pattern held in said event pattern table holding unit and said first matching ratio.

23. The non-transitory computer-readable medium in which the pattern matching program according to claim 22 is recorded characterized by making a computer execute processing, wherein measurement of said first matching ratio performs matching between said attribute and part or all of said partial event patterns included in said event pattern held in said event pattern table holding unit, and on the basis of a result of the matching concerned, measures said first matching ratio for each of said first attribute names.

24. The non-transitory computer-readable medium in which the pattern matching program according to claim 22 is recorded characterized by making a computer execute processing comprising: performing event matching for said event on the basis of said event pattern matching tree; wherein
said measurement of said first matching ratio measures said first matching ratio for each of said first attribute names on the basis of said result of the event matching.

25. The non-transitory computer-readable medium in which the pattern matching program according to claim 24 is recorded characterized by making a computer execute processing comprising: selecting at least one among said first attribute names on the basis of said first matching ratio;
performing matching between said attribute and a partial event pattern including said selected first attribute name; and measuring a second matching ratio for each of said first attribute names on the basis of the result of the matching concerned; wherein
said generation of event pattern matching tree generates said event pattern matching tree on the basis of said second matching ratio.

26. The non-transitory computer-readable medium in which the pattern matching program according to claim 24 is recorded characterized by making a computer execute processing, wherein said generation of event pattern matching tree transmits said event pattern matching tree generated to an all event pattern matching tree holding unit, and
on the basis of each of said first matching ratios and among said event pattern matching trees held in said all event pattern matching tree holding unit, decides an event pattern matching tree for said performing event matching for said event on the basis thereof;
said matching of said event pattern on the basis of said decided event pattern matching tree concerned performs event matching for said event on the basis of said decided event pattern matching tree concerned; and
said measurement of said first matching ratio measures said first matching ratio corresponding to said attribute name included in said attribute value matching assessment instance which is a root node of said event pattern matching tree on the basis of the result of the matching concerned.
